(19) United States
(12) Patent Application Publication
(10) Pub. No.: US 2015/0006422 A1
(43) Pub. Date: Jan. 1, 2015

(54) SYSTEMS AND METHODS FOR ONLINE EMPLOYMENT MATCHING

(71) Applicant: EHARMONY, INC., SANTA MONICA, CA (US)

(72) Inventors: STEVEN R. CARTER, ALTADENA, CA (US); F. DANIEL ERICKSON, SANTA MONICA, CA (US); JONATHAN BEBER, LOS ANGELES, CA (US); JACQUELINE MARTIN, LOS ANGELES, CA (US); NAOMI YARIN, LOS ANGELES, CA (US)

(21) Appl. No.: 14/321,696

(22) Filed: Jul. 1, 2014

Related U.S. Application Data
(60) Provisional application No. 61/841,830, filed on Jul. 1, 2013.

(51) Int. Cl. G06Q 10/10; G06Q 50/00

(52) U.S. Cl. CPC G06Q 10/1053; G06Q 50/01
USPC 705/321

(57) ABSTRACT

A computer-based system for presenting employment analysis and recommendation is disclosed using an employment matching server system, operatively coupled to a public network, wherein the employment matching server system is configured to: receive a job seeker's data and generate a job seeker's profile, receive an employer's data and generate a true employer's profile and calculate a compatibility value generated from correlating the job seeker's profile with the true employer's profile, such correlation resulting in a potential match if the compatibility value meets or exceeds a predetermined threshold; in the event of a potential match, present the data associated with the employer and the true employer's profile to the job seeker based on one or more of the compatibility values, and present the data associated with the job seeker and the job seeker's profile to the employer based on one or more of the compatibility values; and use a user interface device that is configured to enable the job seeker and the employer to evaluate the potential match.

### FIELD OF THE INVENTION

The field of the invention relates to systems and methods for the operation of an employment matching service utilizing electronic data related to participants' electronic profiles, e.g., personality, values, and culture.

### BACKGROUND OF THE INVENTION

Surveys have shown that a majority of workers are unhappy with their jobs. According to a 2011 Gallup poll, 71% of U.S. workers identified themselves as either “not engaged” or “actively disengaged” in their work. Another survey from the firm FPC found nearly 80% of those surveyed would like to change jobs. One possible cause for this unhappiness and/or dissatisfaction is a failure in the job seeking, recruiting and hiring process which may bring significant consequences for both the employees and their employers. Poor selection of where to work may lead to frustration and increased personal pain for employees and their families. Poor selection by employers of who to hire may reduce workforce productivity. Overall, poor selection can be characterized as a mismatch between employees and their employers. Such mismatches arise from both sides lacking a more complete picture and control of the employment seeking and selection process. Matching the right worker to the right employer, or company, can be a complex process. The success of this matching depends on a large number of variables, including, but not limited to, the job seeker's personality and values, the values and personality of workers already in place, and the employer's culture. A job seeker often has little information about a company except what the job seeker can find on the Internet. The company has to rely on the job seeker's resume, which may poorly reflect the job seeker. As a result, many potentially good employees may not reach the interview process. And as the above surveys show, even most employment interviews have not resulted in successful hiring and employment.

On the other hand, personal matching services have developed effective systems that analyze many of the above variables to identify and match people who have the potential to establish a successful relationship. A well-known example of such a service is eHarmony, Inc. (which can be found at www.eHarmony.com). A matching service generally collects and stores data to create a “profile” for each user that includes a number of factors potentially relevant to establishing a successful interpersonal relationship with that user. The matching service then correlates that user's profile with others in its database to access which profiles are compatible, i.e. which users have the potential for a successful relationship when matched.

Accordingly, online employment matching systems and methods that utilize more complete users' and companies' profiles are desirable.

### BRIEF DESCRIPTION OF THE DRAWING(S)

Illustrated in the accompanying drawing(s) is at least one of the best mode embodiments of the present invention In such drawing(s):

FIG. 1 is a diagram showing an online job matching system according to an embodiment of the present invention;

FIG. 2 is a diagram showing an employment matching system server according to an embodiment of the present invention;

FIG. 3 is a diagram showing a user device according to an embodiment of the present invention;

FIG. 4 is a diagram showing facilitation of communication between candidates, employers and an online job matching system according to an embodiment of the present invention;

FIG. 5 is a diagram showing system blocks according to an embodiment of the present invention;

FIG. 6 is a diagram showing a scoring abstraction according to an embodiment of the present invention;

FIG. 7 is a diagram showing a candidate profile as it may be shown in a candidate interface according to an embodiment of the present invention;

FIG. 8 is a diagram showing compatibility visualizations according to an embodiment of the present invention;

FIG. 9 is a diagram showing a general dynamic compatibility indicator according to an embodiment of the present invention;

FIG. 10 is a diagram showing a candidate specific dynamic compatibility indicator according to an embodiment of the present invention;

FIG. 11 is a diagram showing a relative component importance map according to an embodiment of the present invention;

FIG. 12 is a diagram showing sample icons and summarizations according to an embodiment of the present invention;

FIG. 13 is a diagram showing an example login screen according to an embodiment of the present invention;

FIG. 14 is a diagram showing a candidate flow map according to an embodiment of the present invention;

FIG. 15 is a diagram showing a recruiter flow map according to an embodiment of the present invention;

FIG. 16 is a diagram showing a candidate experience map according to an embodiment of the present invention;

FIG. 17 is a diagram showing an employer experience map according to an embodiment of the present invention;

FIG. 18 is a diagram showing a dependencies schematic according to an embodiment of the present invention;

FIG. 19 is a diagram showing an automatic employment search flow for a candidate according to an embodiment of the present invention;

FIG. 20 is a diagram showing a refined employment search flow for a candidate according to an embodiment of the present invention;

FIGS. 21A-B are diagrams showing a search result screen as may be presented to an employer according to embodiments of the present invention;

FIG. 22 is a diagram showing a custom or basic experience flow for a candidate according to an embodiment of the present invention;

FIG. 23 is a diagram showing a recruiter flow for an automatic candidate search according to an embodiment of the present invention;

FIG. 24 is a diagram showing a recruiter flow for a refined candidate search according to an embodiment of the present invention;

FIG. 25 is a diagram showing an email registration flow for a candidate according to an embodiment of the present invention;

FIG. 26 is a diagram showing a profile builder flow for a candidate according to an embodiment of the present invention;

FIG. 27 is a diagram showing a hiring manager adding process for an employer according to an embodiment of the present invention;

FIG. 28 is a diagram showing an architecture of a search system according to an embodiment of the present invention;

FIG. 29 is a diagram showing a site map for a candidate according to an embodiment of the present invention;

FIG. 30 is a diagram showing a site map for an employer according to an embodiment of the present invention.

FIG. 31 is a diagram showing a candidate homepage according to an embodiment of the present invention.

FIG. 32 is a diagram showing a candidate registration page according to an embodiment of the present invention.

FIG. 33 is a diagram showing a candidate registration page using a third party system according to an embodiment of the present invention.

FIG. 34 is a diagram showing a candidate photograph upload page according to an embodiment of the present invention.

FIG. 35 is a diagram showing a candidate photograph upload and editing page according to an embodiment of the present invention.

FIG. 36 is a diagram showing a candidate resume upload page according to an embodiment of the present invention.

FIG. 37 is a diagram showing an initial candidate resume builder page according to an embodiment of the present invention.

FIG. 38 is a diagram showing a secondary candidate resume builder page according to an embodiment of the present invention.

FIG. 39 is a diagram showing a candidate resume preview page according to an embodiment of the present invention.

FIG. 40 is a diagram showing a candidate resume preview page according to an embodiment of the present invention.

FIG. 41 is a diagram showing a candidate resume editor button according to an embodiment of the present invention.

FIG. 42 is a diagram showing a candidate resume editor page according to an embodiment of the present invention.

FIG. 43 is a diagram showing candidate questionnaire headers according to an embodiment of the present invention.

FIG. 44 is a diagram showing a candidate questionnaire page according to an embodiment of the present invention.

FIG. 45 is a diagram showing a candidate validation page according to an embodiment of the present invention.

FIG. 46 is a diagram showing a candidate compatibility scorecard prompt page according to an embodiment of the present invention.

FIG. 47 is a diagram showing a candidate compatibility scorecard according to an embodiment of the present invention.

FIG. 48 is a diagram showing candidate scorecard interaction pages according to an embodiment of the present invention.

FIG. 49 is a diagram showing a candidate search builder page according to an embodiment of the present invention.

FIG. 50 is a diagram showing candidate search builder pages according to an embodiment of the present invention.

FIG. 51 is a diagram showing a candidate custom search page according to an embodiment of the present invention.

FIG. 52 is a diagram showing a candidate custom and basic search results page according to an embodiment of the present invention.

FIG. 53 is a diagram showing candidate automated search results page according to an embodiment of the present invention.

FIG. 54 is a diagram showing a candidate compatibility profile message page according to an embodiment of the present invention.

FIG. 55 is a diagram showing a candidate compatibility profile page according to an embodiment of the present invention.

FIG. 56 is a diagram showing a continuation page of a candidate compatibility profile according to an embodiment of the present invention.

FIG. 57 is a diagram showing numerous navigation buttons which are consistent across many system pages according to an embodiment of the present invention.

FIG. 58 is a diagram showing a dashboard message page according to an embodiment of the present invention.

FIG. 59 is a diagram showing a candidate dashboard page according to an embodiment of the present invention.

FIG. 60 is a diagram showing a top job search results page according to an embodiment of the present invention.

FIG. 61 is a diagram showing a candidate watch list page according to an embodiment of the present invention.

FIG. 62 is a diagram showing a candidate messages page according to an embodiment of the present invention.

FIG. 63 is a diagram showing a candidate single message page according to an embodiment of the present invention.

FIG. 64 is a diagram showing a candidate profile editing page according to an embodiment of the present invention.

### BRIEF DESCRIPTION OF THE PREFERRED EMBODIMENT

The above described drawing figures illustrate the invention in at least one preferred, best mode embodiment, which is further defined in detail in the following description. Those having ordinary skill in the art may be able to make alterations and modifications to what is described herein without departing from its spirit and scope. Therefore, it should be understood that what is illustrated is set forth only for the purposes of example and should not be taken as a limitation on the scope of the present apparatus and its method of use.

### Preferred System

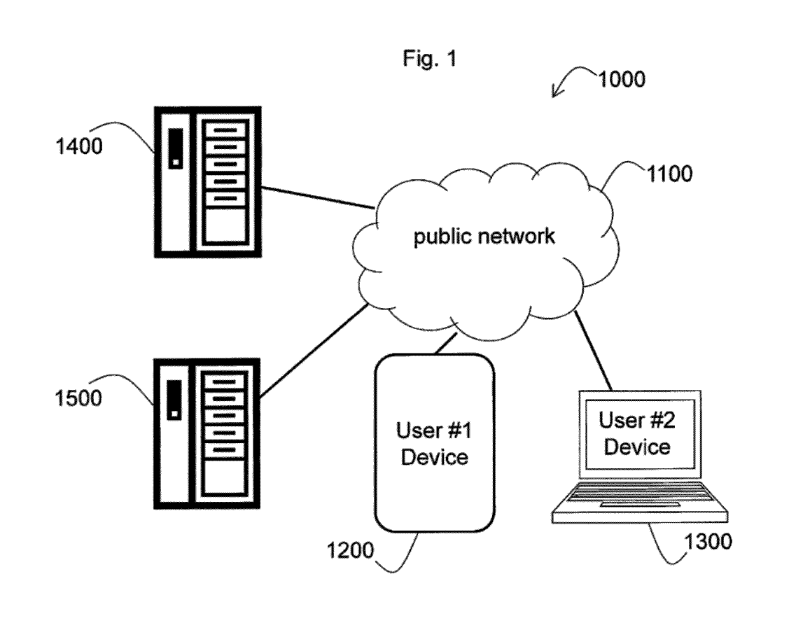

FIG. 1 shows a computer-based employment matching system 1000 according to an embodiment of the present invention. The system generally includes an employment matching server system 1400, which may be distributed on one or more physical servers, each having one or more processors, memory, an operating system, and input/output interface, and one or more network interfaces all known in the art, a plurality of end user devices 1200, 1300, and one or more third-party job server systems 1500 coupled to a public network 1100, such as the Internet and/or a cellular-based wireless network.

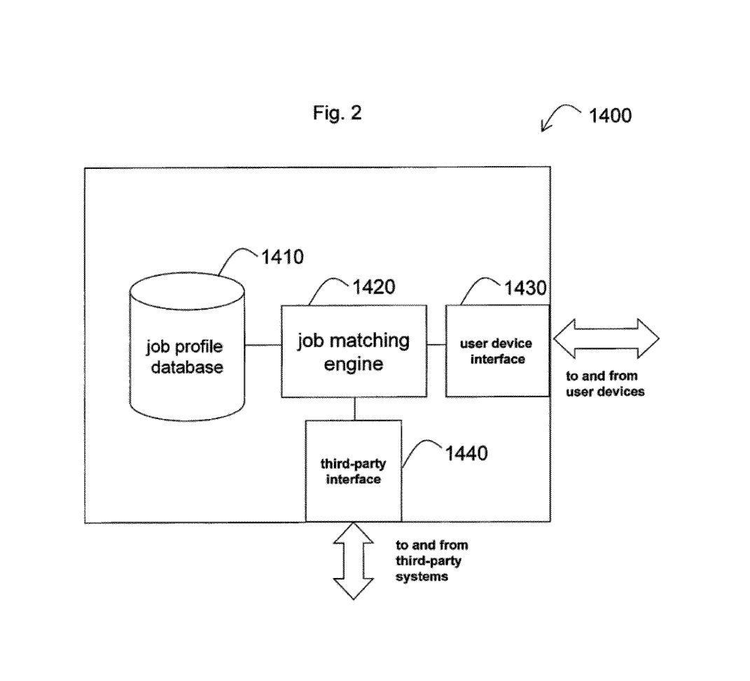

An example embodiment of the employment matching server system 1400 is shown in FIG. 2. The employment matching server system 1400 generally includes a computer application job matching engine 1420 designed to match end users who are job seekers (also referred to herein as candidates) with jobs at which the potential to have a successful employment is optimized and/or employers who are also users of the matching server system 1400 with similarly optimized candidates. To obtain potential matches, each job seeker must be represented by a plurality of normalized descriptors or “candidate profile” and each employer must be represented by a plurality of normalized descriptors or “employer profile.” A candidate profile includes data and factors which have been empirically shown to be relevant to finding and establishing successful employment job seekers. These data and factors include, but are not limited to, education, work experiences, past employers, values, interests, preferences, personality factors, and so on. An employer profile includes data and factors potentially relevant to finding a successful employee for that employer. These data include, but are not limited to, job descriptions, job requirements, culture measures, personality measures of current employees, market and business factors, and so on. Candidate profile data will be collected via online questionnaires completed by each individual in order to describe themselves. Employer profile data include data aggregated from relevant candidate users, questionnaires completed by current employees of the employer surveyed off-site, and third party data purchased from industry tracking services such as Hoover's. An exemplary approach to establishing a profile for a user is described in detail in U.S. Pat. No. 7,454,357, issued to J. Galen Buckwalter et. al. on Nov. 18, 2008, which is hereby incorporated by reference in its entirety (“the Buckwalter patent”).

The candidate and employer profiles, and vacant jobs associated with each employer are stored in the database 1410, which may be one or more logical or physical databases. The profiles and jobs are organized by the user's (candidate or employer) profile identification (“ID”). In the process of creating potential employment matches for a particular job seeker, a job matching engine 1420 queries the job seeker's profile by its respective ID, and correlates that profile with employer profiles as linked to specific jobs to calculate a compatibility value, or predictive score. In some embodiments, if a candidate profile and one or more employer profiles generate a compatibility value, or predictive success score, that meets or exceeds a predefined threshold, then there is potential for the respective job seeker and one or more employers to have a satisfactory and/or successful employment relationship if matched. This calculation can also incorporate data based on a user's (candidate or employer) previous history of matches and satisfaction rate as well as the history of other users with comparable empirical data, thereby enabling a feedback system that allows the system 1400 to “learn” how to optimize the scoring calculation. This process can also involve developing and utilizing a “neural network” to resolve problems in complex data. Details of this calculation and correlation process and the neural network are also described in the Buckwalter patent, which describes an exemplary compatibility value in the form of a “satisfaction index.”

In some embodiments thresholds need not be used in order to predict satisfactory and/or successful employment relationships. For example, users (candidates and employers) will be able to search for each other and see results that show all levels of compatibility rather than a selection or subset thereof. In many of these embodiments only automatic matching conducted by the system will require a minimum compatibility score using a threshold.

According to an embodiment, the job matching engine 1420 may leverage users of the matching system of eHarmony, Inc. to create job satisfaction models. The job matching engine 1420 may also interface with other third-party online employment or other matching systems 1500, e.g., LinkedIn, Monster.com, CareerBuilder.com, etc. Such interfaces may be used to post and/or retrieve job listings, company profiles, job seeker's resumes, and so on.

In an embodiment, the job matching engine 1420 is configured to generate more than one compatibility values, or predictive scores, between two or more correlated profiles, where each compatibility value, or predictive score, is associated with a different set of factors and/or different weighing of factors.

In another embodiment, the system 1400 further provides a resume building application for the job seekers. The system 1400 may also provide the employment matching service on a free or subscription based model. The subscription fee may have one or more tiers, each tier offering a different level of services. Some of these models will be described with regard to FIGS. below.

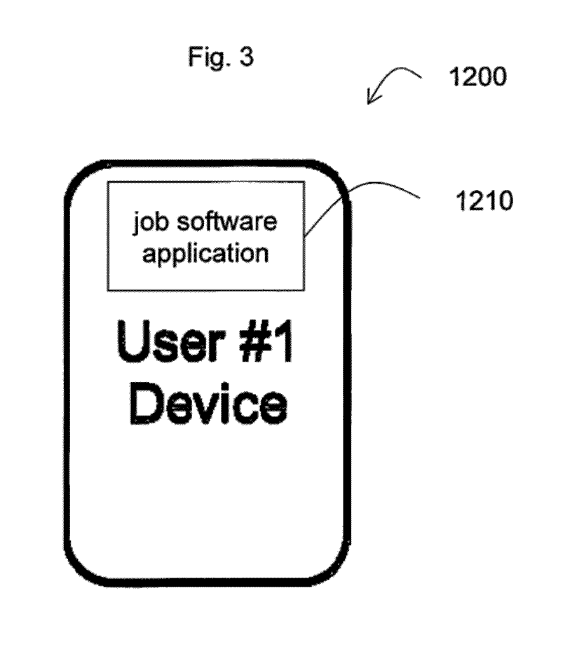

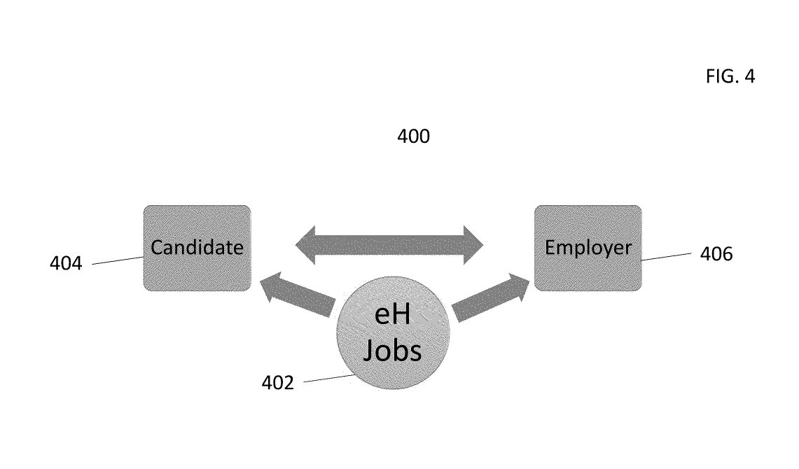

In another embodiment, the system 1400 includes a software application that may be pushed to, or downloaded to, and installed on user devices 1200, 1300, as shown in FIG. 3.

Features in the embodiments described above include:
Matching engine that calculates measurements of personality and values being collected on individuals, measurements of culture and values being collected on companies, and the methods of comparison between these used to generate predicted compatibility/satisfaction/engagement scores.
Electronic system that describes companies based on data collected from surveys administered on the internet
Electronic system that generalizes descriptions of specific companies to taxonomies or “company types” (i.e., company industry sectors×company size×company location)
Electronic system that generalizes compatibility scores from specific companies to compatibility with Company Type profiles
Electronic system that uses the product of user descriptions and company descriptions as the primary input features in models of predicted compatibility/satisfaction/engagement
Electronic system that uses the absolute difference multiplied by the sum of individual and company scores on matched individual values and company culture factors as a primary input feature into empirically validated statistical models of predicted compatibility/satisfaction/engagement
Electronic system that uses the absolute difference multiplied by the sum of candidate and current worker scores on matched personality factors as a primary input feature into empirically validated statistical models of predicted compatibility/satisfaction/engagement

FIG. 4 shows an example embodiment of a system 400 of facilitation between candidates 404, employers 406 and an online job matching system 402 according to an embodiment of the present invention. In the example embodiment employers 406 (also referred to as companies herein) typically will interact with an interface of online job matching system 402 in order to establish an employment candidate search. In many embodiments, numerous employers may be passive users of the system, in that they will be profiled based on empirical data gathered from their current employees, and/or will be associated with a company type profile, and this information will be used to generate compatibility scores for candidates in order to evaluate jobs for potential employment. Company type profiles may describe companies in similar fields, of similar size and in similar locations in order to generalize information for companies for which direct information may not be known. Previously, subsequently or contemporaneously, candidates 404 (also referred to herein as job seekers) will typically interact with an interface of online job matching system 402 in order to establish an employment search. Candidates 404 may create profiles, register for the system, search public postings, and engage in other actions while searching for employment using online job matching system 402. Online job matching system 402 will generally facilitate interaction and communication between candidates 404 and employers 406 through the site including using digital images, textual communications, statistical models, video interactions and other communication tools. After initial interaction through online job matching system 402, candidates 404 and employers 406 may interact outside online job matching system 402 such as by meeting in person and completing a hiring process.

Automatic matching of candidates to jobs using online job matching system 402 is performed by the system and is based on compatibility. In various embodiments the system may send email and push notifications to facilitate consideration and communication between candidates and employers.

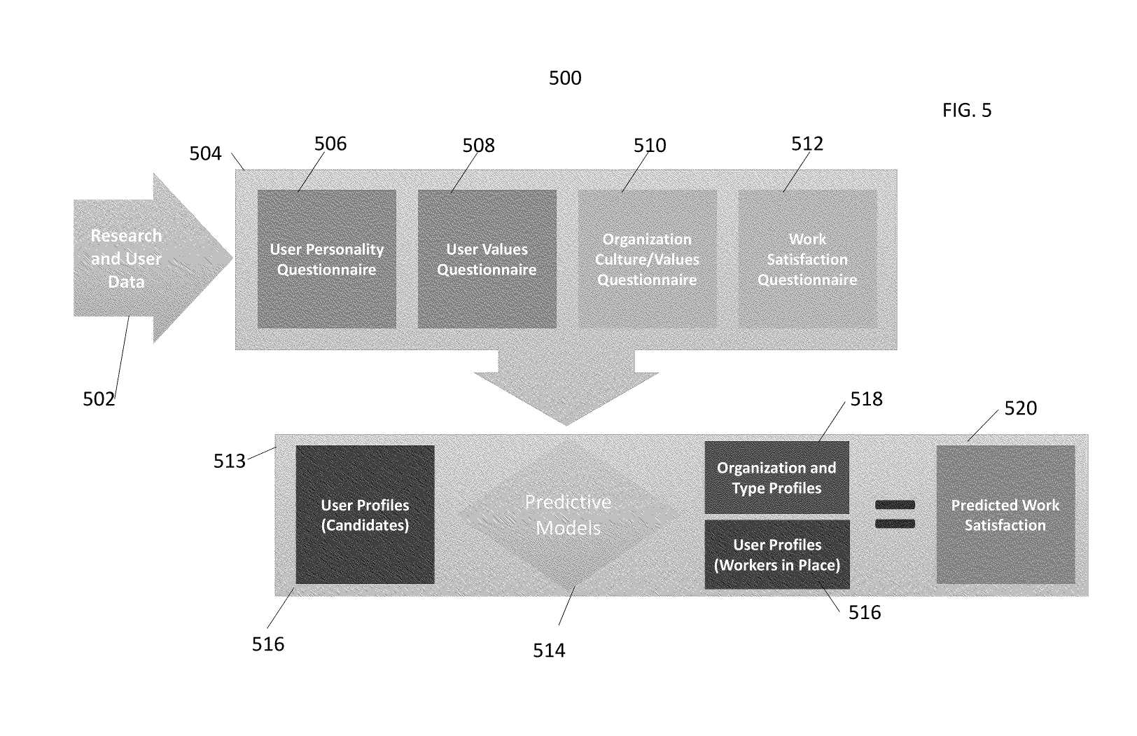

FIG. 5 shows an example embodiment of system blocks 500 in accordance with the present invention. In the example embodiment research and candidate survey data 502 is included and utilized in developing profile information for employers and predictive algorithms 514. Employer Profile information 504 may be a composite of user personality questionnaire 506s, user values questionnaire 508s, organization culture/values questionnaire 510s, work satisfaction questionnaire 512s, and others. Candidate profile information 516 may include self-identified information supplied by users in questionnaires, resumes, photographs, and other profile information.

The system uses predictive models 514 in order to analyze user profiles and organizations and type profiles 518 in predicting work satisfaction 520.

An example embodiment of a conceptual predictive model includes personality factors A-F, personal values factors G-K and employer culture factors L-P used in a formula such as f[(Asubu)(Gsub(U-u))bsubi+ . . . + (Ksubi)(Psub(U-u))bsubi where dependent measure for training weights bsub(i-k)=Job Satisfaction and performance. In the example embodiment some main effects may be partialed out and/or controlled.

Examples of personality factors identified in a user personality questionnaire 506 may include aggressiveness, agreeableness, athleticism, attachment/autonomy, collaboration, conscientiousness, emotional stability, empathy, extraversion, openness, positive affect, self-esteem, social orientation, and others. Examples of values factors in organization culture/values questionnaire 510 and/or user values questionnaire 508 may include autonomy/independent thinking, communicative leadership, company stability, daily perks, daily stability, environmental consciousness, innovation, market position, motivational, opportunity for growth, orderliness, playfulness, prestige, respect for employees, serenity, socially responsible, team spirit, work complexity, work-life balance, and others.

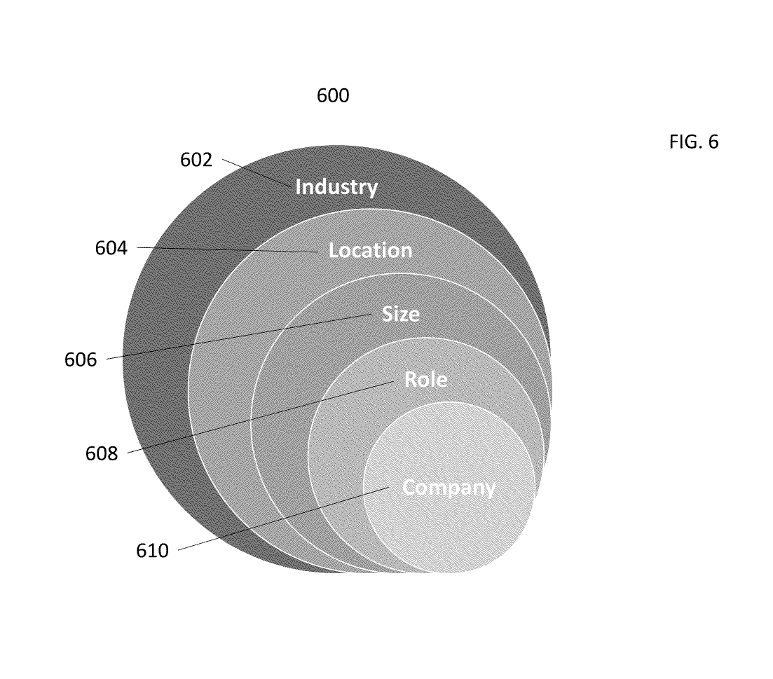

FIG. 6 shows an example embodiment of a scoring abstraction 600 in accordance with the present invention. In the example embodiment culture profiles may be generated utilizing escalating levels of generalization. This may allow the system to generate compatibility scores between candidates and employers for whom no direct data is available. In other words, the system allows for abstraction of employer qualities based on similarly situated employers. Relative values of general compatibility scores may be estimated in part on consistency of scores within a level of abstraction. In some embodiments this means calculating a standard deviation of any and/or all average scores and using a resulting confidence interval for an estimate of compatibility. In the example embodiment levels of scoring abstraction are represented as circles. A first, smallest circle is a unique company/employer level of abstraction 610. A next, higher level of abstraction is a role abstraction 608 which may represent the employer's role, i.e. parts distributor, component manufacturer, subcontractor, contractor, service based, and/or others. A next, higher level of abstraction is a size abstraction 606 which may be based on one or more metrics such as number of employees, gross revenue per year, net revenue per year, percent market share, and/or others. A next, higher level of abstraction is location abstraction 604 which may include a particular town, city, county, state, province, region, and/or others. A next, higher level of abstraction is an industry abstraction 602 which may include a particular industry or industry subset. Examples of different industry and sub-industry levels include the medical field, medical device manufacturers, heart implant manufacturers, manufacturers of integrated circuits used in heart implants, etc.

Each level of abstraction may have a generalized profile. Generalized profiles may be generated based on aggregated responses from workers in place at companies fitting the group described. In an example embodiment a candidate may be interested in evaluating potential employment at an employer “CanineCampers” in Santa Monica, Calif. If the system has no information about employer CanineCampers (for instance because CanineCampers has not yet registered with the system or is a new employer) then an abstraction may be created. In an example embodiment an average innovation factor score for all organizations in the consumer internet service industry, residing in the Santa Monica area, and fewer than 100 employees would be calculated by the system and potentially used to extrapolate a score for CanineCampers.

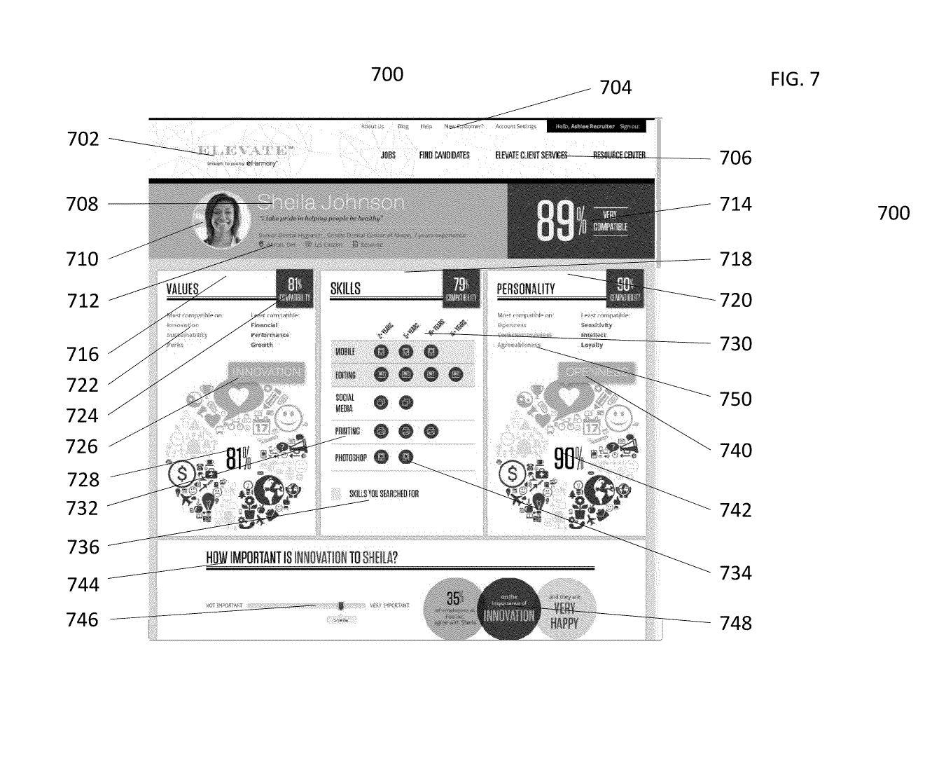

FIG. 7 shows an example embodiment of a candidate profile 700 as it may be shown in an employer interface in accordance with present invention. In the example embodiment a title and/or homepage button 702 is shown. Although in the example embodiment it is located in the top-left of the interface the title and/or homepage button 702 will generally be located in the top of the interface but, as with many other buttons and fields that will be described below, could be located elsewhere as appropriate. Informational navigation buttons 704 may include an “About us” button that describes the system, a “Blog” button, a “Help” button, a “New Customer?” button, an “Account Settings” button, an active account identifier button (“Hello, Ashlee Recruiter” in the example embodiment), a “Sign out” button, and others. An employer managing buttons section 706 may include buttons for an employer to post “Jobs”, “Find Candidates”, “Elevate client services”, a “Resource Center”, and others.

Candidate profile 700 may include a name/title field 708 (“Sheila Johnson”) and a personal image, photograph, or avatar location 710. In some embodiments selecting this location may allow scrolling, viewing, or selecting additional images. Identifying information 712 may include information such as a personal quote (“I take pride in helping people be healthy” in the example embodiment), a location (“Akron, Ohio” in the example embodiment), work status information (“US Citizen”), short blurb (“Senior Dental Hygienist, Gentle Dental Center of Akron, 7 years experience”), resume button, and/or others. Also included at the top of the page for intuitive viewing is an enlarged compatibility score 714. The compatibility score may be rated on many different scales, in the example embodiment a percentage score is used with 100% being highly compatible and 0% being less compatible. Also included may be one of numerous descriptors. In the example embodiment the candidate is shown as having an 89% and a “very compatible” description.

The system may display numerous categories on a candidate profile 700 which describe aspects of a candidate. In the example embodiment a “Values” category 716, “Skills” category 718, and “Personality” category 720 are shown. A “Values” category 716 may include lists 722 a “Most compatible on:” list (ex: innovation, sustainability, perks) and a “Least compatible on:” list (ex: financial, performance, growth). A graphical depiction of values may show a most compatible value in large script and a compatibility percentage 724, 728 may be displayed in multiple locations. Graphical icons may be displayed in varying sizes relating to highest and lowest compatibilities and various colors may be used to highlight positive and negative connections.

Similar to the “Values” category 716, a “Personality” category 720 may show lists 722 a “Most compatible on:” list (ex: openness, conscientiousness, agreeableness) and a “Least compatible on:” list (ex: sensitivity, intellect, loyalty). A graphical depiction of values may show a most compatible value in large script and a compatibility percentage 742 may be displayed in multiple locations. Graphical icons may be displayed in varying sizes relating to highest and lowest compatibilities and various colors may be used to highlight positive and negative connections.

A “Skills” category 718 may include a listing of different attributes in a column 732 (ex: mobile, editing, social media, printing, photoshop) and a time amount in years row 730 (ex: “2+ years”, “5+ years”, “10+ years”, “15+ years”).

Candidate profile 700s may be created using a profile building process including uploading photos, inputting information and completing questionnaires such as general demographics, values and culture, personality and value, company value, and/or company satisfaction. Photos may be uploaded through third party APIs or via file and candidates may be able to view current photos, upload different photos, save photos, close interfaces and/or adjust photos. General demographics questionnaires (GDQ) may include questions relevant to a candidate's demographics, residency, and willingness to travel. Values and culture questionnaire (VCQ) may include questions relevant to computing a candidate's compatibility with an employer. Personality and value questionnaire (PVQ) may include questions relevant to computing a candidate's compatibility with a manager. Company value questionnaire (CVQ) may include questions relevant to understanding the culture of a candidate's current employer. Company satisfaction questionnaires (CSQ) may include information relevant to a candidate's satisfaction with the candidate's current job.

Candidates may skip sections only on chapter header pages. Answers in each section may be saved upon a page exit by logging out, selecting a continue option, skipping to a next section, skipping directly to a search, clicking a persistent navigation link. When a candidate returns to an incomplete section they may be presented with a first unanswered question in the section. Sections which are incomplete may not be used to compute compatibility. Completing VCQ, CVQ, CSQ may give a candidate the opportunity to view search results and a current company compatibility report in addition to a search button. If candidates skip directly to a search the candidate may skip to automated search results or candidate defined search builders depending upon what information the candidate has previously provided.

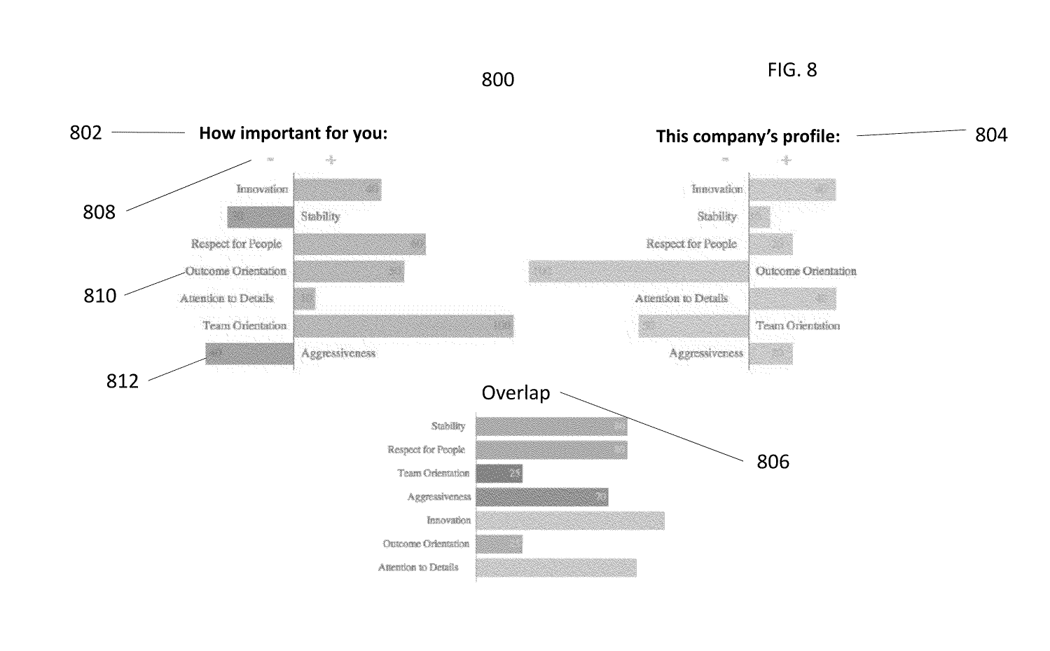

FIG. 8 shows an example embodiment of compatibility visualizations 800 in accordance with the present invention. In the example embodiment three charts are shown. First is “How important for you” chart 802 which shows the importance of particular metrics to a candidate. Second is “This company's profile” chart 804 which shows the importance of particular metrics for a particular company or employer that the candidate may be researching. In the example embodiment each of the metrics shown are the same while in other embodiments there may be additional non-overlapping metrics. In many embodiments levels of the metrics shown in chart 802 and 804 are derived from questionnaires and other analysis of a candidate and employer profile. Third is “Overlap” chart 806 which shows a composite chart with a combination of chart 802 and 804. “Overlap” chart 806 is useful for both candidates and employers since it identifies strengths and weaknesses in compatibility during a preliminary stage in the employment searching process. If many negative correlations and few positive correlations are shown then the system may identify that the match may not be successful. Alternatively, if many positive correlations and few negative correlations are shown then the system may be able to identify that the match may be successful. In some embodiments compatibility may be ranked using a scale between 0 and 100%. The system may then label particular ranges considering all compatibility factors as “Highly Compatible”, “Average Compatibility”, “Below Average Compatibility”, “Low Compatibility” and/or others as appropriate.

In the example embodiment each of chart 802 and 804 may have a field 808 identifying importance or lack thereof of particular attributes. Important attributes to a candidate or employer will be shown under the plus sign while unimportant attributes will be shown under the negative sign. Metrics 810 in the example embodiment include innovation, stability, respect for people, outcome orientation, attention to details, team orientation, aggressiveness, and others. Each metric is associated with a bar including a numerical value representative of a relative value of importance. The numerical value may be determined in relation to similarly situated candidates or employers or may be determined on a different basis. Overlap chart 806 may use color coding to intuitively show candidates and employers which categories may have a high compatibility and which may have a lower compatibility. In the example embodiment green may be used to show above average compatibility while red may be used to show below average compatibility.

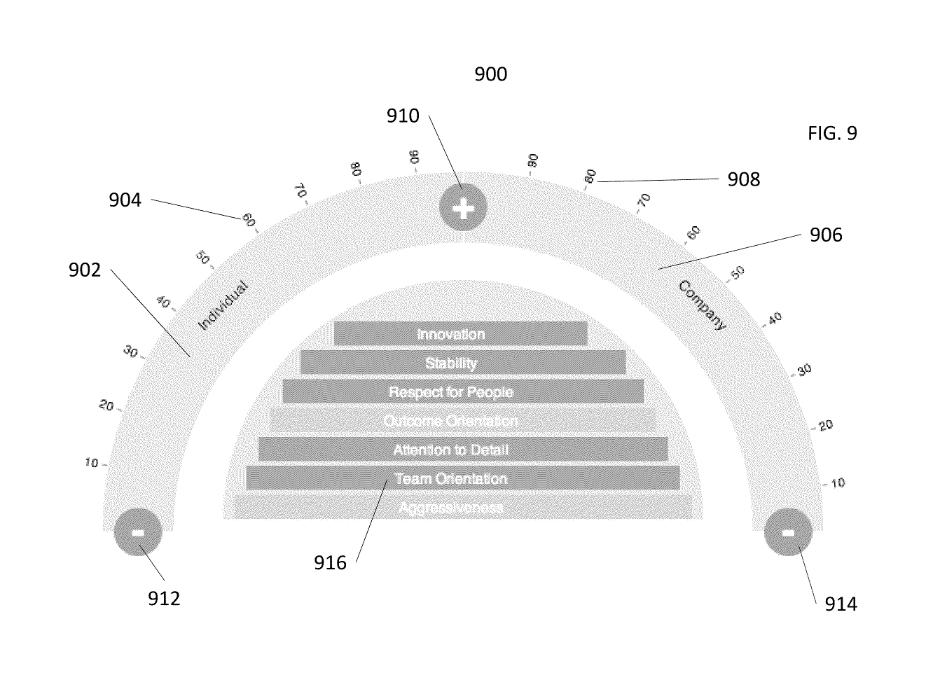

FIG. 9 shows a general dynamic compatibility indicator 900 in accordance with the present invention. In the example embodiment a candidate side 902 and employer side 906 are shown with candidate scores 904 and employer scores 908. Also shown are positive candidate and employer indicator 910, negative candidate indicator 912 and negative employer indicator 914. Metric list 916 is shown in the center and may be color coded to intuitively show strong compatibility or weak compatibility as described previously for other metric comparisons.

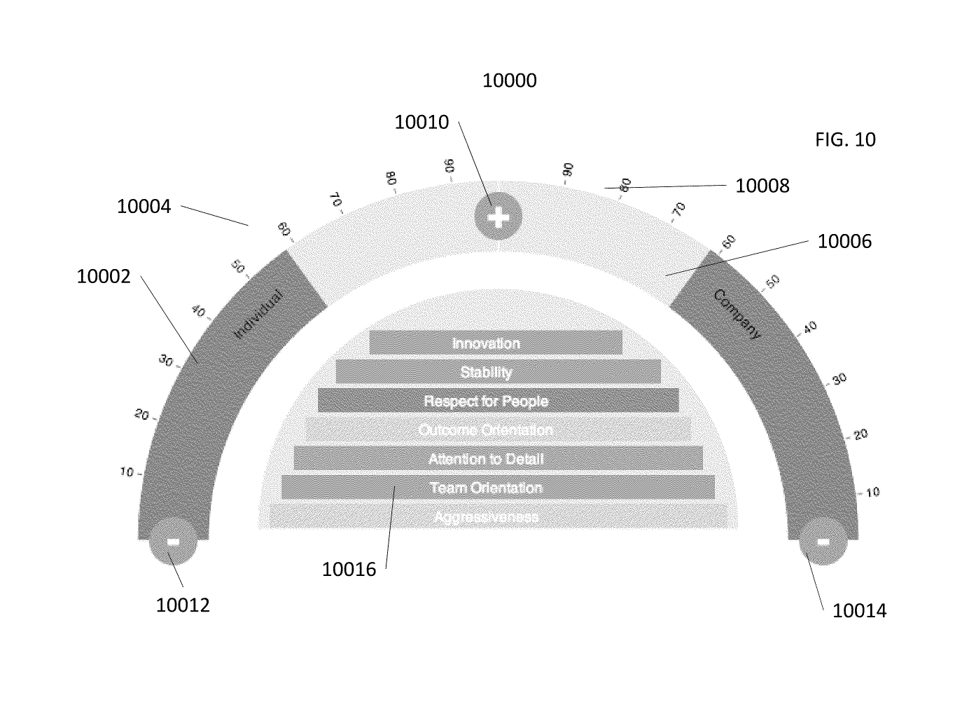

FIG. 10 shows a candidate/employer specific dynamic compatibility indicator 10000 in accordance with the present invention. This indicator is similar in nature to the general dynamic compatibility indicator 900 shown in FIG. 9 but represents a comparison of a particular candidate and employer. In the example embodiment a candidate side 10002 and employer side 10006 are shown with candidate scores 10004 and employer scores 10008. Also shown are positive candidate and employer indicator 10010, negative candidate indicator 10012 and negative employer indicator 10014. Metric list 10016 is shown in the center and may be color coded to intuitively show high levels of compatibility or low levels of compatibility as described previously for other metric comparisons. In the example embodiment the candidate side 10002 is filled to slightly less than 60%, indicating that the candidate may be a better candidate for the employer than nearly 60% of similarly situated candidates. The employer side 10006 is filled to slightly greater than 60%, indicating that the employer may be a better employer for the candidate than greater than 60% of similarly situated employers. Green metrics in metric list 10016 include team orientation, stability and innovation, indicating that these metrics may be points of particular compatibility between the candidate and employer. Red metrics in metric list 10016 include attention to detail indicating this metric may be a point of contention between the candidate and employer. Yellow metrics in metric list 10016 include aggressiveness and outcome orientation, indicating that these metrics may be neutral between the candidate and employer. Black metrics in metric list 10016 include respect for people, indicating that the system may not have enough information to generate a compatibility score between the candidate and employer and more surveys, questionnaires, and/or analysis may need to be performed by the candidate/employer/system before a predictive metric can be generated.

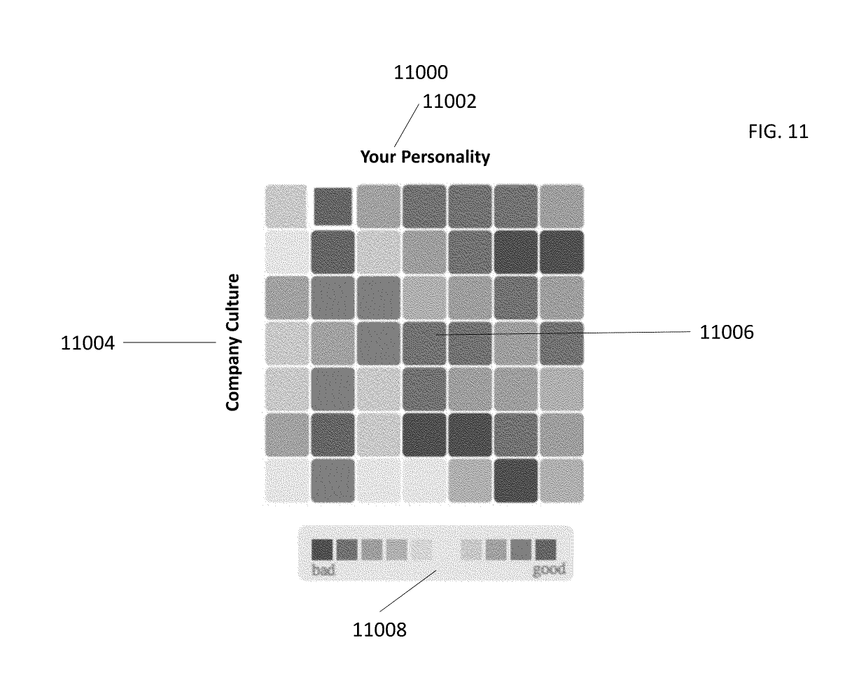

FIG. 11 shows an example embodiment of a relative component importance map 11000 in accordance with the present invention. In the example embodiment a candidate personality side 11002, company culture side 11004, heat map 11006 and heat map key 11008 are shown. This visualization may represent the power and direction of each interaction between users personality and values profile and the culture scores for an employer in relation to predicting a candidates likely satisfaction in the employer's workplace.

The heat map 11006 includes tiles, where each tile represents the intersection of a personality or values factor (candidate score) and a culture factor (employer score). A color represents whether the interaction predicts a positive or negative outcome, and the intensity of the color indicates the strength of this unitary prediction. In the example embodiment colors may range from red to orange, pink, yellow, green, aqua, and blue indicating poor intersections to good intersections respectively. In an example embodiment a candidate and/or employer may hover a cursor over or select a particular tile to receive more information about levels of compatibility of the personality or values factor and/or culture factor.

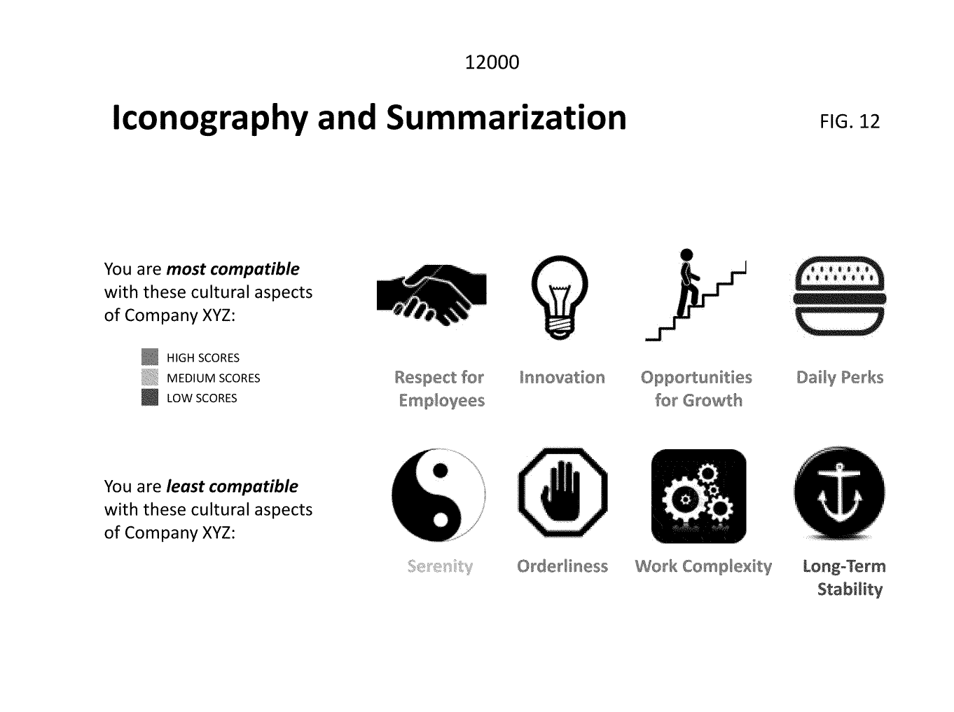

FIG. 12 shows sample icons and summarizations 12000 in accordance with the present invention. In the example embodiment the system may present this screen to a candidate to show the candidate probable compatibility metrics. In the example embodiment appropriate, logical icons are shown for each attribute including: a handshake for respect for employees, a light bulb for innovation, a staircase with a person climbing for opportunities for growth, a food depiction for daily perks, a yin yang for serenity, a stop sign with a hand for orderliness, gears for work complexity, an anchor for long term stability, and others. As previously described, color coding may be used to aid in intuitive understanding of each icon.

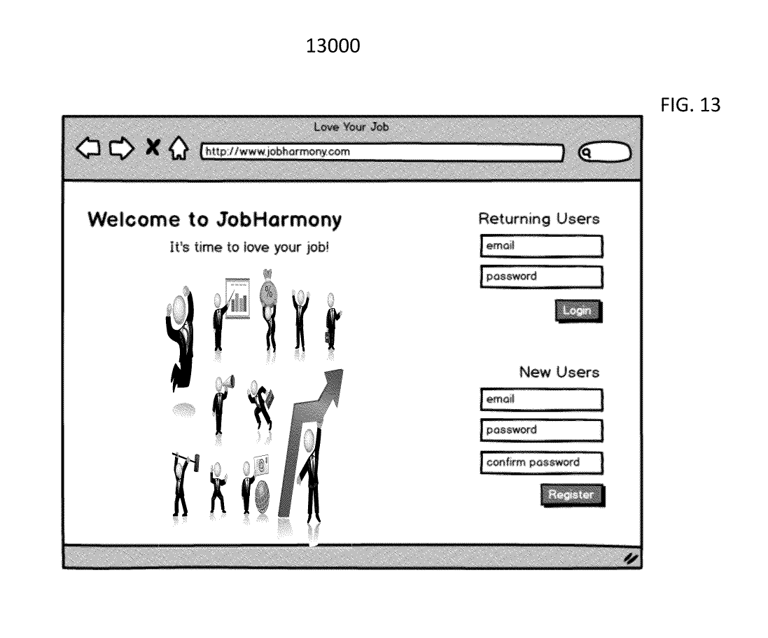

FIG. 13 shows an example embodiment of a system login screen 13000 in accordance with the present invention. Included are fields for returning users to enter a username/email address and password and fields for new users to sign up with an email address, password, and password confirmation.

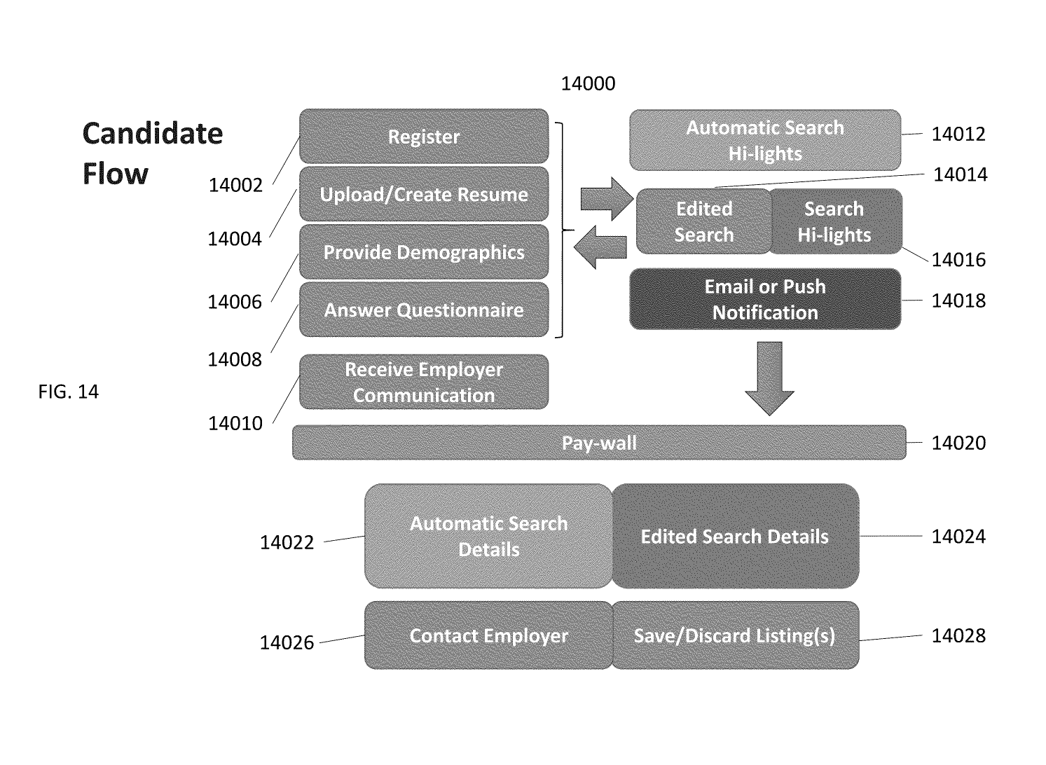

FIG. 14 shows an example embodiment of a candidate flow map 14000 in accordance with the present invention. In the example embodiment candidates may initially register 14002, upload/create a resume 14004, provide demographics information 14006, and answer questionnaires 14008. Based on information identified in these sections, candidates may perform searches using search editing 14014 and search highlights 14016. The system may present automatic search highlights 14012 and send email or push notifications 14018 to the candidate. The candidate may also receive employer communication 14010. Each of the previously stated functions in this embodiment may occur in front of pay-wall 14020. Once reaching pay-wall 14020, the system may require candidates to become paying subscribers before allowing additional functionality. Functionality available behind pay-wall 14020 may include automatic search details 14022, edited search details 14024, employer contact 14026, save/discard listings 14028, and others.

Employment searching for candidates may include the ability for candidates to search for jobs using multiple criteria including location, job attributes, skills, pay level, number of employees, industry, and many others. Candidates may also search for employers based on compatibility ranks, compatibility score for jobs, and others.

Candidates may fall into various categories based on their status in the system. A first candidate status may be incomplete job seeker. This status may mean that a candidate has registered with the system but has not validated an account yet (for instance, by clicking a verification link in an email from the system to the candidate's attempted registration email address). Incomplete job seekers may not be able to view current employer/company compatibility ratings/rankings or search for jobs.

A second candidate status may be registered job seeker. Candidates with this status may have validated an account registration themselves (for instance, by clicking a verification link in an email from the system to the candidate's registration email address) or have been registered by the system through other means (such as by linking a profile from social media, using customer service, or others). Registered job seekers may be able to complete their candidate profile and search for jobs using the system.

A third candidate status may be subscribed job seeker. Candidates with this status may be registered job seekers who have completed the additional step of paying for a subscription with the system (which is up to date and currently active). Subscribed job seekers may be able to search and see all job details available and have access to apply for jobs using the system. Subscribed job seekers may also be able to interact with employers using site communication tools such as messaging, etc.

Job seekers/candidates may be further categorized to define available actions and system behaviors related to candidate experience on the site and also for internal and external business analytics and reports. Subscription statuses may be incomplete, pre-registered, registered, subscriber, expired, closed, flagged and/or others. Additionally profile status information may include a determination as to whether the candidate has completed one or more of personality profile, values profile, company profile, job satisfaction questionnaire, resume and/or others. Subscribed job seekers may be further categorized using an email status such as receives marketing emails, receives newsletter emails and/or receives match notification emails. Subscribed job seekers may also be categorized as profile searchable and/or viewable.

Candidates may receive various types of email messages and other notifications from the system in various embodiments. These may include notifications of generic matches, detailed matches, contacts, applications, marketing, instructional, newsletters, and administrative. Generic match notifications include notification of compatible jobs but may not provide specific information or contact links. Detailed match notifications may include notification of compatible jobs with specific information and/or contact links. Contact notifications may include notifications that an employer has sent a message. Marketing notifications may include marketing messages and promotions. Instructional notifications may include instructions and/or tips to assist candidates in optimizing their experience. Newsletters may include content relevant to the system experience in addition to the brand and may entice candidates into using the system. Administrative notifications may include notifications such as validation request for registration, notice of registration, notice of subscription, notice of renewal, notice of expiration, notice of closure, notice of account information change, notice of payment failure, notice of administrative action (such as suspension of account, etc.) and others.

Candidates may receive various messages while using the system based on a role, status, recent activity and/or the activities of hiring companies that have interacted with their information. These may include messages regarding unread messages, resume uploading, current company compatibility report review, subscription issues, profile completion, saved job applications, friend/colleague referral, report/article recommendations, quiz/questionnaire, number of unread messages, number of unreviewed matches taking and others.

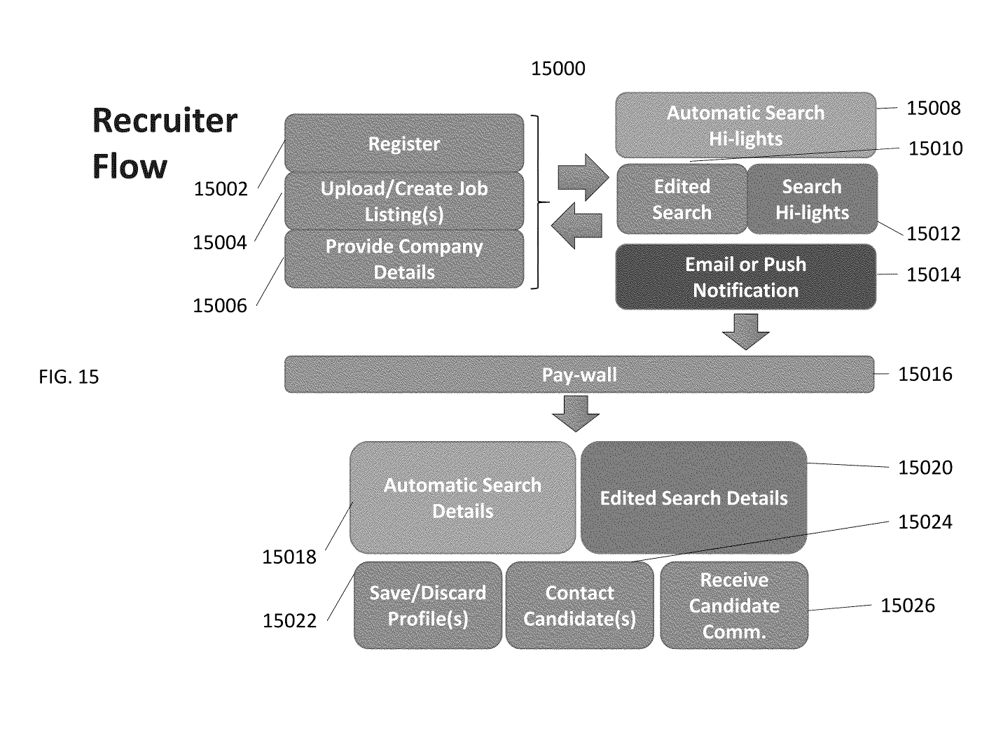

FIG. 15 shows an example embodiment of an employer flow map 15000 in accordance with the present invention. In the example embodiment employers may initially register 15002, upload/create job listing 15004s and provide company details 15006. Based on information identified in these sections, employers may perform searches using search editing 15010 and search highlights 15012. The system may present anonymized automatic search results 15008 based on a plurality of business rules, action-optimized algorithms and computed compatibility with a job description uploaded by an employer and send email or push notifications 15014 of such matches to the employer based on one or more job descriptions. Each of the previously stated functions in this embodiment may occur in front of pay-wall 15016. Once reaching pay-wall 15016, the system may require employers to become paying subscribers before allowing additional functionality and specificity to search and matching results available for the user to review. Functionality available behind pay-wall 15016 may include automatic search details 15018, edited search details 15020, candidate contact 15024, save/discard profiles 15022, receive candidate communication 15026 and others. In some embodiments employers may be able to view previous job tenure of candidates in making employment decisions.

Employers may fall into various categories based on their status in the system. A first employer status may be incomplete hiring company. This status may mean that an employer has registered with the system bud has not validated an account yet (for instance, by clicking a verification link in an email from the system to the employer's attempted registration email address) and/or has not uploaded any jobs to the system.

A second employer status may be registered hiring company. Employers with this status may have validated an account registration themselves (for instance, by clicking a verification link in an email from the system to the employer's registration email address) or have been registered by the system through other means (such as by linking a profile from social media, using customer service, or others). Registered hiring companies may also have at least one job listing associated with an employer profile. Registered hiring companies may search for candidates relevant to the employer's job listing(s) using the system but may be restricted from using custom searching tools. Registered hiring companies may not be able to see candidate details or contact candidates and any job listings an employer has uploaded to the system may not be searchable and/or viewable by candidates.

A third employer status may be subscribed hiring company. Employers with this status may be registered hiring companies who have completed the additional step of paying for a subscription with the system (which is up to date and currently active). Subscribed hiring companies may have job listings searchable for candidates using the system. Subscribed job seekers may also be able to search for candidates relevant for the employer's job listing(s), may be able to search using custom parameters, may be able to see detailed candidate information, and may be able to interact with employers using site communication tools such as messaging, etc.

Hiring companies/employers may be further categorized to define available actions and system behaviors related to employer experience on the site and also for internal and external business analytics and reports. Subscription statuses may be incomplete—has not validated through link, pre-registered—does not require validation, registered—validated or logged as pre-registered, subscriber—paid and current subscription, expired—paid and lapsed subscription, closed, flagged and/or others. Additionally profile status information may include a determination as to whether the employer has completed one or more job listings. Subscribed employers may be further categorized using an email status such as receives marketing emails, receives newsletter emails and/or receives match notification emails.

Employers may receive various types of email messages and other notifications from the system in various embodiments. These may include notifications of generic matches, detailed matches, contacts, applications, marketing, instructional, newsletters, administrative and candidate applications. Generic match notifications include notification of compatible candidates that match a job listing but may not provide specific names of candidates or profile information. Detailed match notifications may include notification of compatible candidates that match a job listing with specific information including candidate names. Contact notifications may include notifications that a candidate has sent a message. Marketing notifications may include marketing messages and promotions. Instructional notifications may include instructions and/or tips to assist employers in optimizing their experience. Newsletters may include content relevant to the system experience in addition to the brand and may entice employers into using the system. Administrative notifications may include notifications such as validation request for registration, notice of registration, notice of subscription, notice of renewal, notice of expiration, notice of closure, notice of account information change, notice of payment failure, notice of administrative action (such as suspension of account, etc.) and others. Candidate application notifications may include notification that a candidate has applied to one of the employer's job listings.

Employers may receive various messages while using the system based on a role, status, recent activity and/or the activities of candidates that have interacted with their information. These may include messages regarding unread messages, resume uploading, current company compatibility report review, subscription issues, profile completion, saved job applications, friend/colleague referral, report/article recommendations, quiz/questionnaire taking, spring cleaning-to update job listings, number of unread messages, number of un-reviewed matches and others.

In some embodiments promotions, testing, and changes in activities and site behavior assigned to different user status values may be fluid, meaning that site behaviors and employer/candidate actions may change based on system permission. These fluid behaviors may include automatic search functionality, custom search functionality—including searching and scoring based solely on user defined search terms, basic search functionality—including searching using a candidate's current title/industry/zip code, current compatibility report viewing, job/candidate compatibility, clicking through to apply for jobs, sending communication to candidates, and/or others.

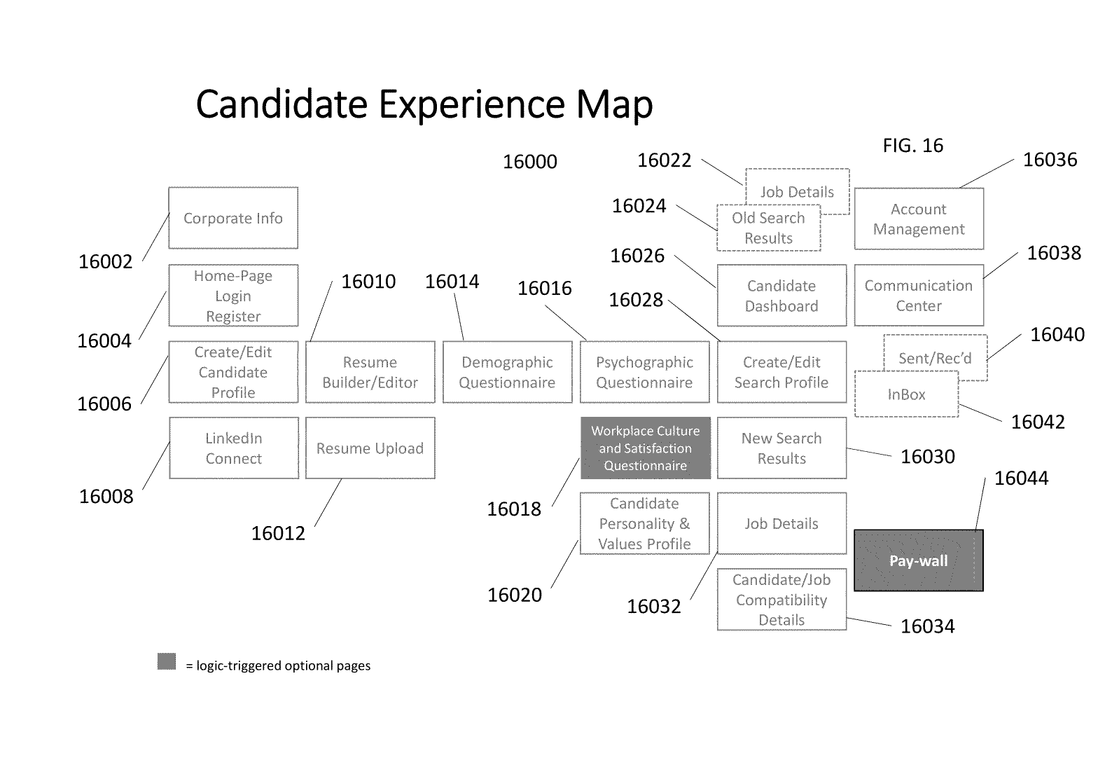

FIG. 16 shows an example embodiment of a candidate experience map 16000 in accordance with the present invention. In the example embodiment candidates may find corporate information 16002 in the system prior to a home-page login/register 16004. This may occur using search engines, advertising, or other means. Registration may include web-form registration with email validation, third party API registration (such as through social media sites or search engines), and pre-registration through administrative action. Once a candidate has logged in or registered the candidate may create and/or edit a candidate profile 16006 or connect to other sites (such as LinkedIn) 16008. Candidates may use a resume builder/editor 16010 and/or upload a resume 16012, such as with a text or other file. A resume builder may contain sections including experience (such as title, company name and dates), skills, education (such as degree, school, majors, minors, dates), certifications (such as name, authority, license, dates) projects (such as names, companies, dates, summaries, photographs/images, URLs) and others. Candidates may be able to add multiple entries for each section and multiple resumes in some embodiments. At any point a candidate may exit a resume creation page using a logout, site exit, or search button. The system may then present candidates with a demographic questionnaire 16014, psychographic questionnaire 16016, workplace culture and satisfaction questionnaire 16020, and others. Based on answers given in these and other questionnaires the system may create a candidate personality and values profile 16020. Candidates may view old search results 16024 and/or job details 16022 if the candidate is a returning candidate who has previously completed searches. In embodiments where the candidate is returning the candidate may not be required to complete questionnaires again if they have already been completed. The system may display a candidate dashboard 16026 including selections for account management 16036, communication center 16038, sent/received messages 16040, inbox 16042, and others. Candidates may create/edit search profile 16028s and view new search results 16030 before viewing job details 16032 and candidate/job compatibility details 16034. Candidates may then reach a pay-wall 16044 which requires the candidate to become paying subscribers before allowing additional functionality. Some functionality including current company compatibility report, automatic search results based on compatibility, build/refine search based on multiple criteria and weights, view job listing overview/stubs in search area, view detailed company and compatibility information for each job listing, apply to jobs using click-through to external sites, save searches, save job listings, receive notification of matches with compatible jobs, view matched jobs, view content and tips from employment specialists and hiring managers, respond to communications from hiring managers and others may be located behind pay-wall 16044.

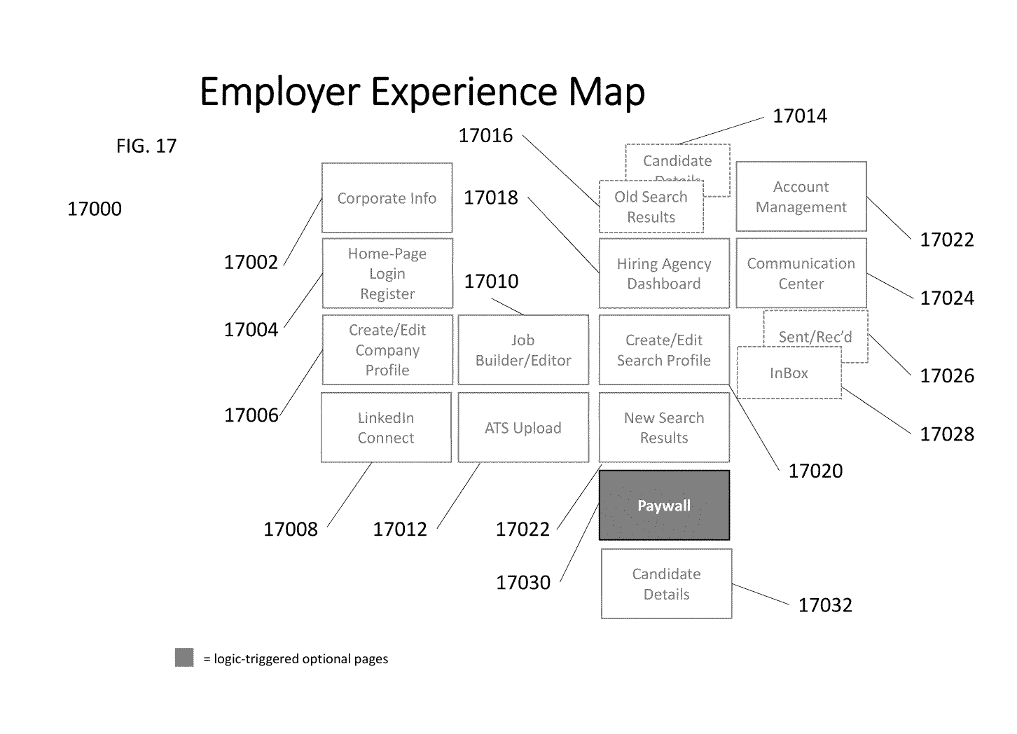

FIG. 17 shows an example embodiment of an employer experience map 17000 in accordance with the present invention. In the example embodiment employers may view corporate information 17002 about system administrators such as “About us”, contact us” and others. An early step is a home-page login/register 17004. Registration may be completed through web forms with email validation or through pre-registration through administrative action. Once an employer has logged in or registered the employer may create and/or edit an employer billing profile 17006 or connect to other sites (such as LinkedIn) 17008. Employers may use a job listing builder/editor 17010, upload Applicant Tracking System ATS 17012 and/or use a third party API— such as from a third party employment profile system. One example of a third party employment profile system is JobVite. Employers may designate or identify hiring managers and/or recruiters by selecting using a registered candidate list, linking a hiring manager to particular job listings and/or inviting hiring managers to create personality profiles. The system may then present employers with old search results 17016 and/or candidate profiles 17014 if the employer is a returning employer which has previously completed searches. The system may display an employer dashboard 17018 including match notifications with a date of match, a name, a current title, an overall compatibility score, a location, a “new” tag if the employer has not viewed the candidate yet, and other attributes. Match notifications may be displayed after each automated search run (nightly, weekly, etc.) and selecting a notification may take an employer to a compatibility report for a candidate or a pay-wall depending on employer status. Employers may view all matches if fewer than all received and not deleted candidates can be displayed on the dashboard above a fold. Selecting a view all matches link may take employers to a search results page displaying all matches in order of the date found. Employers may receive various messages or calls to action on the dashboard including uploading job listings, subscribe, reply to candidate communication, and others. Employers may have selections for account management 17022, communication center 17024, sent/received messages 17026, inbox 17028, and others. Employers may create/edit candidate search profile 17020s using multiple criteria and weights and may view new search results 17022 based on compatibility. Employers may then reach a pay-wall 17030 which requires the employer to become paying subscribers before allowing additional functionality. In the example embodiment additional functionality includes viewing candidate details 17032, receiving detailed compatibility reports for each candidate, communicating with candidates, saving searches and candidates, running regular searches for top compatible candidates (such as nightly, weekly, bi-weekly, etc.), using a mobile application and others.

Employers searching for candidates may search in at least three ways. First is an automatic search which includes searching and scoring based on an automatic process solely using an available job listing. Second is a refined search which includes searching and scoring based on user defined search terms in combination with an automatic process based on an available job listing. Third is a custom search which includes searching and scoring based solely on user defined search terms. In many embodiments employers must be subscribers in order to use custom search capabilities.

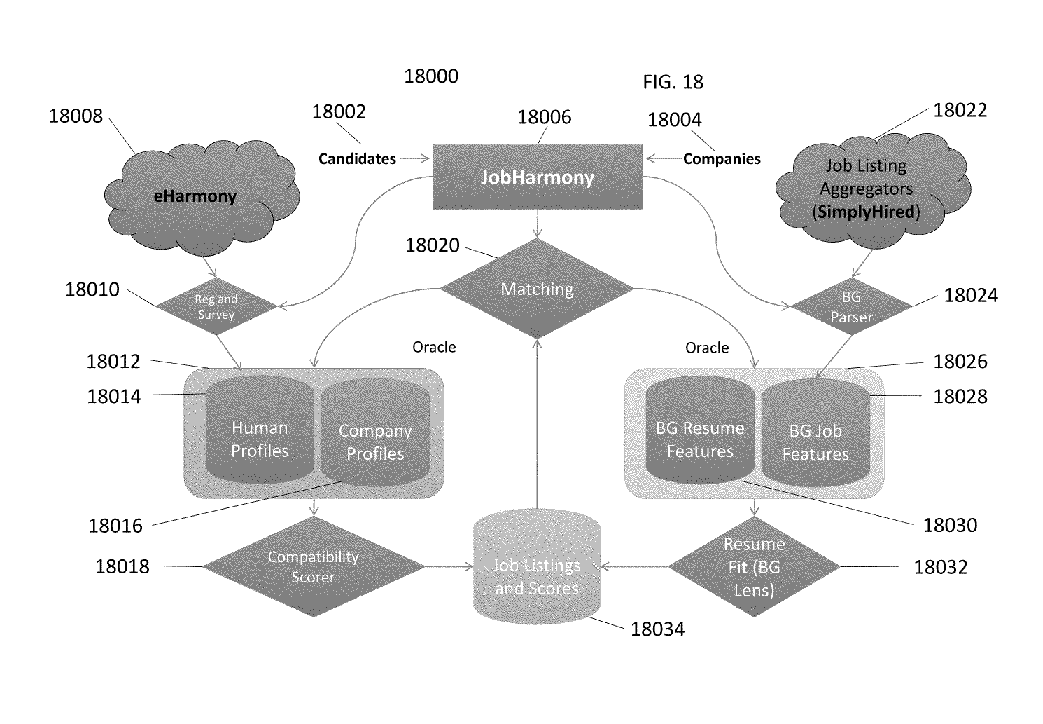

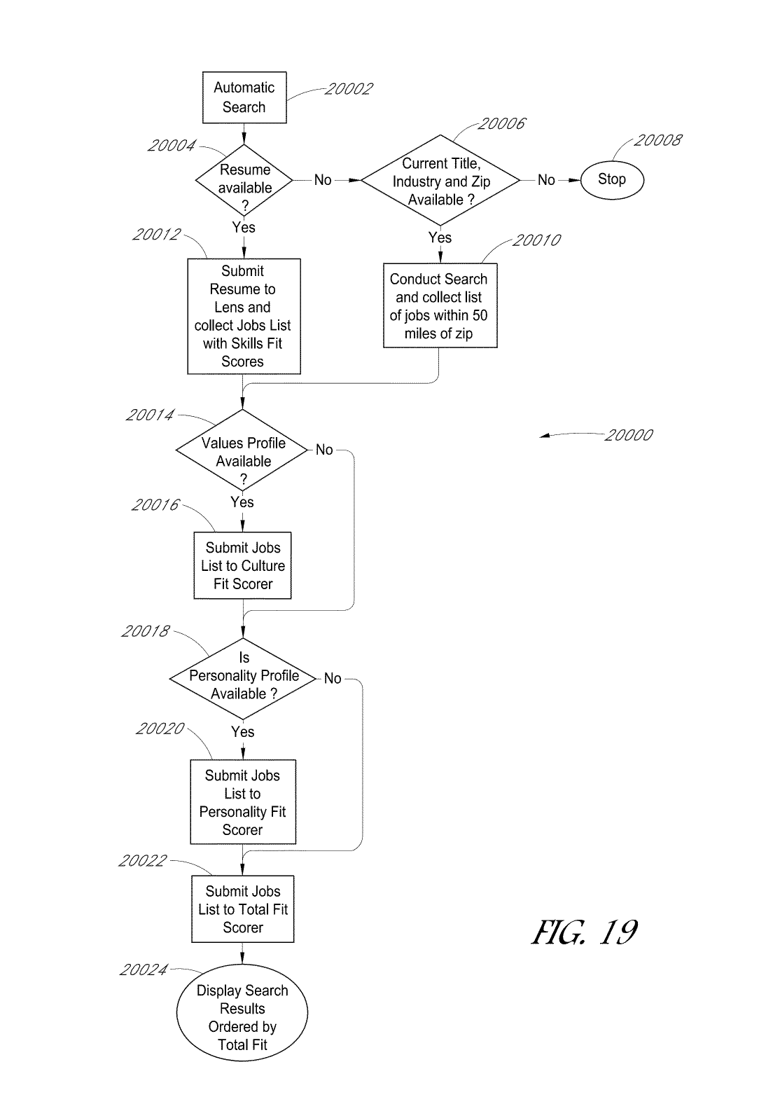

FIG. 18 shows an example embodiment of a dependencies schematic using interoperability between a relationship predicting program 18008 and third party jobs aggregator 18022 in accordance with the present invention. In the example embodiment candidates 18002 and employer 18004 sign up for employment matching system 18006. Candidates may also sign up for relationship predicting program 18008 and registration and survey 18010s may present candidate 18002s and employer 18004s (through employees such as hiring managers and others) to use aggregate information from each system. Additionally, employment matching system 18006 may perform matching of candidates 18002 and employers 18004 and store results in database 18012 in human profile database 18014 and company profile database 18016. Information from database 18012 may become an input to a compatibility scorer 18018, the result of which may be used in job listings and scores database 18034 and used to create matches that are delivered to candidates or employers 18020. Scoring a match does not mandate delivering it as a match. The mechanism for scoring something, even if those define a high compatibility as a match, is not the same mechanism as selecting a match. Selection may be dependent upon numerous scores and numerous independent business rules

Third party jobs aggregator 18022 may send information to parser 18024 which also receives information from employment matching system 18006. Parser 18024 may parse resumes and job listings and organize data into feature sets with unique taxonomies. Matching 18020 sends information to database 18026 which includes resume features database 18030 and job features database 18028. Matching 18020 may be a skills matching algorithm which in some embodiments is based on Bayesian models and may predict hiring based on a comparison of skills possessed by a candidate and job listing features and/or requirements. Information from database 18026 may be used by resume fit (Lens) 18032 which may output information to job listings and scores database 18034. Information from job listings and scores database 18034 may be used in matching 18020.

In some embodiments some or all members of a relationship predicting program 18008 may automatically be offered membership in employment matching program 18006 while in other embodiments specialized criteria may be used to select members for employment matching program 18006.

Compatibility scorer 18018 may use correlational models in order to calculate predictive scores. These models may be created using self-provided information of users of relationship predicting program 18008 including personality and values information, current work culture information and job satisfaction information to create scores for a number of predetermined factors and then using those factors to predict individual job satisfaction and performance across other employer.

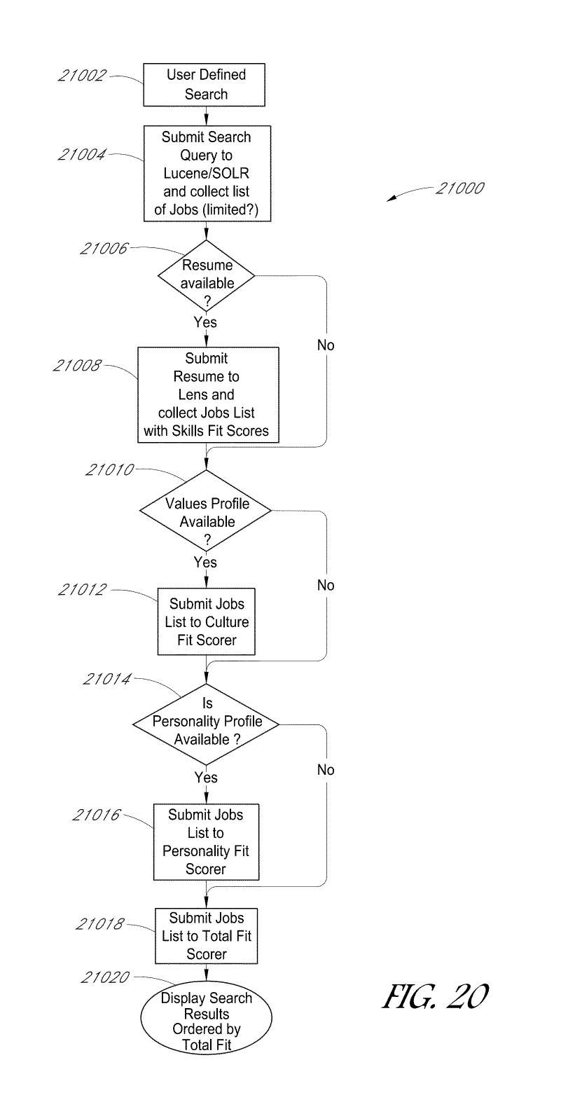

FIG. 19 shows an example embodiment of an automatic employment search flow 20000 for a candidate in accordance with the present invention. Automatic searches allow for search and scoring based on an automatic process based solely on available job seeker profile information. In the example embodiment a candidate may select automatic search 20002 from within an employment search system. The system may first automatically determine whether a candidate profile is available or prompt a user with a question as to whether a resume is available in step 20004.

In cases where a resume is available in step 20004, the system may prompt a user to upload or otherwise submit a resume to one or more third-party systems (such as Lens by burningglass) and then use the submitted resume to collect or compile a jobs list with Skills Fit scores and/or other scores in step 20012. Lens or other third-party software packages may be used for parsing resumes and job listings and generating fit-scores based on skills versus requirements (i.e., predicted match to a job based on candidates stated skills). The system may then determine whether a values profile for the candidate is available in step 20014. In cases where a values profile is available the system may submit the jobs list from step 20012 to a Culture Fit Scorer in step 20016. In cases where no values profile is available from step 20014 or the jobs list has been submitted to a Culture Fit Scorer in step 20016, the system may then determine whether a personality profile is available for the employer in step 20018.

In cases where a personality profile for the candidate is available the system may submit the jobs list to a personality fit scorer in step 20020. In cases where no personality profile for the candidate is available in step 20018 or the jobs list has been submitted to a personality fit scorer in step 20020, the system may then submit the jobs list to a total fit or overall fit scorer and/or evaluator in step 20022. After the jobs list has been submitted to the total fit scorer in step 20022, the system may display search results ordered by highest total fit to lowest total fit for the candidate to review in step 20024.

In cases where no candidate resume is immediately available in step 20004, the system may check to determine whether a current title, industry and/or Zip code are available in step 20006. In cases where there is no current title, industry and/or Zip code are available the system may simply stop or terminate the process in step 20008. In cases where a current title, industry and/or Zip code are available the system may conduct a search and compile or collect a list of job opportunities within a user-defined or system defined radius (in miles, kilometers or other units) of the specified Zip code in step 20010. The system may then proceed as described above from step 20014.

FIG. 20 shows an example embodiment of a refined employment search flow for a candidate 21000 in accordance with the present invention. Refined searches allow for search and scoring based on user defined search terms including criteria and weights in combination with the automatic process based on a job seekers profile information. Search queries may be displayed on custom search builder pages, custom search results pages, automated search results pages, refined search results pages, and basic search results pages. In the example embodiment the system receives a user defined search in step 21002 such as a search term and parameter category. In some embodiments searches may be saved and resubmitted at later times. Auto-complete may be used in some embodiments to suggest words or phrases. Candidates may be able to rank importance of a particular search term including low, medium, high, must have, and others. In some embodiments numerous search parameters may be used, up to twenty-five or more. In some embodiments the number of search parameters may be limited and candidates may be required to remove some before new ones are accepted. The system then submits a query to an electronic database and collects a list of jobs which may be limited or may not be in different embodiments. Next the system may determine whether a resume is available and prompt the user to provide a resume if not 21006. If a resume is available then the system may submit the resume to Lens and collect or compile a jobs list with skills fit scores in step 21008. After step 21008 or if no resume is available in step 21006, the system may determine if a values profile is available in step 21010. If a values profile is available the system may submit the jobs list to a culture fit scorer in step 21012. After step 21012 or if no values profile is available in step 21010, the system may determine if a personality profile is available in step 21014. If a personality profile is available the system may submit the jobs list to a personality fit scorer in step 21016. After step 21016 or if no personality profile is available in step 21014, the system may submit the jobs list to a total fit scorer in step 21018. After the jobs list has been submitted to a total fit scorer in step 21018 the system may display search results ordered by best total fit to least total fit for the candidate to review in step 21020.

Search results may be displayed for automated searches, refined searches, custom searches, and basic searches. For automated searches, if the candidate provided a resume or provided a resume and completed the values and culture questionnaire and/or completed the personality questionnaire and the candidate will receive automated search results that are based on skill compatibility (if available), culture compatibility (if available), and personality compatibility (if available). For refined searches, if the candidate refined an automated search, the results will be generated using a query built from the users industry and zip code and newly entered search terms and then scored for compatibility. For custom searches, if the candidate performs a custom search, the results will be generated using a query built solely from the terms and weights provided. No compatibility scoring will be performed. Ranking may be by search fit. For basic searches the results may be based only on the job seeker's zip code, industry and current title.

Search results may provide candidates with a high level overview of the job. Contents may vary according to candidate status. For subscribers, company name, company headline, job title, exact location, overall compatibility, values compatibility, skills compatibility, personality compatibility, and employer photo may be displayed. For registered users who are not subscribers, job title, location, overall compatibility, values compatibility, skills compatibility, personality compatibility, and de-branded company photo may be displayed.

Default rankings for search results generally will be ranked with best match first. Algorithms may take personality, values, skills, and search fit into account. If no compatibility data is available a default ranking may be a search fit based on a candidates search parameters. Candidates may sort job search results using search fits, skills fits, values fits, personality fits, distance fits, and best match fits.

Each job result may allow a candidate (who has the required status) to save the job, apply to the job, view a detailed compatibility report, close a job such that it will never be displayed again to the candidate, or flag a job such that an alert will be sent to an administrator. If a job is risky or non-existent as determined by an administrator the job may be disabled and not displayed to other candidates.

Saved searches may automatically be saved in case a user accidentally or purposefully exits a search window.

Compatibility profiles which the system may generate may include detailed reports regarding the job and the employer. Compatibility reports may include information about how compatible the candidate is with the employer's culture, how well the candidate's skills fit the requirements of the job, how compatible the candidate is with the manager from the employer, what type of person succeeds at the employer's place of business, and what type of person the candidate is. From a compatibility profile screen a candidate may save the job, apply for the job-such as by clicking through to an outside site, and/or return to search results.

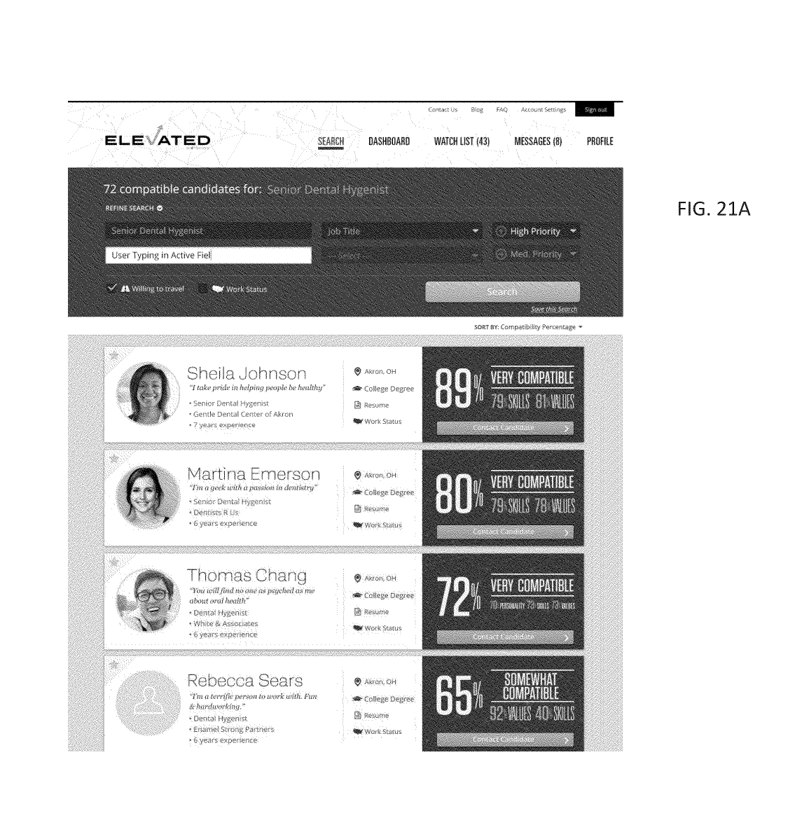

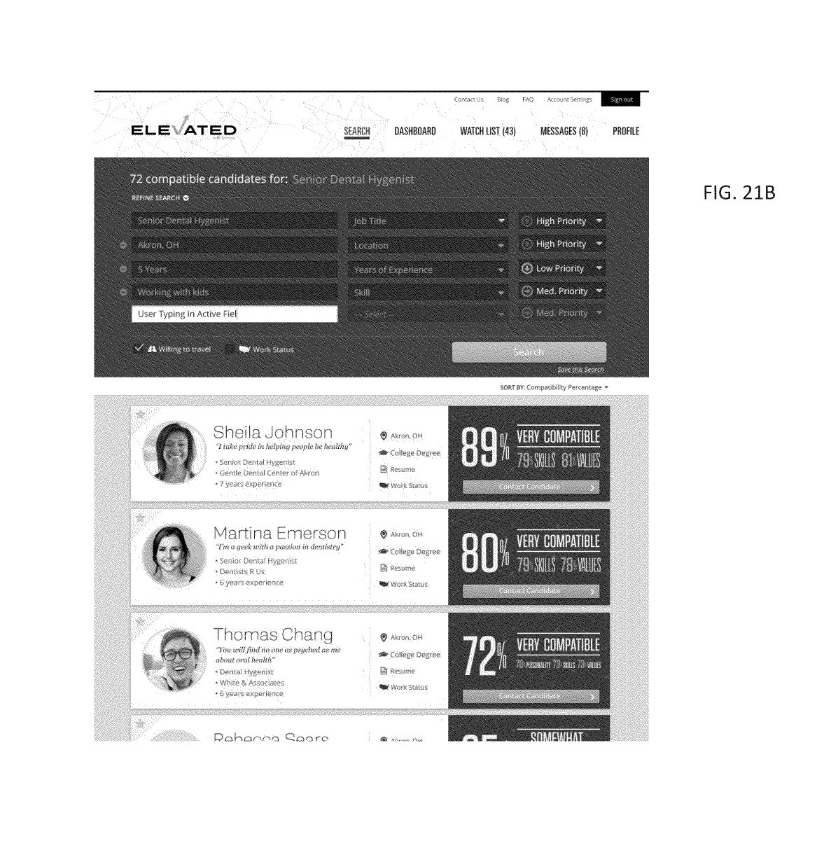

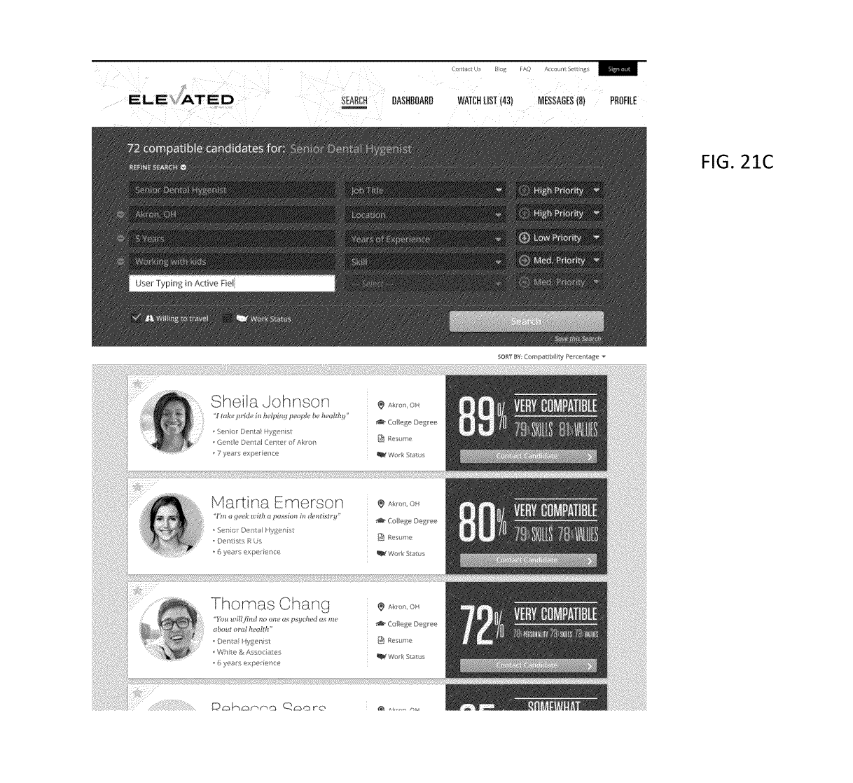

FIG. 21A shows an example embodiment of a search result screen as may be presented to an employer including a search field and candidate profiles ranked from highest to lowest total compatibility rating.

FIG. 21B shows an example embodiment of a search result screen as may be presented to an employer including a search field (expanded from FIG. 21A to include more search fields) and candidate profiles ranked from highest to lowest total compatibility rating.

FIG. 22 shows an example embodiment of a custom or basic experience flow for a candidate 22000 in accordance with the present invention. In the example embodiment a candidate may enter a job search 22002 into the system. The system may determine if a resume is available in step 22004. In cases where a resume is available the system may submit the resume to Lens and collect or compile a jobs list with skills fit scores in step 22006. The system may then determine whether a values profile is available in step 22008. If a values profile is available the system may submit the jobs list to a culture fit scorer in step 22010. If a values profile is not available in step 22008, the system may prompt a candidate to complete a values and satisfaction questionnaire in step 22034. If a candidate completes a values and satisfaction questionnaire in step 22034 the system may proceed to step 22010. If a candidate does not complete a values and satisfaction questionnaire in step 22034 or the system has submitted the jobs list to a culture fit scorer in step 22010, the system may determine whether a personality profile is available by proceeding to step 22012. If a personality profile is available in step 22012 the system may submit the jobs list to a personality fit scorer in step 22014. If a personality profile is not available in step 22012 then the system may prompt user to complete a personality questionnaire in step 22036. If a candidate completes a personality questionnaire in step 22036 the system may proceed to step 22014. If a candidate does not complete a personality questionnaire in step 22036 or the system has submitted the jobs list to a personality fit scorer in step 22014, the system may submit the jobs list to a total fit scorer in step 22016. After the jobs list has been submitted to a total fit scorer in step 22016 the system may display search results ordered by best total fit to least total fit for the candidate to review in step 22018.

In cases where no candidate resume is immediately available in step 22004, the system may prompt a candidate to submit a resume in step 22020. If a candidate elects to submit a resume in step 22020, the resume is uploaded in step 22032 and the system may then proceed as described above starting at step 22006.

If a candidate elects not to submit a resume in step 22020, the system may check to determine whether a current title, industry and/or Zip code are available in step 22024. In cases where a current title, industry, and/or Zip code are available in step 22024, the system may conduct a search and collect or compile a list of job opportunities within a user-defined or system defined radius (in miles, kilometers or other units) of the specified Zip code in step 22030. In the example embodiment this may be within a fifty mile radius. The system may then proceed to step 22008 as described above.

In cases where no current title, industry and/or Zip code are available the system may prompt the user to enter a current title, industry and Zip Code in step 22026. In cases where a current title, industry and/or Zip Code are entered by a candidate in step 22026, the system may proceed as described above from step 20030. In cases where a candidate elects not to enter a current title, industry and/or Zip Code the system may display an empty results page with a search editor to the candidate in step 22028 since the system does not have adequate information to display a useful result set.

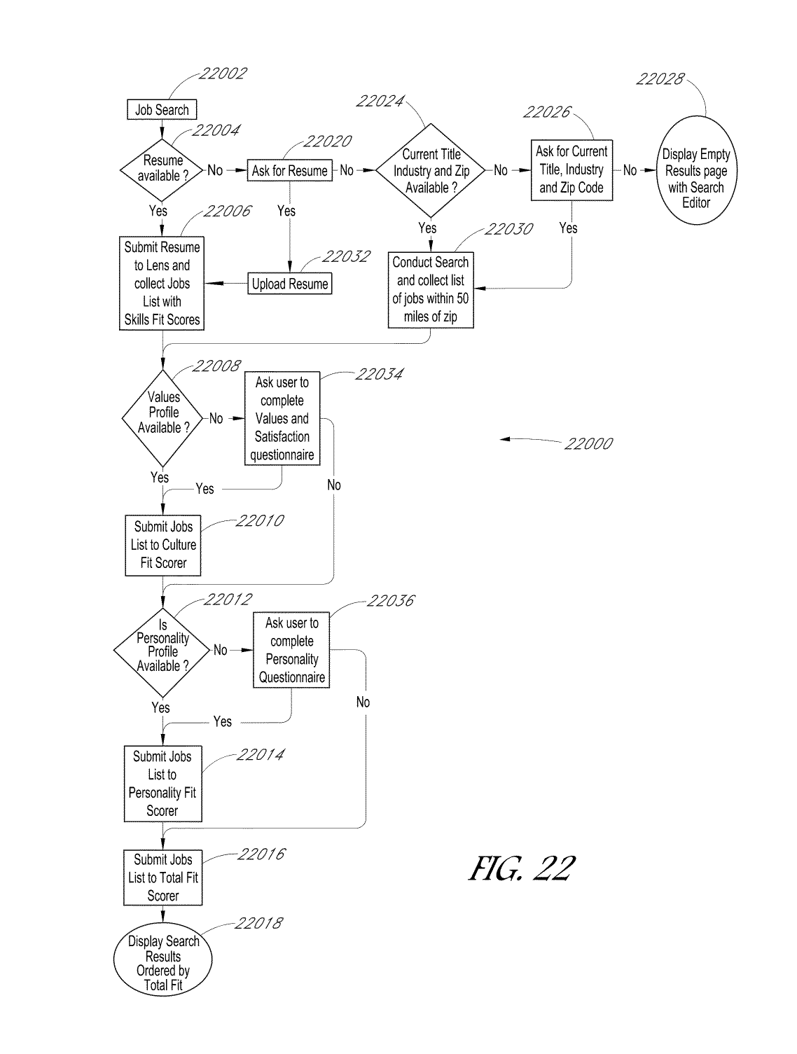

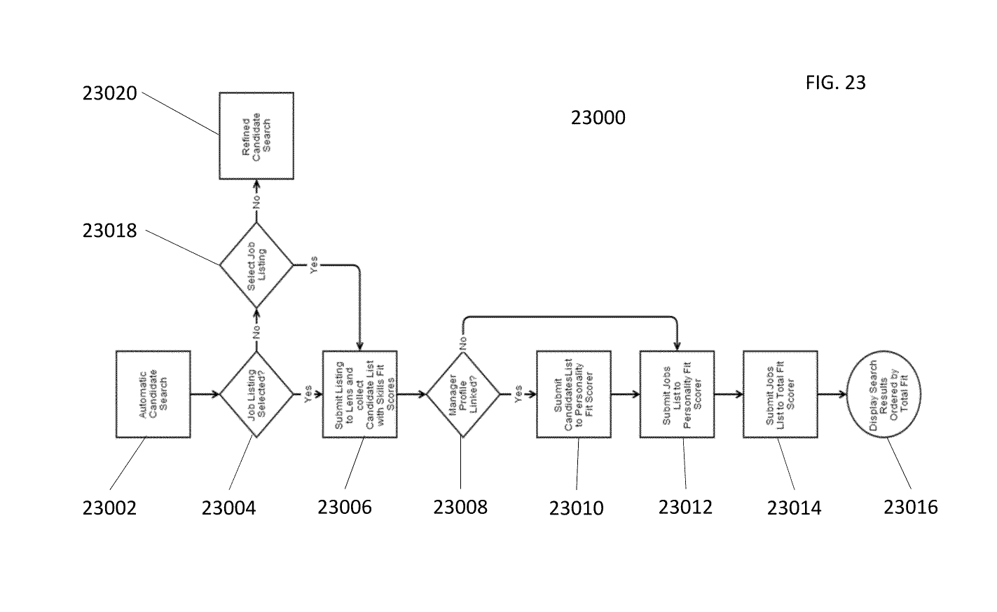

FIG. 23 shows an example embodiment of a recruiter flow for an automatic candidate search 23000 in accordance with the present invention. In the example embodiment the system may receive an automatic candidate search in step 23002. The system may then determine whether a job listing has been selected in step 23004. If a job listing has been selected in step 23004, the system may submit the listing to Lens and collect a candidate list with skills fit scores associated with each candidate in step 23006. The system may then determine whether a manager profile has been linked in step 23008. If a manager profile has been linked then the system may submit the candidates list to a personality fit scorer in step 23010. After the candidates list has been submitted to the personality fit scorer in step 23010 or if no manager profile was found linked in step 23008, the system may then submit the jobs list to a personality fit scorer in step 23012. The system may then submit the jobs list to a total fit scorer in step 23014. After the jobs list has been submitted to a total fit scorer in step 23014 the system may display search results ordered by best total fit to least total fit for the recruiter to review in step 23016.

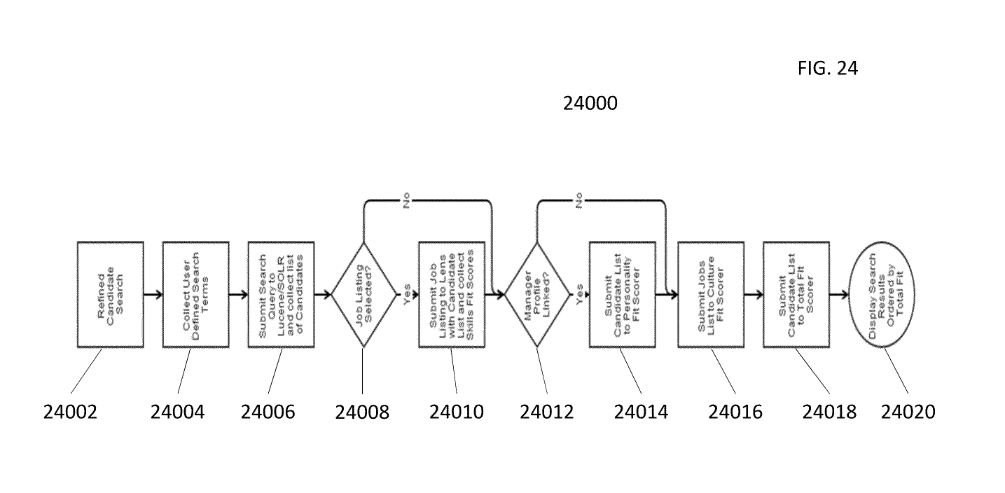

If the system determined that no job listing was selected in step 23004, the system may prompt a recruiter to select a job listing in step 23018. If the recruiter elects to select a job listing in step 23018 then the system may move to step 23006 and proceed as described above. If the recruiter does not elect to select a job listing in step 23018 then the system may move to a refined candidate search in step 23020 (further described below with respect to FIG. 24).

FIG. 24 shows a recruiter flow for a refined candidate search 24000 in accordance with the present invention. In the example embodiment the system may begin a refined candidate search in step 24002. The system may collect recruiter defined search terms in step 24004 such as any word or phrase the recruiter may wish to perform a search on. Next the system may submit a search query to Lucene/SOLR and collect list of candidates in step 24006. The system may then determine whether a job listing has been selected in step 24008. If the system determines a job listing has been selected in 24008, the system may submit the selected job listing to Lens with a candidate list and collect or compile skills fit scores in step 24010. After the system has collected or compiled skills fit scores in step 24010 or determined that no job listing was selected in step 24008, the system may determine whether a manager profile has been linked in step 24012. If a manager profile has been linked the system may submit a candidate list to a personality fit scorer in step 24014. After a candidate list has been submitted to a personality fit scorer in step 24014 or if a manager profile was determined not to be linked in step 24012, the system may submit the jobs list to a culture fit scorer in step 24016. The system may then submit the candidate list to a total fit scorer in step 24018. After the candidate list has been submitted to a total fit scorer in step 24018 the system may display search results ordered by best total fit to least total fit for the recruiter to review in step 24020.

FIG. 25 shows an example embodiment of an email registration flow for a candidate 25000 in accordance with the present invention. Registration may be required when a job seeker seeks to search for jobs or view a current company compatibility report without validation. In the example embodiment the system may recognize a candidate registration in step 25002. This may include using a web form or third party API. In embodiments where a web form is used a candidate may need to fill out required fields such as first name, last name, email address, valid password, and password confirmation. In embodiments where third party APIs are used, candidates may need to grant the system access to all required permissions. The system may then automatically generate a system email with an included validation link and send it to a candidate provided email address. The candidate may then select or follow the link provided in step 25010 in order to validate the associated candidate profile. If a candidate does not successfully validate an account then the candidate may be prompted to resend a validation email to the current email address or a new email address. Upon a user registration in step 25002, the system may prompt a user to upload a resume in step 25004. The system may then prompt the user to complete numerous other steps 25006 which may include filling out surveys, completing questionnaires, etc. in step 25006. The system may then prompt a user to complete a job selection questionnaire in step 25008. At any point between and including step 25004 and 25008 the system may allow a user to skip directly to a search function and validation step 25010. A candidate may also arrive at step 25010 from a system email or by completing all steps 25004 through 25008.

In some embodiments candidates who previously registered with an associated relationship compatibility system may be considered “pre-registered” when entered into the system and “registered” upon first login to the system.

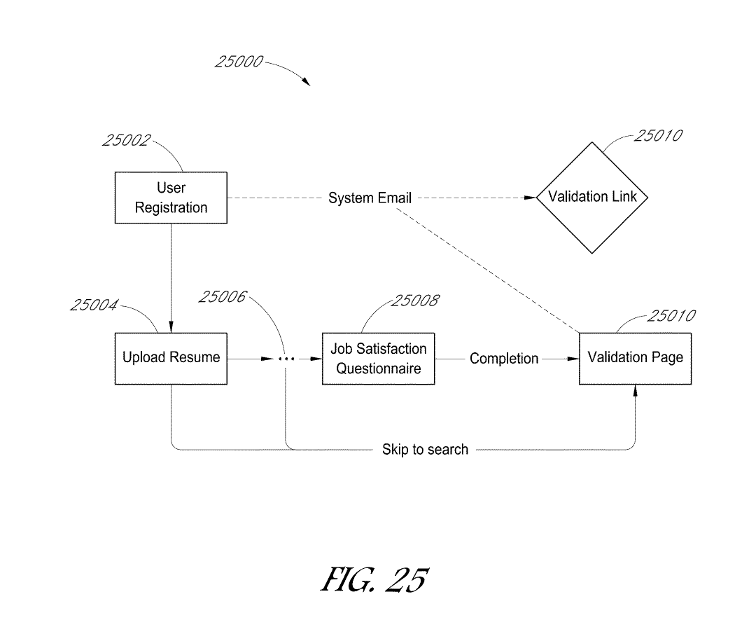

FIG. 26 shows an example embodiment of a profile builder flow for a candidate 26000 in accordance with the present invention. In the example embodiment a system may prompt a user to upload a resume or build a resume using fields, buttons, lists, typing, and other methods of data entry and resume building in step 26002. Next the system may prompt a user to respond to a general demographics questionnaire in step 26004. Next the system may prompt a user to respond to a values and culture questionnaire in step 26006. Next the system may prompt a user to respond to a personality questionnaire in step 26008. Next the system may prompt a user to respond to a company culture questionnaire in step 26010. In any of steps 26002 to 26010 a candidate may skip to a search step 26020. Also, it should be understood that many questionnaires could be completed in varying orders, some may be skipped and returned to at later points, and some may be omitted completely while moving on to others in various embodiments of the invention. Additionally, some questionnaires may incorporate results or single or multiple answers from previously completed questionnaires in generating new results as appropriate in order to save candidates' time and energy from having to repeatedly answer similar or identical questions.

After completing step 20010 the system may prompt the candidate to complete a company satisfaction questionnaire at step 26012. Upon completion the system may determine whether the candidate has completed the values and cultures, company culture, and satisfaction questionnaires in step 26014. If the candidate has not completed these questionnaires then the system may go to search step 26020 in the example embodiment. In alternative embodiments the system may provide the candidate with the opportunity to return and complete the incomplete questionnaires. If the candidate has completed the questionnaires as determined in step 26014 then the candidate may be prompted to determine if the candidate wishes to view a current employer compatibility report in step 26016. If the candidate does not wish to view this report the system may go to search step 26020. If the candidate does wish to view this report the system may generate the current employer compatibility report and display it for the candidate in step 26018. Then the system may proceed to search step 26020.

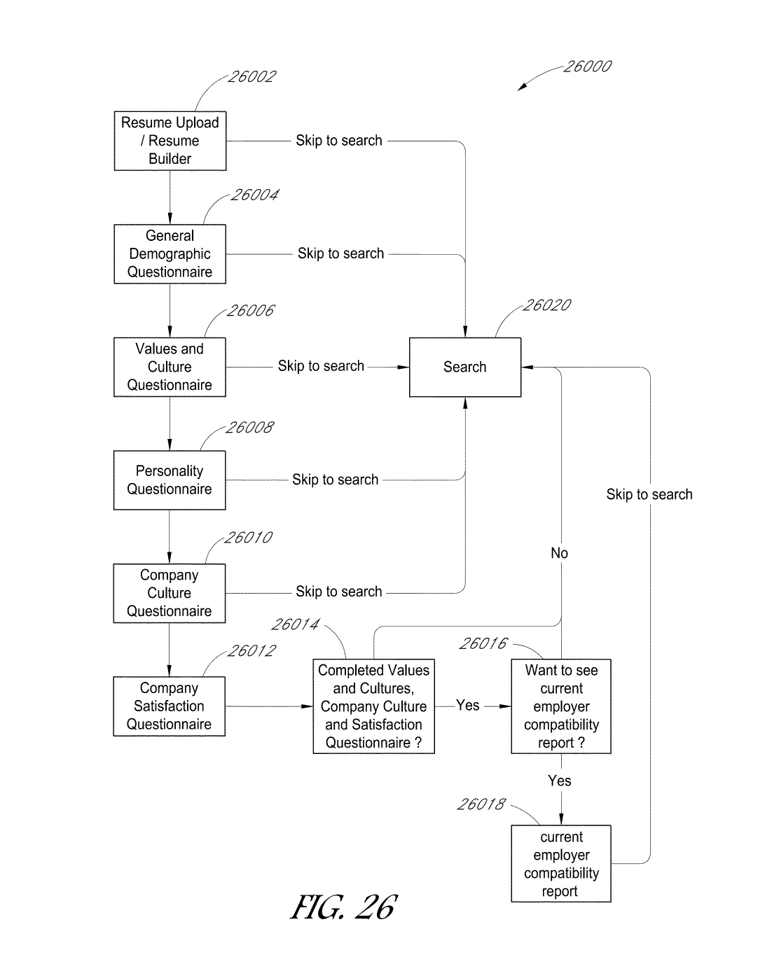

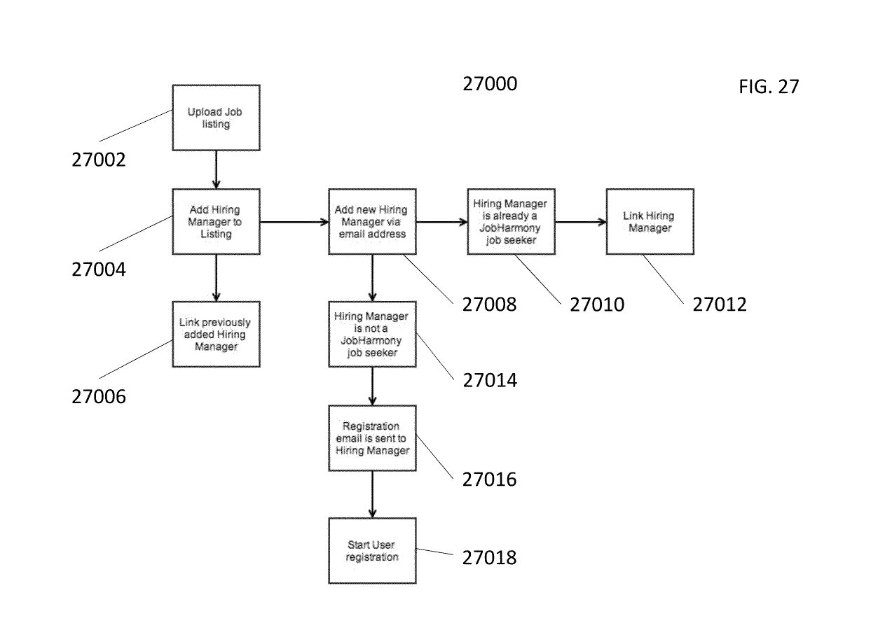

FIG. 27 shows an example embodiment of a hiring manager/recruiter adding process 27000 for an employer in accordance with the present invention. In the example embodiment, an employer may upload a job listing in step 27002. The system may then determine whether to add an associated hiring manager to the listing in step 27004. The added hiring manager may be the individual who uploaded the job listing in step 27002 or it may be a different individual or group of individuals associated with the employer. In embodiments where a hiring manager has been previously associated with the employer in the system, the system may perform a step 27006 to link the previously added hiring manager.

In embodiments where the hiring manager has not been previously added to the system, the system may move to step 27008 and add a new hiring manager via email address. In adding the new hiring manager via email address the system may determine that the hiring manager has not previously been a system job seeker in step 27014. In this case the system may send a registration email to the hiring manager in step 27016. This email sending leads to the system starting a user registration in step 27018.

In some embodiments the system may determine the hiring manager is already a system job seeker in step 27010. In these embodiments the system will link the hiring manager in step 27012.

Once the employer uploads a job listing, they will have the option to add the hiring manager/recruiter. This may occur in a dialog box. The employer will have the option to select a hiring manager from a list of previously added hiring managers (if available) or add a new hiring manager. When adding a new hiring manager, the hiring company will need to provide the hiring manager's email to see whether they already have a candidate account saved in the system. If the hiring manager is already a candidate, the employer may link the hiring manager's email to the job listing. If the hiring manager does not have a candidate account, a registration email will be sent out to the hiring manager's email.

The hiring manager will have to go through the candidate registration process. The hiring manager's details may already be pre-populated (Name, and email) and the hiring manager may have a status of a pre-registered job seeker. The hiring manager may have to select a valid password in order to register or choose to register through a third party API. If the hiring manager registers through web-form email no validation may be required. Once registered, the hiring manager may go through the same flow as a candidate.

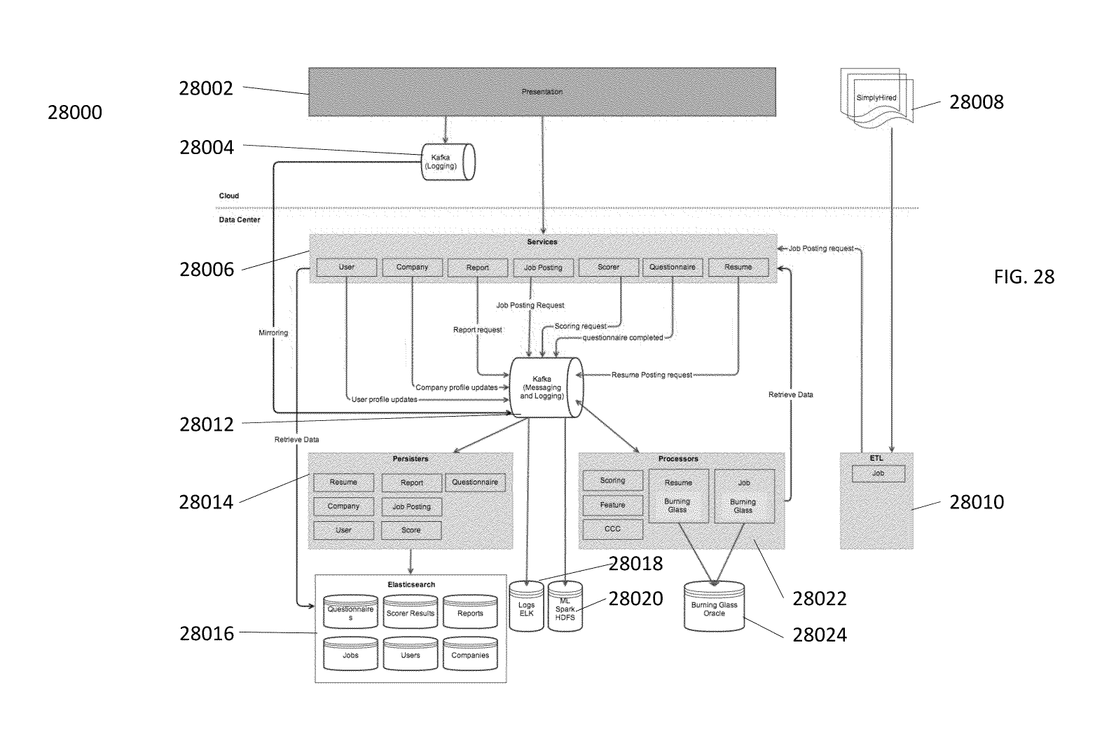

FIG. 28 is a diagram showing an architecture of a search system according to an embodiment of the present invention. In the example embodiment presentation 28002 provides an input to logging database 28004 and services 28006. Presentation 28002, logging database 28004 and third party information 28008 may be located in a cloud computing environment while other elements described below may be located in a data center.

Services 28006 may include user services such as user profile updates, company services such as company profile updates, report services such as report requests, job postings services such as job posting requests, scorer services such as scoring requests, questionnaire services such as completed questionnaires, resume services such as resume posting requests, and others as appropriate. Each of these services may send outputs to a messaging and logging database 28012 which may also receive input via mirroring of database 28004. Third party information 28008 may send information to ETL 28010 including job information which may send job posting requests to services 28006.

Messaging and logging database 28012 may send information to persisters 28014 such as resume, company, user, report, job posting, score, questionnaire and other information as well as exchanging information with processors 28022 including scoring, feature, Current Company Compatibility report, resume, job, and other information. Messaging and logging database 28012 may also send information to logs ELK database 28018 and ML Spark HDFS database 28020. Processors 28022 may provide information to database 28024. Processors 28022 may also retrieve information from services 28006 when required. Persisters 28014 may send data to Elasticsearch databases including questionnaires, scorer results, reports, jobs, users, companies and other databases and services 28006 may retrieve information from one or more of these databases. Various protocols, both known and developed in the future, may be used in information exchange between the various elements in the architecture.

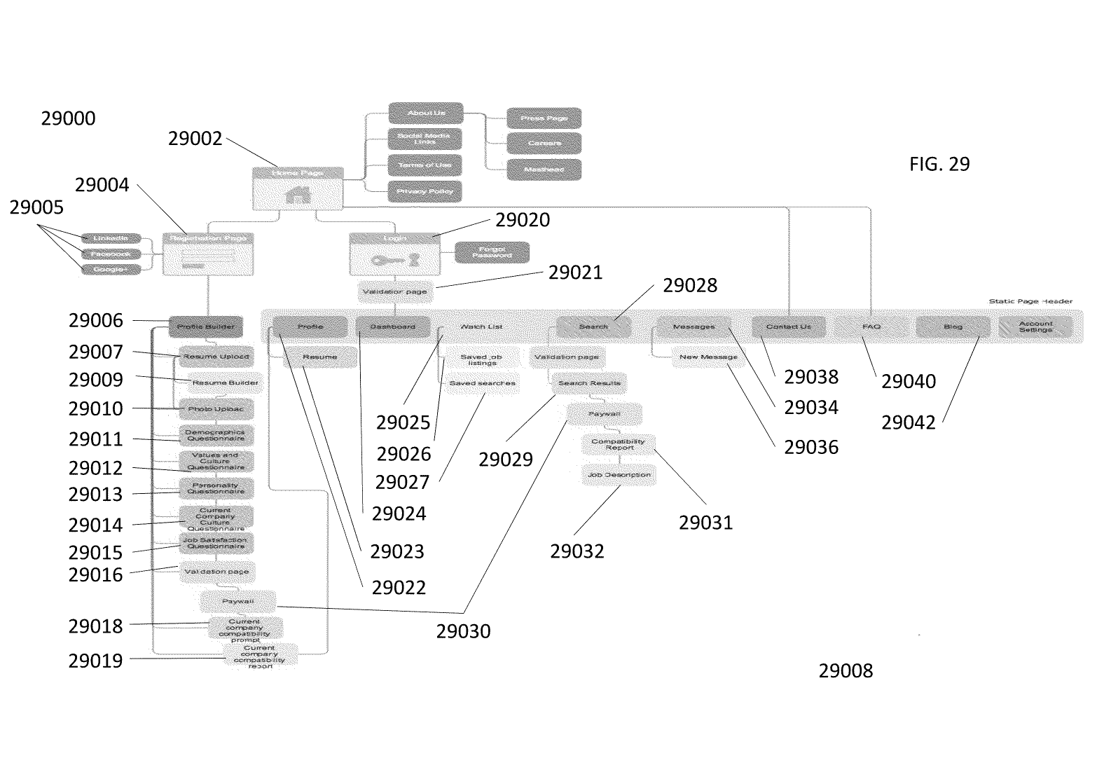

FIG. 29 is a diagram showing a site map for a candidate 29000 according to an embodiment of the present invention. In the example embodiment the system first shows a candidate a homepage 29002. From the homepage 29002 the candidate may register 29004 using a registration process or sign in as a returning candidate 29020, for instance using a username and password. In embodiments where the candidate registers in step 29004, the system may present the candidate with the option to use a third party system 29005 or to use an email validation with username and password. From the registration page 29004, a candidate may use a profile builder 29006 to develop a personalized candidate profile. The system may prompt the candidate for a resume upload 29007 and then use the resume upload 29007 to add additional details using a resume builder 29009. Candidates may also upload photos to a resume in 29010. Next a candidate may be presented with a series of questionnaires starting with a demographics questionnaire 29011.

In embodiments where the candidate completes part or all of a general demographics questionnaire in step 29011, the system may then present the candidate with a values and culture questionnaire in step 29012. In embodiments where the candidate completes part or all of a values and culture questionnaire in step 29012, the system may then present the candidate with a personality questionnaire in step 29013. In embodiments where the candidate completes part or all of a personality questionnaire in step 29013, the system may then present the candidate with a current company culture questionnaire in step 29014. In embodiments where the candidate completes part or all of a current company cultures questionnaire in step 29014, the system may then present the candidate with a job satisfaction questionnaire in step 29015. In many embodiments candidates may elect to skip one or more of the above steps starting at 29006 and return at a later point. In the example embodiment candidates may be presented with a validation page 29016 after completing (or skipping) the above steps, presenting candidates with the opportunity to review their answers and validate them. In some embodiments one or more of the above steps may be swapped, omitted, or changed as appropriate. Next a candidate may be presented with a paywall 29030 requiring the candidate to purchase a subscription service in order to gain access to additional system functionality. It should be noted that paywall 29030 may be located in different positions, may be omitted, may be duplicated, and may be changed as required by system administrators.

If candidates elect to become subscription service users at paywall 29030 they may be presented with a current company compatibility prompt in step 29018. Similarly, paywall 29030s may be presented in various embodiments at various locations in the system as required by system administrators based on business requirements.

In embodiments where candidates are returning users they may elect to travel to a login page 29020 from home page 29002 and in some instances reset or retrieve forgotten or lost password information. A validation page 29021 may ensure the candidate is signed in under the correct profile. Profile view 29022 and resume view 29023 may each allow candidates to review what information they have entered into the system.

The system may present the candidate with a dashboard 29024. Dashboard 29024s may contain match notifications, messages, questionnaire/quiz links, blogs and other engaging content, and other information. Match notifications may display compatible listings from a predetermined overnight search and clicking on a notification may take users to a compatibility report for an indicated job or a pay-wall depending on user status. Match notifications may include the date of the match, a job title, an overall compatibility score, a location, a “new” tag if a candidate has not yet viewed the job and/or other information. In some embodiments, if fewer than all received and not deleted job listings can be displayed on the dashboard above a fold, then a “View All Matches” link will be displayed. Following this link may take candidates to a Search Results page displaying Matches in order of date created. Candidates may see a “To Do” list of messages (sometimes called calls to action) which may include various tasks or instructions and links to locations such as replying to communication from an employer, completing a profile and many others.

In embodiments where the candidate has previously completed and submitted questionnaires, the system may present a candidate's previously selected job postings in a watch list 29025 on a dashboard 29024 or other page which the candidate may be interested in reviewing. Watch list 29025 may include information on saved job listing 29026s and saved searches 29027. The system will present the candidate with the chance to search 29028 and may include another validation page in order to ensure the candidate is viewing jobs associated with their correct profile. Candidates may view search results in step 29029 and may reach a paywall 29030 depending on if the candidate has become a subscription service member or not. After passing paywall 29030, candidates may view a compatibility report 29031 and a job description 29032 for a selected job.

In many embodiments candidates may create a watch list where the candidate may look through saved jobs and searches. For saved jobs the candidate may be able to View high level overview of the job, apply to the job directly from watch list, view a compatibility report-depending on candidate status and/or remove the job. For saved searches, the candidate may be able to view search results, rename the search and/or remove the search.

Search 29028 may be an unpopulated search builder. An unpopulated search builder may allow a candidate to build a search with no fields prepopulated while a populated search builder may populate search fields with information provided previously by the candidate. Examples of populated search information may include location, job type, industry, experience, desired salary, and others.

Messages 29034 may allow candidates to view all messages they have previously sent and received with employers while new message 29036 may allow users to review only new messages which have not been previously viewed. Contact us 29038 may provide information for candidates to contact system administrators such as physical addresses, email addresses, phone numbers, messenger service screen names, and others. FAQ 29040 may allow candidates to view frequently asked questions by other candidates. Blog 29042 may allow candidates to review blog postings by system administrators or others which may be helpful to candidates.

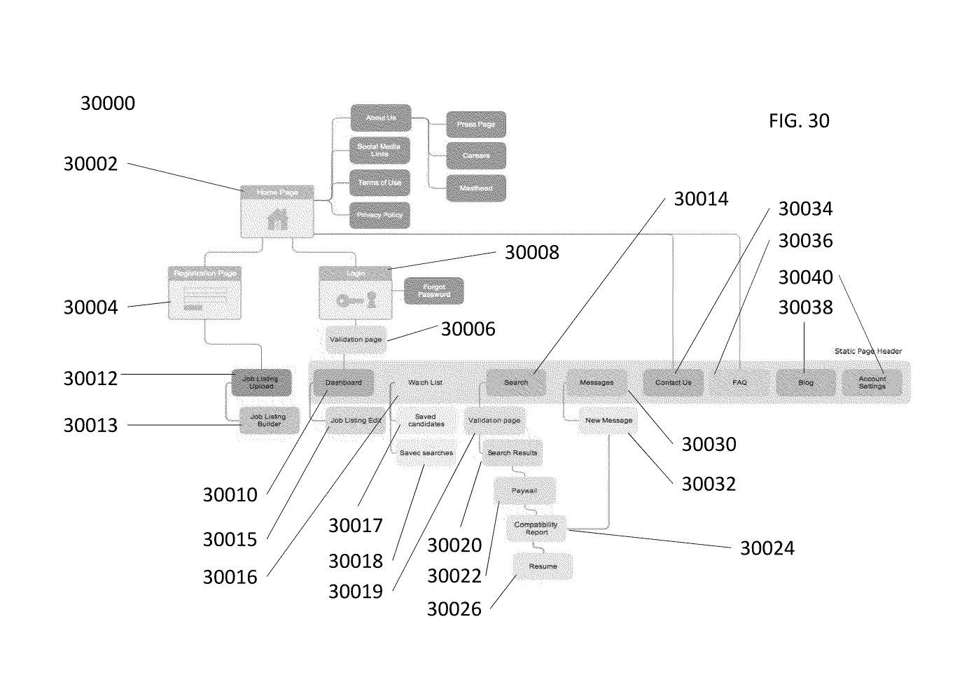

FIG. 30 shows an example embodiment of a site map for an employer 30000 in accordance with the present invention. In the example embodiment the system first shows an employer a homepage 30002. From the homepage 30002 the employer may register 30004 using a registration process or sign in as a returning employer 30008, for instance using a username and password and including a full name and company name. The system may remind employers of forgotten passwords and reset passwords in some embodiments as well. The employer may then be sent a validation link to the provided email. The employer may be shown a validation page 30006 after logging in and in some embodiments must validate in order to make job listings searchable. In embodiments where the employer registers in step 30004, the system may present the employer with a job listing upload in step 30012. Alternatively or additionally, employers may be able to build a job listing using job listing builder 30013 provided by the system.

In embodiments where the employer is a returning employer 30008, the system may show the employer a dashboard 30010. From dashboard 30010, employers may be able to edit job listings 30015. Where employers upload job listings 30012, the system may present automatic search results 30014 of candidates who may meet qualifications for the position. The system may then present refined search results 30016 and/or a compatibility report in 30018.

Search 30014 allows employers to search for candidates and validation page 30019 may require users to validate their identities again. Search results 30020 may include a list of candidates for a particular job listing and employers may be presented with a paywall 30022 requiring them to become subscription service members before gaining access to additional functionality. Additional functionality may include viewing a compatibility report 30024 and a candidate resume 30026. From a compatibility report an employer may be able to send a new message 30032 to a candidate. Employers may also be able to view previously received messages 30030 and new (unread) messages from candidates 30032.

Contact us 30034 may provide information for employers to contact system administrators such as physical addresses, email addresses, phone numbers, messenger service screen names, and others. FAQ 30036 may allow employers to view frequently asked questions by other employers. Blog 30038 may allow employers to review blog postings by system administrators or others which may be helpful to employers. Account settings 30040 may allow employers to edit account settings.

In some embodiments, upon registration, employers may be required to fill out a company profile and/or information form. The company profile form may contain full name, company name, email, phone number, location, “how did you hear about us?” (with an associated drop down menu), Once the employer submits the form with all required fields provided they may be prompted with a message that a system sales executive will contact them. Once the message is viewed the employer may be navigated back to the home page. A system sales executive may then contact the employer and subscribe them over the phone. The employer will be given a user name and password that they can use to login to the system. The first time the employer logs in to the site after subscription, the hiring manager or recruiter may be prompted to change the password before continuing to the next section.

Employers may upload photographs, logos from files and may view, upload, close the interface, submit the photograph, and/or adjust the photograph. Once uploaded, the photograph/logo may be displayed on the employer's dashboard where it may be editable.

Employers may be able to skip directly to a candidate search with an appropriate permission based on status but generally employers will upload one or more jobs to the system before performing any searching. Employers may be able to upload job listings using third party sites and applications, file uploads, and a system job builder. A system job builder may include fields for job title, job keywords, job description, location, full time/part time, contract-temporary, permanent, residents/visa/citizenship, years of experience, travel required, and others.

Employer searching may have a default setting with one row and two components: first is enter search term (“Enter your search term”) and second select associated search parameter category (“-Select-”). If an employer selects a “down arrow” to the right of the parameter category window before entering a search term, a drop down menu may be displayed below the search term box. It may display the employers saved searches (if available).

While the hiring company starts typing in a search term, the best category should automatically be selected, with the default being keyword/phrase to include. Examples of alternative categories may include: If a recruiter enters a 5 digit number a category may suggest a zip code. If a recruiter enters a 1 to 4 digit number a category may suggest: a range in miles. If a recruiter enters a known city name a category may suggest a city.

Once an employer has entered a search term, if the automatic category is incorrect, the employer may select the correct category from a drop down menu (any parameter can be selected multiple times) from options including job title, location, key word/phrase to include, key word/phrase to exclude, skill, range, zip code, education level (Phd, masters, bachelors, associates, some college, high school) or others. When an employer starts typing a search term, an importance level may appear to the right. The default importance may be medium. The employer will be able to change the importance between medium, high, low, must have, or others.

In an example embodiment an employer may provide up to 25 search parameters. Once the employer starts typing a search term a new row will appear under the current row (up to 25 rows). The new row will be greyed out unless the employer types a search parameter in that row. The employer may also remove rows (one row must remain) and clear the entire search query (query should return to the default mode). If the employer is entering a custom search, at LEAST one parameter is necessary before a search will run. When the employer has entered all the search terms, they can then search or refine a current search based on those terms. When the search button is pressed, the query should remain and the number of compatible candidates should be displayed. The employer can decide to save the search at any point using a unique name.

A selector may be present to indicate if the job listing the employer is searching on accepts non-us citizens and/or requires travel. These Boolean search criteria should be displayed on the bottom of the search builder. Once the employer searches on a job, the job listing's title should be displayed at the top of the search builder. The employer will be able to select other uploaded job listings by clicking on the “down arrow” to the right of the job listing title and select a different job listing from the dropdown menu.

Search results may appear in three forms depending on the type of search performed: automated, refined, and custom. For Automated results, if the employer provided a job listing(s), the employer will receive automated search results that are based on skill compatibility (if available), culture compatibility (if available), and personality compatibility (if available). For refined search results, if the employer refines an automated search, the results will be generated using a query built from the job listing's zip code, title, and newly entered search terms and then scored for compatibility. For custom search results, if the employer launches a custom search, the results will be generated using a query solely from the terms and weights provided. No compatibility scoring may be performed and ranking may be by search fit.

Compatibility profiles shown to employers with a required status may include detailed reports regarding a candidate. Results may include how compatible the candidate is with the employers culture, how well the candidate's skills fit the job's required skills, how compatible the candidate is with a managers personality, what kind of person succeeds at the company and what kind of person the candidate is, among others. Employers may save a candidate, contact a candidate and/or return to search results from compatibility profiles. Search results may provide an employer with a high level overview of the candidate. Content may vary according to user status as follows: Subscriber view may display candidate name, candidate headline (if available), current job title, exact location, overall compatibility (if available), values compatibility (if available), skills compatibility (if available), personality compatibility (if available), candidate photo (if available), registered view, candidate first name, current job title, Demographic Marketing Area (DMA) location, overall compatibility (if available), values compatibility (if available), personality compatibility (if available) and others.

A default ranking for the search results if compatibility data is available is a “best match” ranking. The algorithm for best match may take personality, values, and skills compatibility into account. If no compatibility data is available, the default ranking may be search fit based given employer's search parameters. The employer may sort the candidate results based on search fit (available if search terms were provided), skills fit percentage (if available), values/culture compatibility percentage (if available), personality compatibility percentage (if available), distance, best match, and others. For each candidate result an employer may save the candidate, contact the candidate (if the use has requisite permission), view detailed compatibility report (is user has requisite permission) and others.

A current search will automatically be saved (current means last search results before the employer leaves the search results page). When the employer launches a search without updating the job listing, the last search parameters will be executed and results displayed.

The messaging system will allow hiring companies to send messages to candidates, and allow candidates to reply. The messaging system will have the following components: contact initiation link for employers, appears on a candidate listings, appears on a candidate's compatibility profile, appears on a candidate “Applied” messages, message display and editing screen for employers and candidates, a reply link for candidates and employers that appears on messages, and others. A messages page linked to the navigation header will display threaded messages which have been sent or received, allow candidates/employers to access messages, and allow candidates/employers to delete message threads. Both employers and candidates may see the number of unread messages they have in their messages page as a notifier in the navigation bar.

Employers may use the messaging system in the following way: create a new message for a candidate, read incoming responses from candidates, create/edit a reply to a candidate, delete a message, delete a message thread, and others. Candidates can use the messaging system in the following way: read incoming messages from employers, create/edit a reply to an employer, delete a message, delete a message thread, and others.

The system may provide a Nightly Match Run (NMR), which consists of an offline matching platform that will run each night. For each candidate, the NMR will generate a list of compatible jobs/companies. The top 3 compatible jobs are selected and may be sent out to the job seeker via email as well as get displayed in the candidate's dashboard. For each employer, the NMR will generate a list of compatible candidates. The top 3 compatible candidates are selected and may be sent out to the employer via email as well as be displayed in the employer's dashboard.

Subscription types for employers may vary on a pay per listing basis, pay per job detail basis, subscription basis, automatic renewal subscription, and promotional.

In some embodiments the system may allow system administrations to clos accounts, change user status and permission (such as grant free subscriptions, cancel subscriptions, allow non-subscribers to view job details, allow non-subscribers to make job listings searchable, make job-listings non-searchable, make candidates non-searchable), process refunds, extend subscriptions, flag accounts/job listings for fraud or other problems, and login as users to monitor without creating behavior/event data.

The system creates a unique identifier which is linked to a taxonomy defining a page type and includes page identifier, page type, timestamp, user identifier, behavior type (such as entry and exit), job identifier, candidate identifier, user device type, skip to page identifier, referring websites (such as during registration), and a third party API provider. For pages, data stored may include page views, visits, unique visitors, number of entries, and number of exits. Job seekers may be tracked to identify if any part of a profile build was skipped and which section was skipped. Candidate/employer message clicks and category of message.

The system may also track everything a user views on a page including and not limited to page identifiers, message/call to action identifiers, job identifiers, candidate identifiers, content identifiers, timestamps, and paywall identifiers. Additionally, candidate/employer statuses may be tracked including incomplete, registered, resume complete, profile complete, subscriber, closed, marketing email opt-in, matching email opt in, newsletter email opt in, viewable by employers, contactable by employers, subscribed employers, and others.

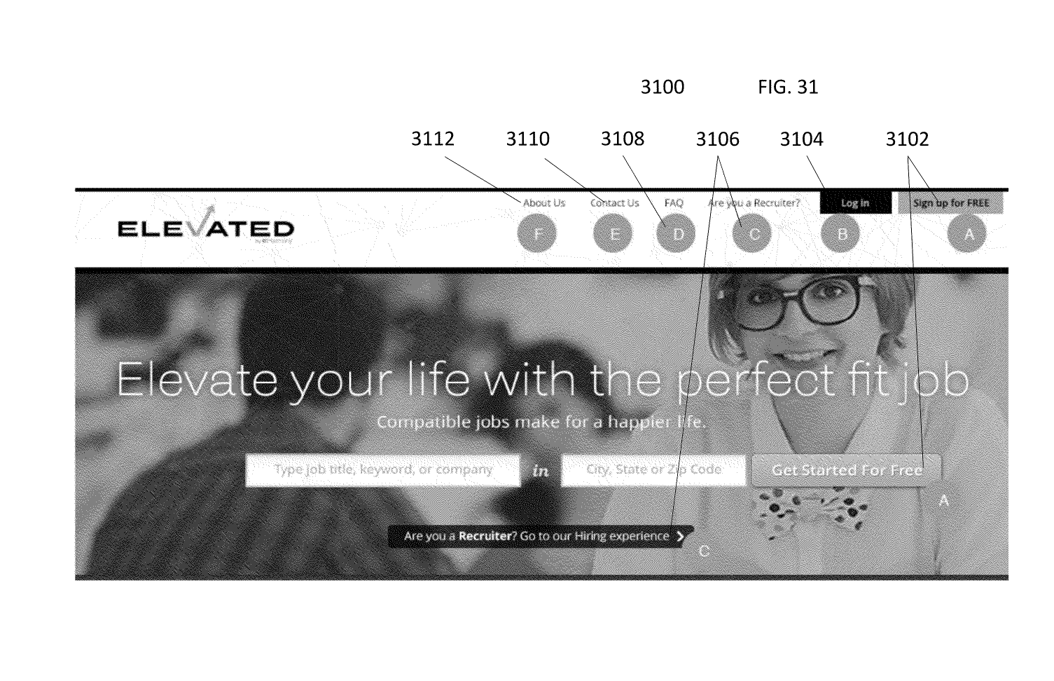

FIG. 31 is a diagram showing a candidate homepage 3100 according to an embodiment of the present invention. In the example embodiment system users may select a sign up button 3102 which may take them to a registration page. Users may select a log in button 3104 which may take the candidate to a login page. Users may select an “are you a recruiter” button 3106 which may take a user to an employer/recruiter home page. Users may select a FAQ button 3108 taking the user to a FAQ page. Users may select a contact us button 3110 taking a user to a contact information page. Users may select an about us button 3112 which may take a user to a system administrator description page.

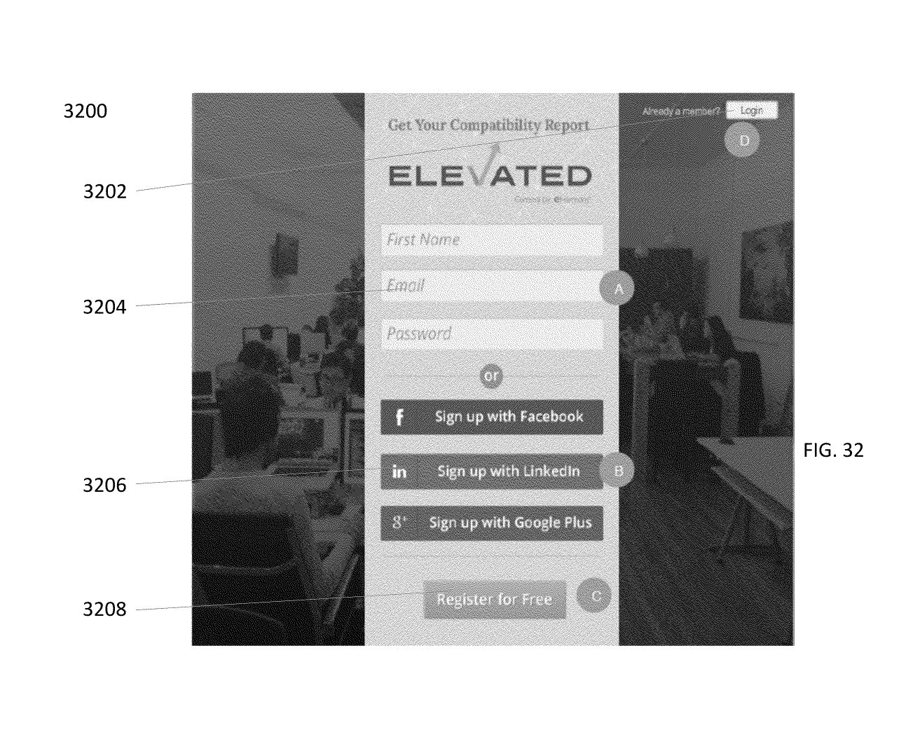

FIG. 32 is a diagram showing a candidate registration page 3200 according to an embodiment of the present invention. In the example embodiment a web form registration field 3202 allows a candidate to register via email. Also provided is are third party API registration links 3204 to sign in with profiles established in other systems such as social media. A Registration button 3206 submits a web-form registration and a login button 3208 may take a candidate to a login page.

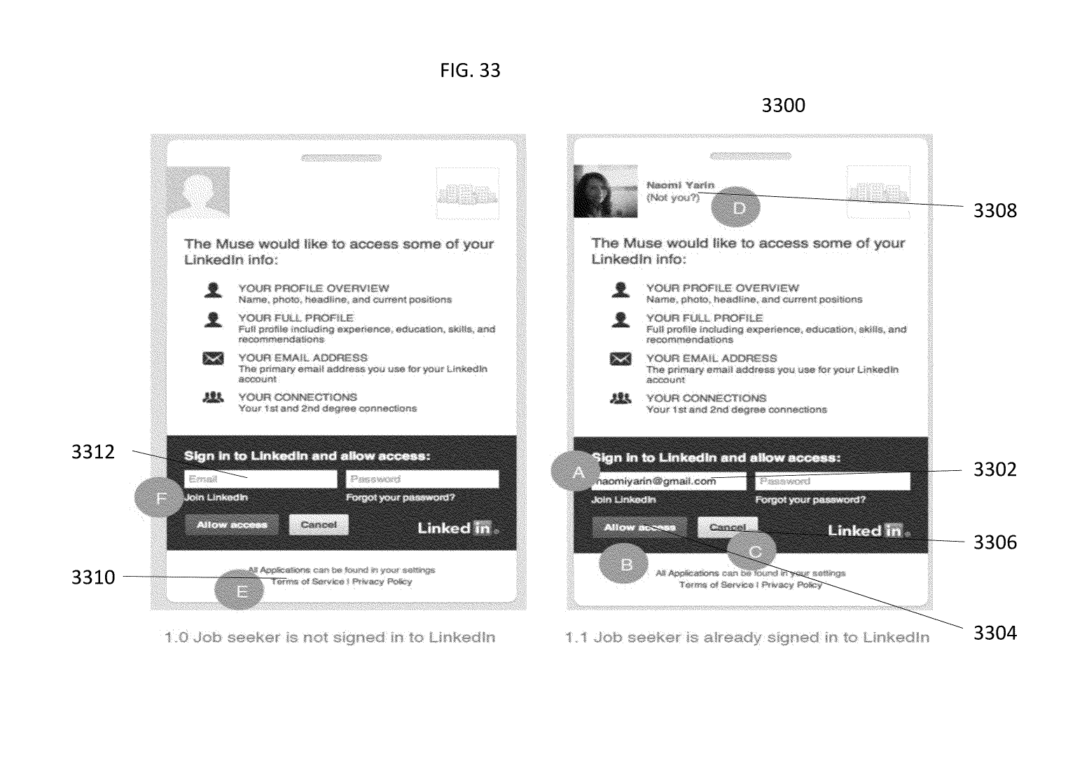

FIG. 33 is a diagram showing a candidate registration page 3300 using a third party system according to an embodiment of the present invention. In the example embodiment the system allows candidates to provide third party system credentials 3302 such as LinkedIn credentials and a user email is prepopulated when a candidate is signed in to a third party system. An allow access button 3304 registers the candidate and stores the permissions. A cancel button 3306 takes the candidate back to a registration page. A not you button 3308 takes candidates to the screen at the left of FIG. 33 where no credentials have been prepopulated. Terms of Service and Privacy Policy buttons 3310 opens the system's terms of service and privacy policy pages respectively. In some embodiments these may be opened in new windows. A join third party button 3012 takes a candidate to a third party registration page.

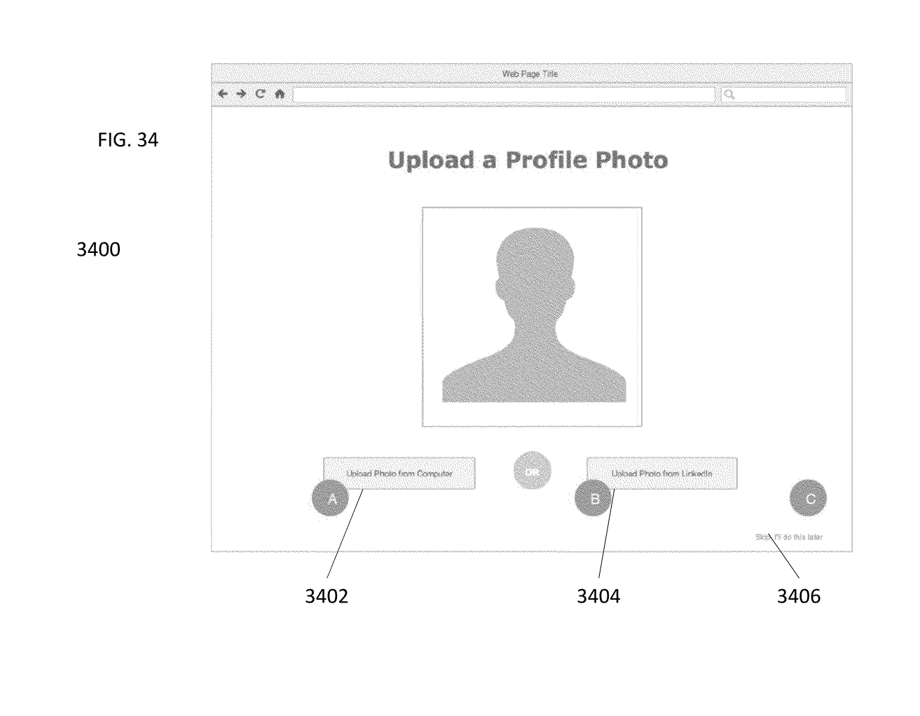

FIG. 34 is a diagram showing a candidate photograph upload page 3400 according to an embodiment of the present invention. In the example embodiment a computer upload button 3402 allows a candidate to select a photo file to upload and display on a candidate profile page. A third party website photo link 3404 allows candidates to upload a third party website profile photo. If the candidate has not registered via a third party website the same authentication process described during registration may take place. A skip button 3406 allows a candidate to skip to a next section (such as a resume upload section) without uploading a profile photo.

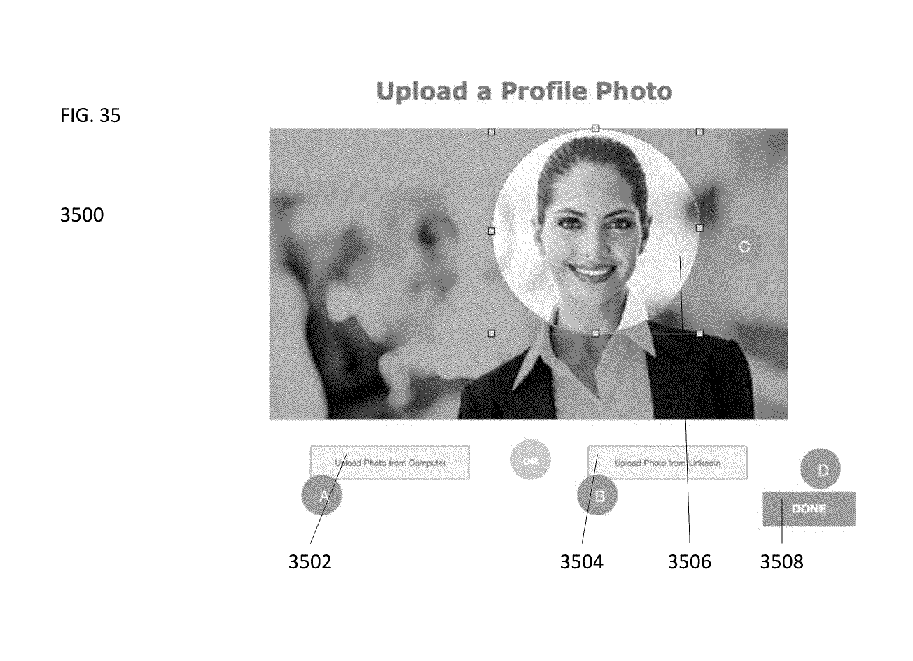

FIG. 35 is a diagram showing a candidate photograph upload and editing page 3500 according to an embodiment of the present invention. In the example embodiment a computer upload button 3502 allows a candidate to select a photo file to upload and display on a candidate profile page. A third party website photo link 3504 allows candidates to upload a third party website profile photo. If the candidate has not registered via a third party website the same authentication process described during registration may take place. A crop area 3506 may allow a candidate to move a cropping tool anywhere within image borders and expand or minimize the area within minimum and maximum limits. Whatever is shown in crop area 3506 may be displayed as the candidate's profile photograph. A done button 3508 takes candidates to a resume upload page.

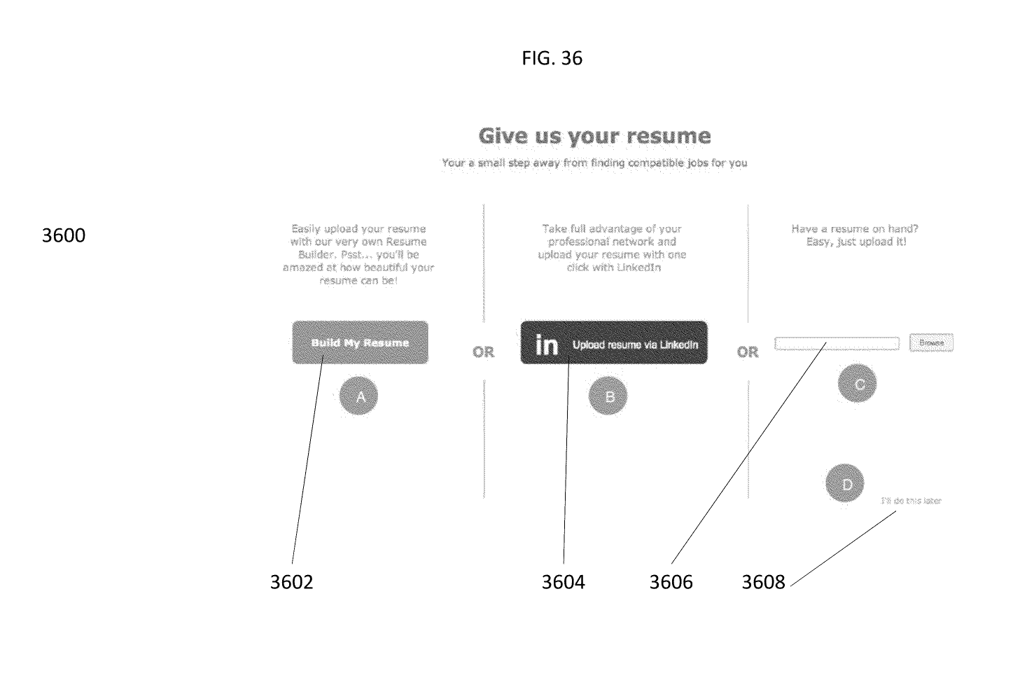

FIG. 36 is a diagram showing a candidate resume upload page 3600 according to an embodiment of the present invention. A build my resume button 3602 takes a candidate to a resume builder. A third party website resume uploader button 3604 allows a candidate to upload a resume via a third party website. If the candidate has not registered via the third party website, the same authentication process that occurred during the registration will take place. If the candidate registered via a specific third party website page 3600 may state the name of the third party website where the resume is located. Once a resume is uploaded a candidate may continue to a resume preview page. A resume upload via file button 3606 allows a candidate to select a file to upload before continuing to a resume preview page. An I′ll do this later button 3608 allows a candidate to move forward in the process, and upload a resume at a later point. In some embodiments this may mean allowing the candidate to begin a questionnaire.

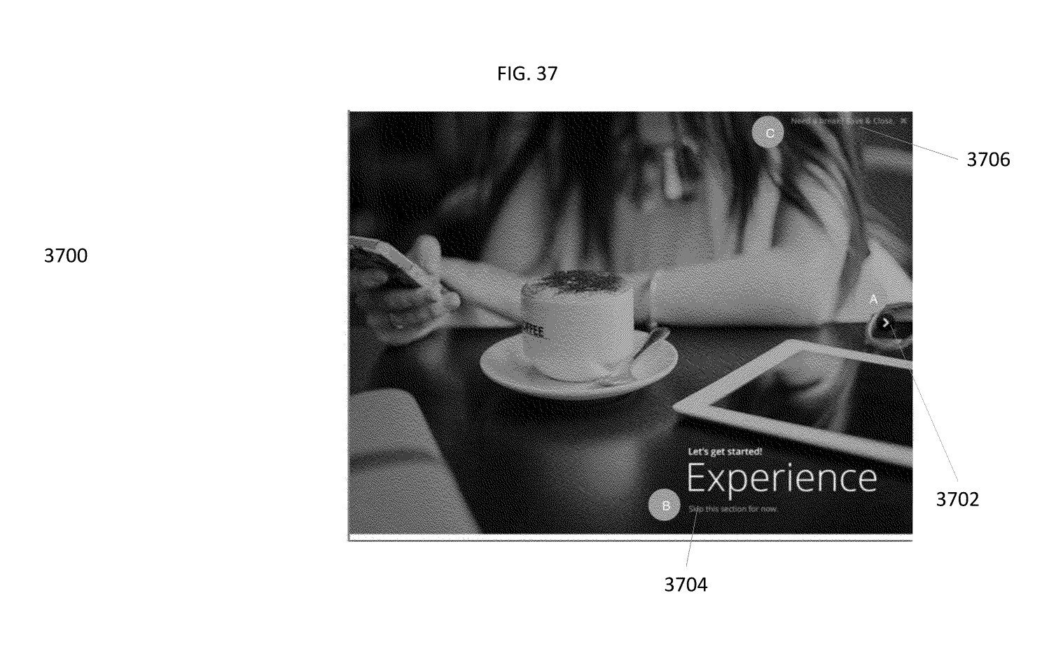

FIG. 37 is a diagram showing an initial candidate resume builder page 3700 according to an embodiment of the present invention. A next arrow 3702 takes a candidate to the next page in the resume builder. A skip button 3704 allows a candidate to skip to a next section. If the current section is the last section of the resume builder this button may take the candidate to a resume layout preview page. A save and close button 3706 takes a candidate back to a resume upload page if the candidate has not completed an experience, company projects, education or other section. If the candidate has completed all sections this button may take the candidate to a resume layout page.

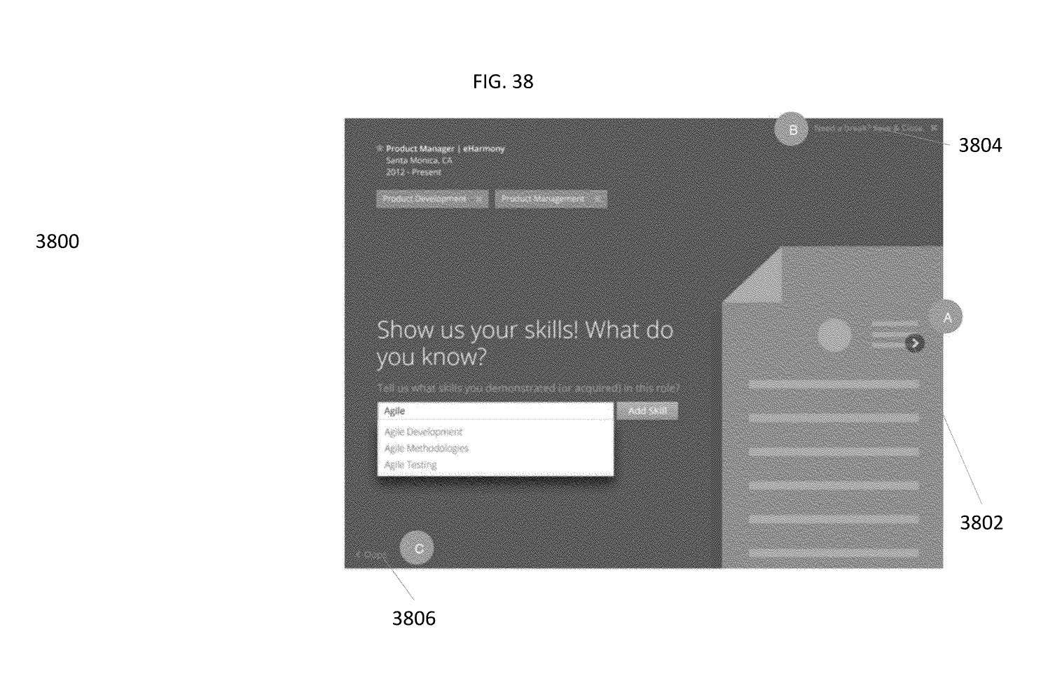

FIG. 38 is a diagram showing a secondary candidate resume builder page 3800 according to an embodiment of the present invention. A next arrow 3802 takes a candidate to the next page in the resume builder. A save and close button 3804 takes a candidate back to a resume upload page if the candidate has not completed an experience, company projects, education or other section. If the candidate has completed all sections this button may take the candidate to a resume layout page. An oops button 3806 may take a candidate to a previous page of the resume builder.

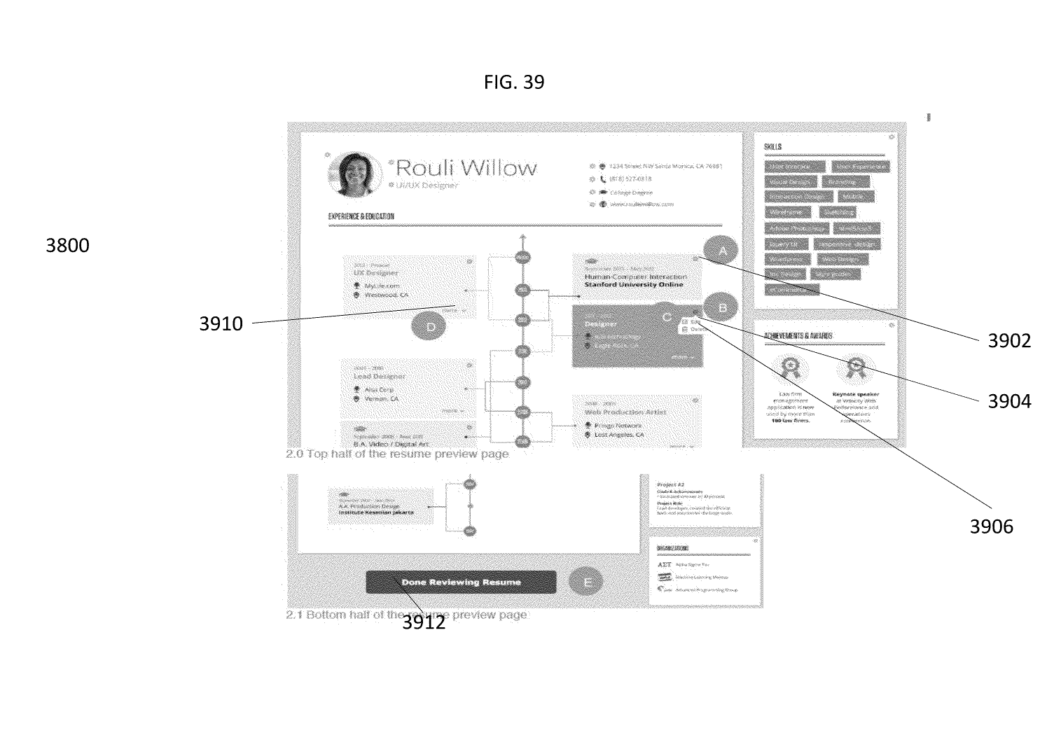

FIG. 39 is a diagram showing a candidate resume preview page 3900 according to an embodiment of the present invention. In the example embodiment a gear button 3902 on click a menu for edit/delete will appear. An edit button 3904 may take a candidate to a section/question in the resume builder with fields prepopulated with the candidate's input. A delete button 3906 may delete a portion or section from the resume. A more button 3908 may expand a section to show more or all details pertaining to the section. A done button 3910 may take a candidate to a questionnaire such as a demographics questionnaire.

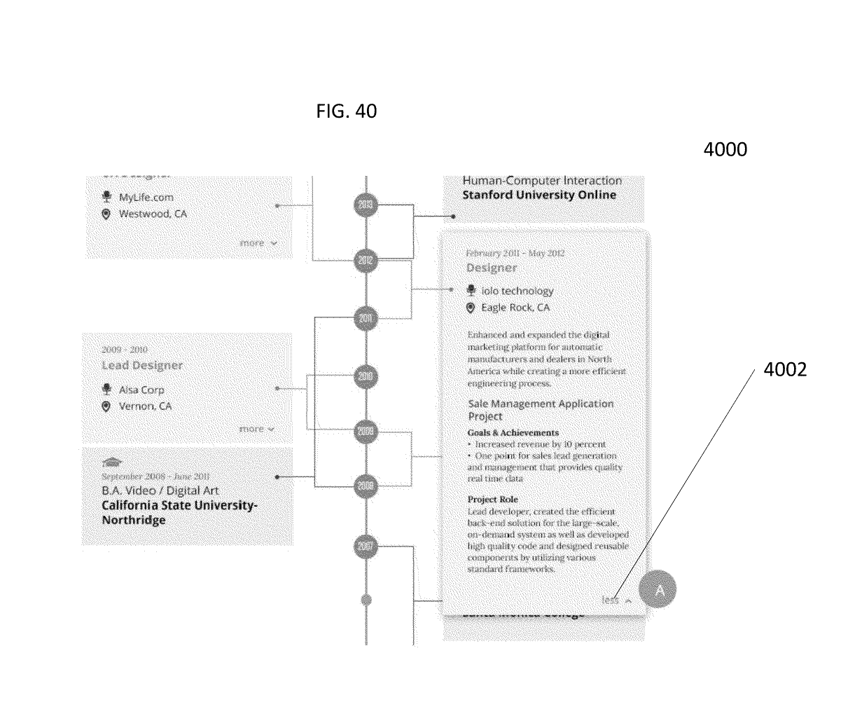

FIG. 40 is a diagram showing a candidate resume preview page 4000 according to an embodiment of the present invention. In the example embodiment a less button 4002 may collapse a detailed section to a high level overview.

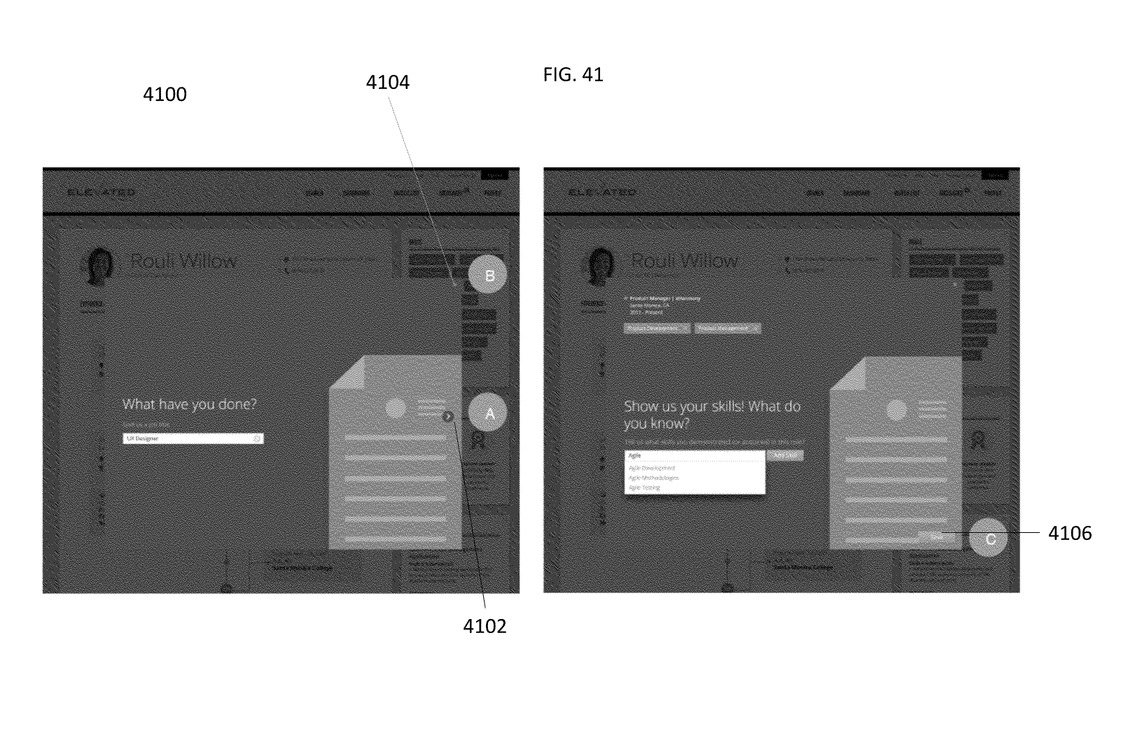

FIG. 41 is a diagram showing a candidate resume editor button 4100 according to an embodiment of the present invention. A next button 4102 takes a candidate to the next page in the resume builder. An exit button 4104 takes a candidate to a resume layout page without saving changes. A save button 4106 takes a candidate back to a resume layout page with saved updated information included.

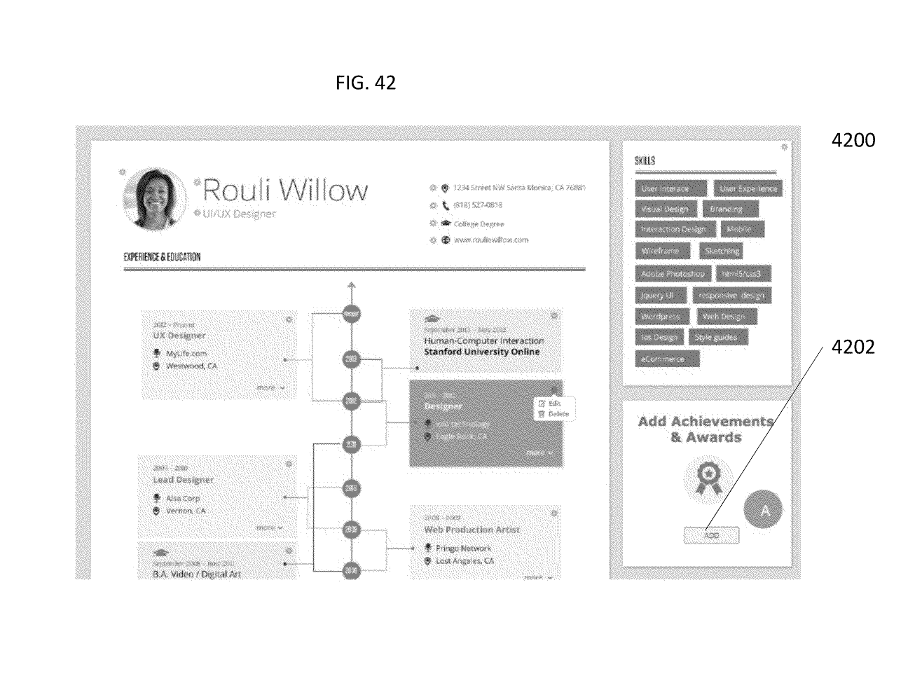

FIG. 42 is a diagram showing a candidate resume editor page 4200 according to an embodiment of the present invention. In the example embodiment a call to action 4202 may inform a candidate that a section of a resume should be completed by the candidate. This happens for example when a candidate uploads a resume via a third party system or file and some sections may not be included that are portions of the resume builder experience. The candidate may select the call to action 4202 and will be taken to that section of the resume builder. Once the incomplete section is completed and saved the candidate will be taken back to the resume preview with the saved information updated and included.

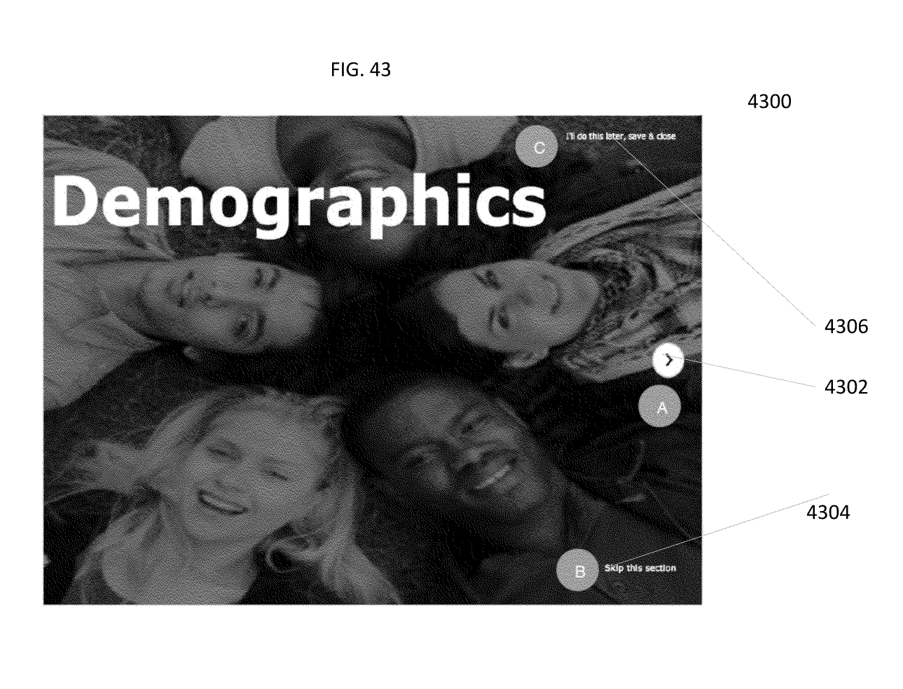

FIG. 43 is a diagram showing candidate questionnaire headers 4300 according to an embodiment of the present invention. A next button 4302 takes a candidate to the next page in the profile builder. A skip button 4304 allows a candidate to skip a current section. If the current section is the final section in the profile builder the skip button 4304 may take the candidate to a validation page if the candidate registered via a web-form, a compatibility scorecard if the candidate completed necessary questionnaires and has a registered status, or automatic search results if the candidate has a registered status but has not completed the necessary compatibility scorecard sections. A save and close button 4306 saves the current portion of the profile and may take the candidate to a search page.

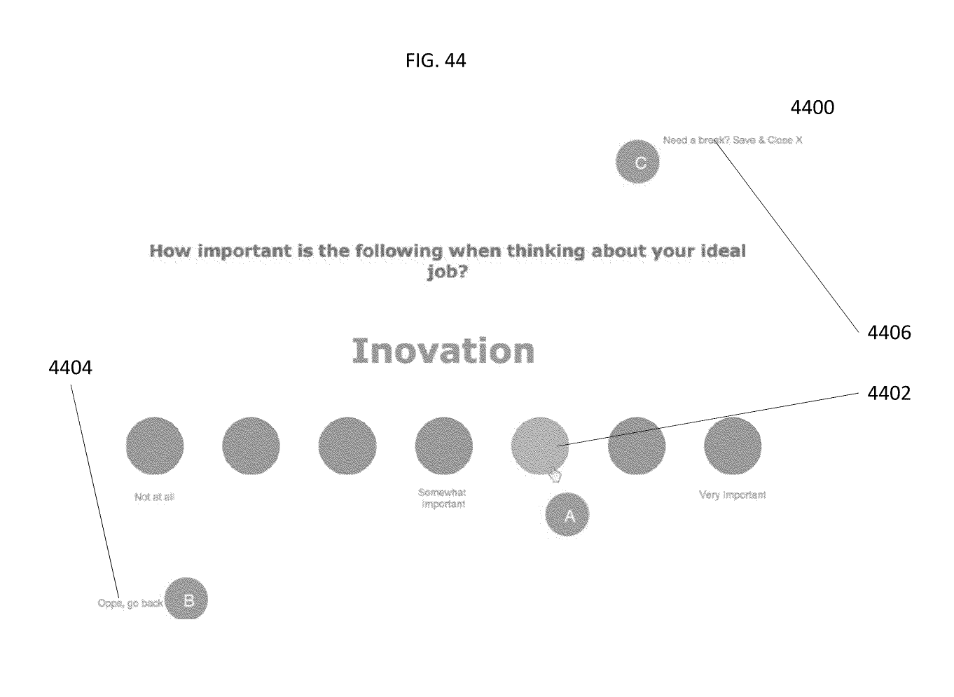

FIG. 44 is a diagram showing a candidate questionnaire page 4400 according to an embodiment of the present invention. An answer selection 4402 may automatically take a candidate to a next page when the candidate selects an answer. A back button 4404 may take the candidate to a previous page. A save and close button 4406 may take the candidate to a search page.

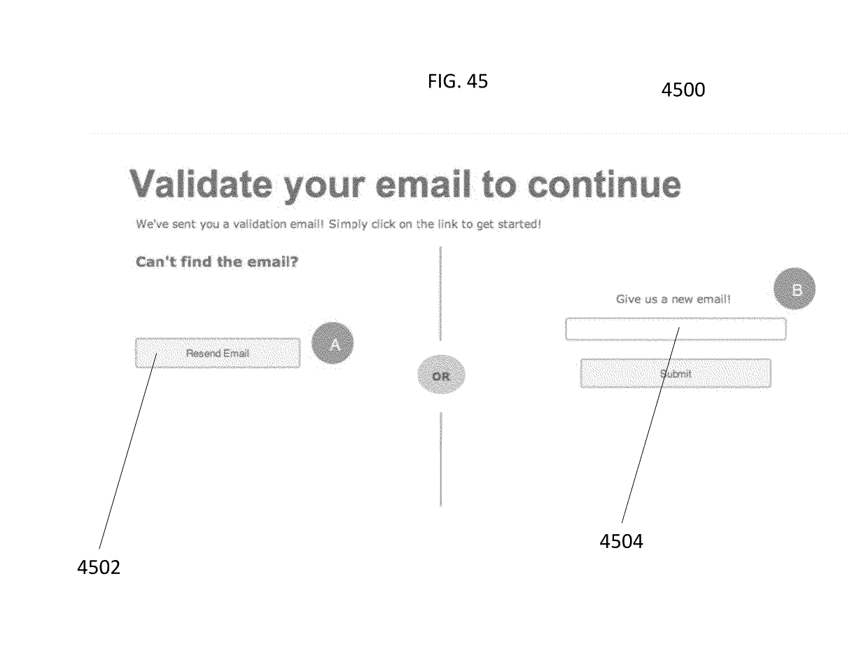

FIG. 45 is a diagram showing a candidate validation page 4500 according to an embodiment of the present invention. In the example embodiment a resend email button 4502 allows a candidate who registered through a web-form and has not validated through email to resend the validation email in the case they never received the validation email. A submit new email field 4504 allows candidates to provide a new email address that will replace the current one. A validation email will be sent to the new email address.

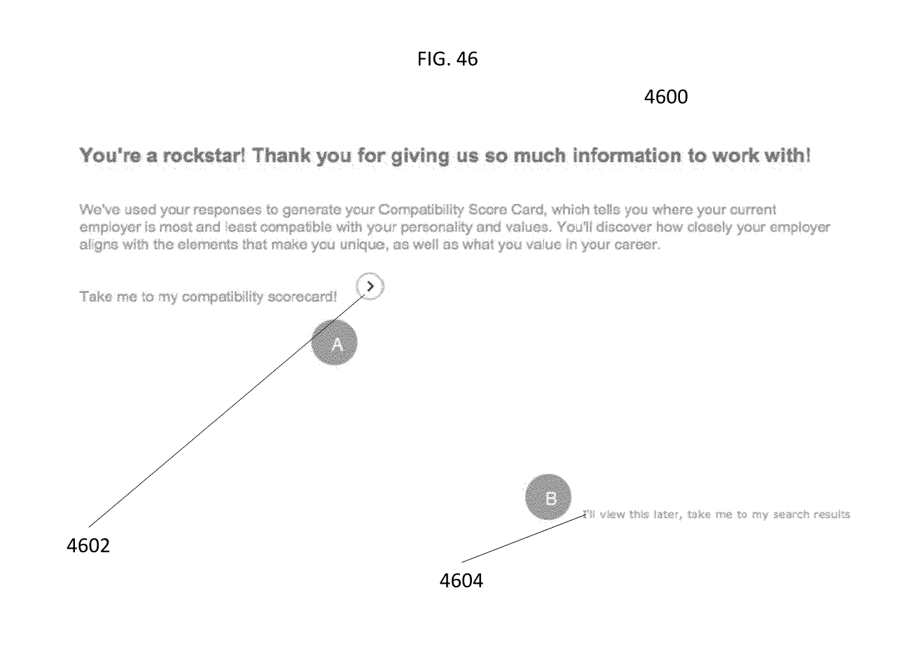

FIG. 46 is a diagram showing a candidate compatibility scorecard prompt page 4600 according to an embodiment of the present invention. A view compatibility scorecard button 4602 allows a candidate to view a compatibility scorecard if the candidate has previously completed a values, company values, and job satisfaction questionnaire. When the candidate selects this button it will take them to the first page of the scorecard. A go to search button 4604 may take the candidate to automated search results.

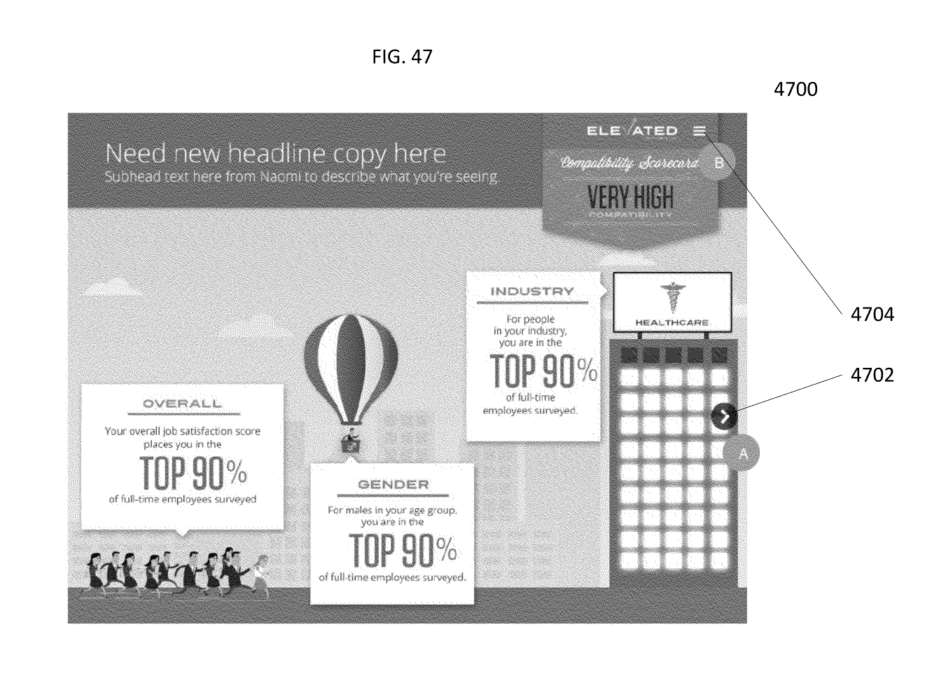

FIG. 47 is a diagram showing a candidate compatibility scorecard 4700 according to an embodiment of the present invention. A next button 4702 may take a candidate to a next page of the compatibility scorecard. If the current page is the last page then the candidate may be taken to automated search results. A collapsed menu 4704 may contain search, dashboard, watch list, messages, profile, and/or other sections. If a candidate selects any of the sections the candidate will be taken to the corresponding page.

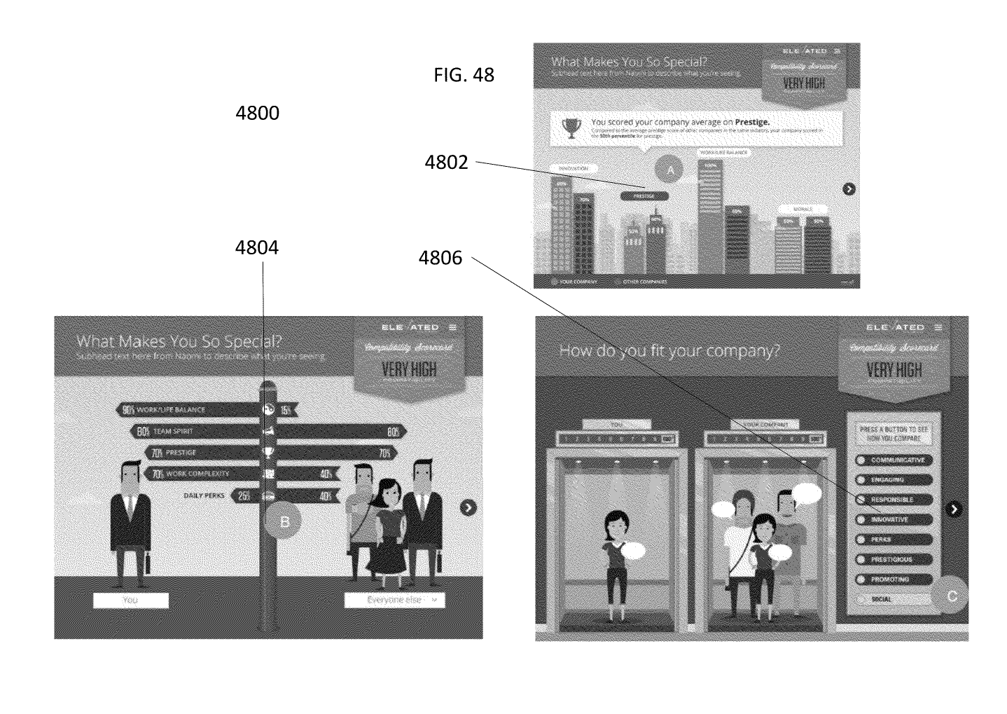

FIG. 48 is a diagram showing candidate scorecard interaction pages 4800 according to an embodiment of the present invention. Values buttons 4802 may move the pointer to a selected value with updated text. Value icons 4804 may show a value definition for a selected value. Elevator buttons 4806 may change percentage on an elevator and modify people in the elevator accordingly.

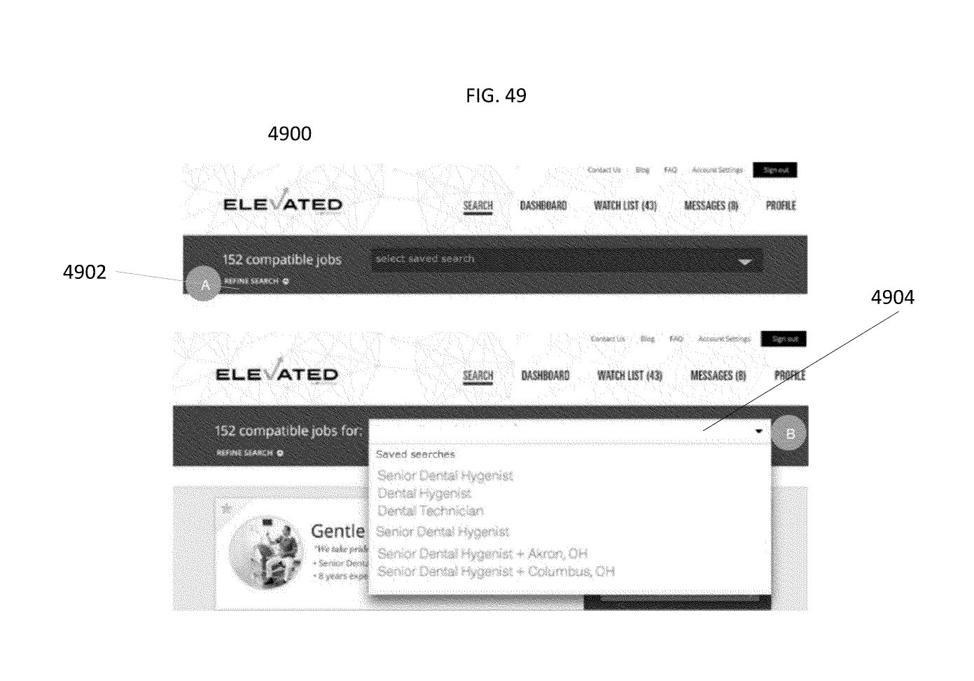

FIG. 49 is a diagram showing a candidate search builder page 4900 according to an embodiment of the present invention. A refine search button 4902 allows a candidate to expand a search builder to enter parameters to search. A saved search list 4904 allows a candidate to see a list of saved search queries. When a candidate selects a search query the corresponding search results will appear.

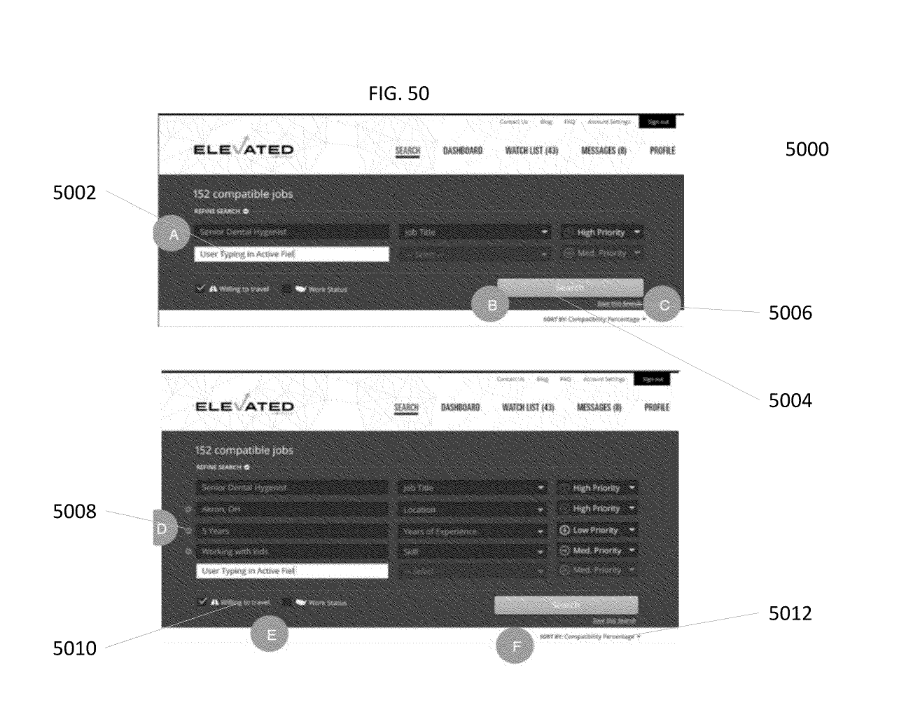

FIG. 50 is a diagram showing candidate search builder pages 5000 according to an embodiment of the present invention. In the example embodiment a search row 5002 allows a candidate to type in a search parameter, select a search category from a dropdown menu, and a priority from a dropdown menu. The best matching search category will automatically be selected according to the search parameter selected by the candidate. The candidate may then modify the search if necessary. When a candidate types in a current row an additional row may automatically appear. In some embodiments up to twenty-five search rows may be used. In some embodiments more or fewer than twenty-five search rows may be used. When a candidate selects a search button 5004, a search builder may collapse to display up to the first three search rows and generated search results may appear below. A pop-up menu may appear asking a candidate to provide a name for a saved search 5006. Upon saving, the saved search may appear at the top of a saved searches list. A minus or “−” button 5008 may remove a search row. A fixed search criteria 5010 may be a criteria which is fixed. For example, if a “willing to travel” selection is unchecked, job listings that require travel will not be displayed to a candidate. If a “work status” selection is checked then only jobs not requiring citizenship/residency may be shown. These criteria may be based on a candidate's input in a demographics or other questionnaire. A candidate may modify these criteria. If the candidate has not provided necessary information then a default state for both “work status” and “willing to travel” may be unchecked. A sort by button 5012 may allow a candidate to sort search results using criteria such as overall, skill, values compatiblity, personality compatibility, distance, search fit, and others if available.

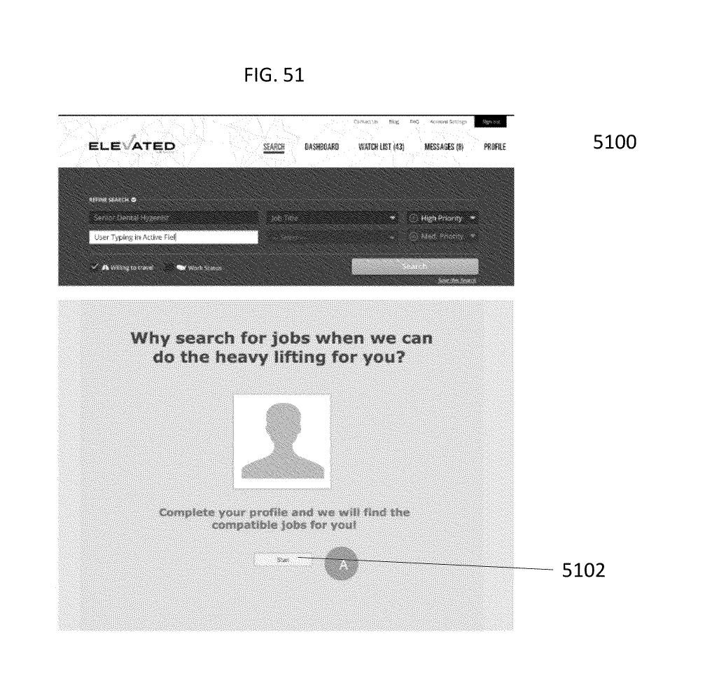

FIG. 51 is a diagram showing a candidate custom search page 5100 according to an embodiment of the present invention. When a candidate skips to a search without providing any information or uploading a resume the candidate may be taken to a custom search where the candidate will be required to provide at least one valid search row in order to view results. If the candidate selects a start button 5102 the candidate will be taken to an upload resume page.

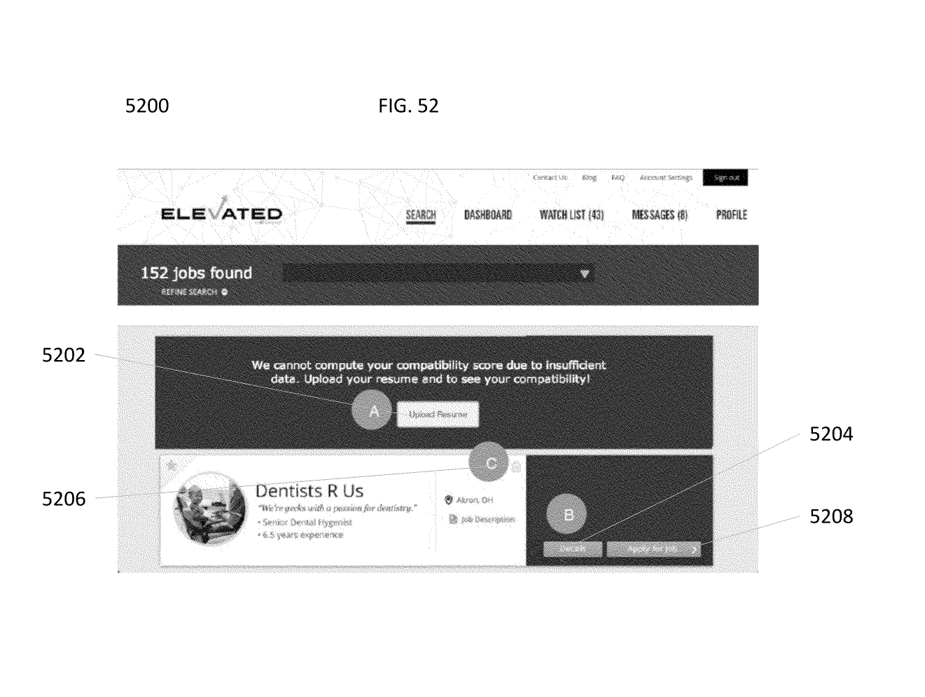

FIG. 52 is a diagram showing a candidate custom and basic search results page 5200 according to an embodiment of the present invention. In the example embodiment, if a candidate provided at least one valid search row from the custom search page or the system has the candidate's current title and zip code and/or city when the candidate skips to a search page they may see an interface screen similar to page 5200. There may be no compatibility scores displayed since the system does not have enough data to compute the compatibility scores. If the candidate selects an upload resume button 5202 they will be taken to a resume upload page. A details button 5204 may take the candidate to a compatibility profile call to action page. A delete job listing button 5206 may open a menu asking why the candidate wants to delete the job listing. If the candidate does not like the job listing then the job listing will be removed and will not be presented to the candidate again. If the job listing does not exist then the candidate may flag it as such and an administrator will decide whether to disable, delete, or otherwise remove the job listing from the system and it will no longer appear for any other candidates. In some embodiments an apply for job button 5208 will take a candidate to a job application screen while in some embodiments it may take a candidate to a third party job listing page such as an employer website.

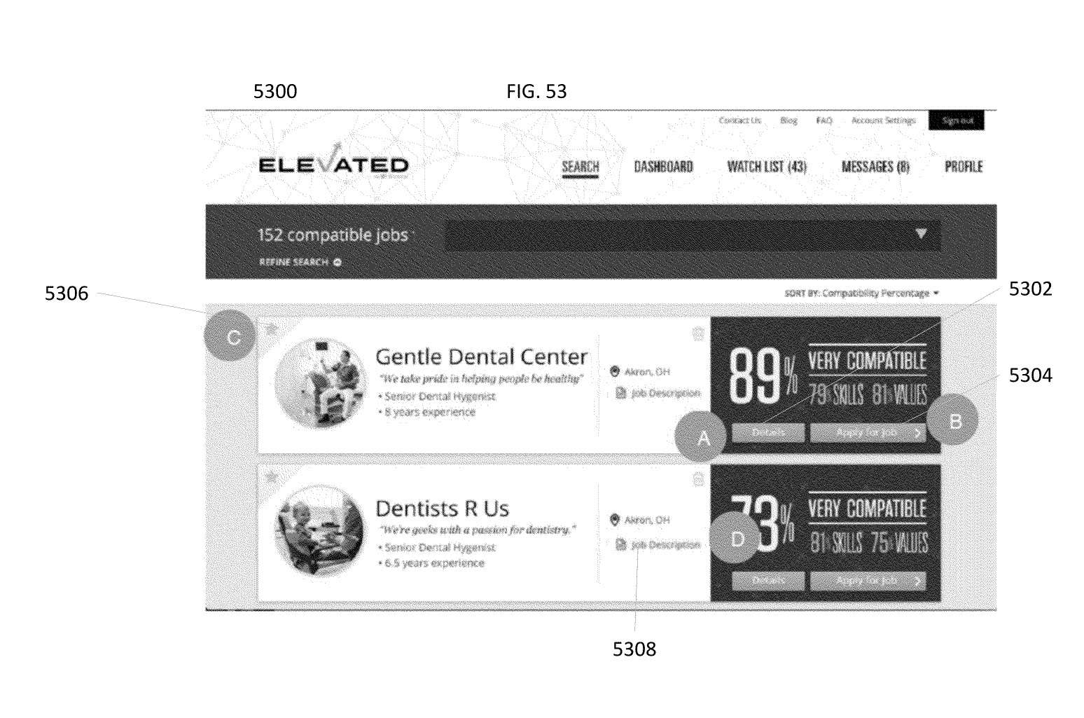

FIG. 53 is a diagram showing candidate automated search results page according to an embodiment of the present invention. When a candidate uploads at least a resume the system has enough information to generate compatibility scores. When the candidate reaches a search page or skips to a search page the candidate will be taken to an automated search results page. A details button 5302 may take a candidate to a compatibility profile when a candidate selects the button. An apply for job button 5304 will take a candidate to a job listing application page which in some embodiments is on a third party system. A save job listing button 5306 will save a job listing to a watch list page and fill in an indicator, such as a star, to indicate that the job has been saved. A job description button 5308 launches a separate page with the selected job listing's detailed description.

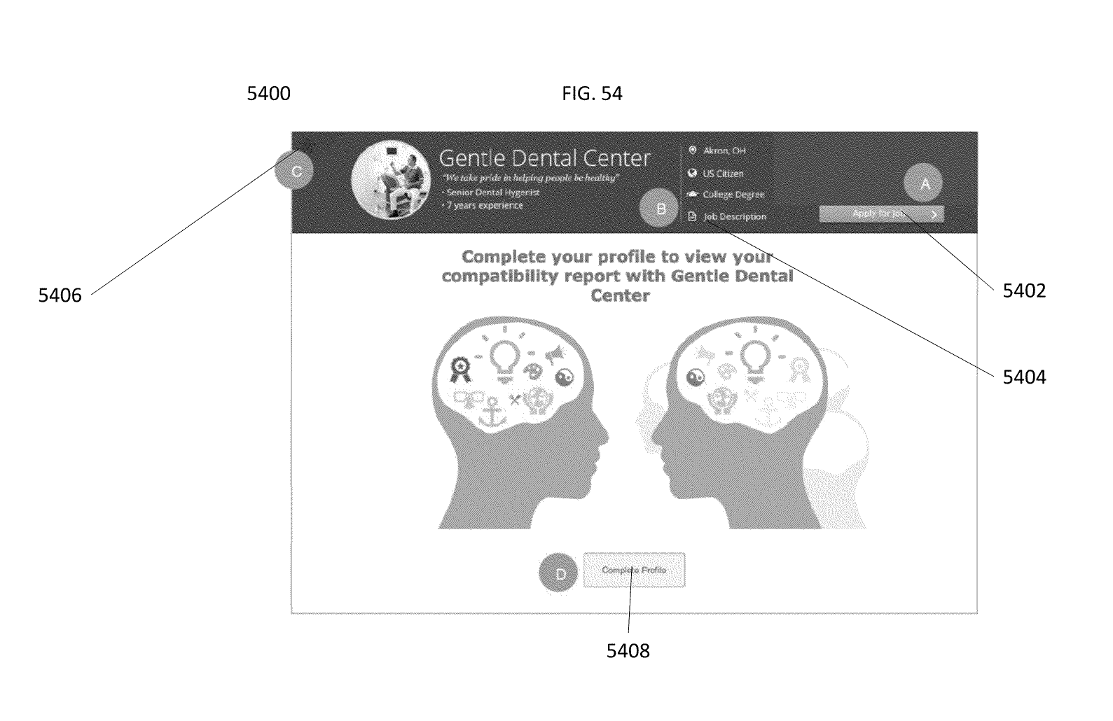

FIG. 54 is a diagram showing a candidate compatibility profile message page 5400 according to an embodiment of the present invention. An apply for job button 5402 will take a candidate to a job listing application page which in some embodiments is on a third party system. A job description button 5404 launches a separate page with the selected job listing's detailed description. A save job listing button 5406 will save a job listing to a watch list page and fill in an indicator, such as a star, to indicate that the job has been saved. A complete profile button 5408 will take a candidate to a resume upload page since the candidate did not provide enough information to compute compatibility.

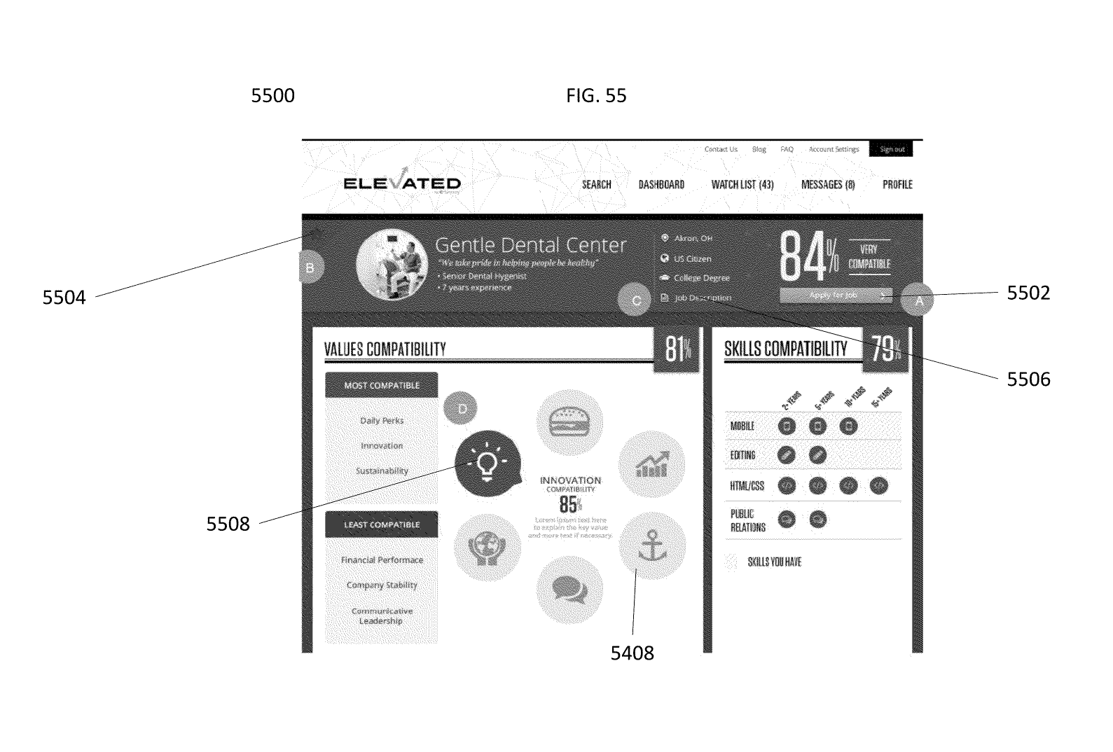

FIG. 55 is a diagram showing a candidate compatibility profile page 5500 according to an embodiment of the present invention. An apply for job button 5502 will take a candidate to a job listing application page which in some embodiments is on a third party system. A save job listing button 5504 will save a job listing to a watch list page and fill in an indicator, such as a star, to indicate that the job has been saved. A job description button 5506 launches a separate page with the selected job listing's detailed description. A value interaction field 5508 will highlight a circle around a value or a value icon itself and associated text will change accordingly when selected by a candidate.

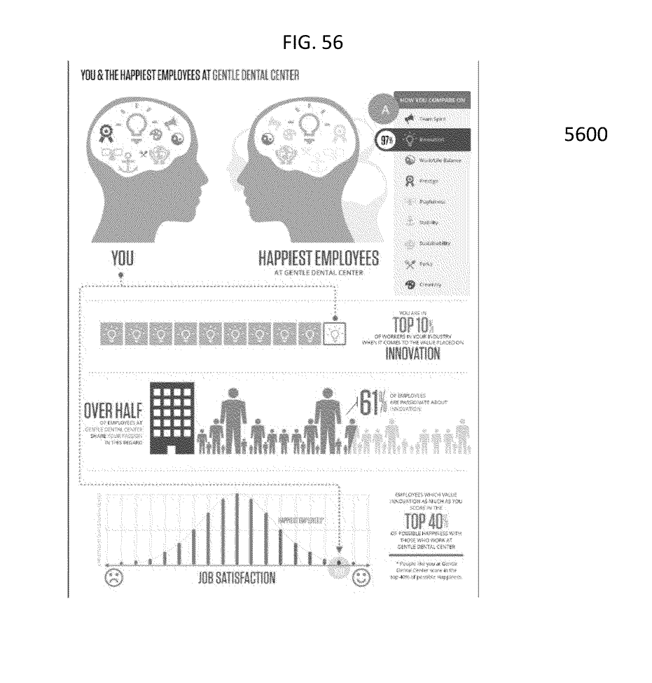

FIG. 56 is a diagram showing a continuation page 5600 of a candidate compatibility profile according to an embodiment of the present invention. When a candidate selects a value, graphics may change accordingly to reflect the candidate's answers and how they compare on a specific value to the happiest employees at the company. Varied statistical information, graphical information, and other information may be displayed by the system in order to present candidates with a broad explanation.

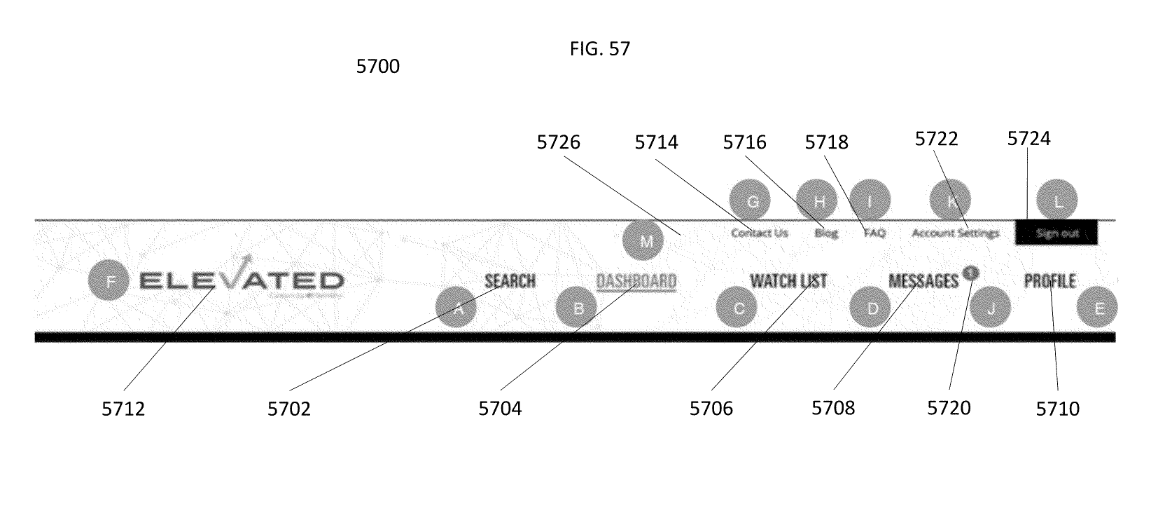

FIG. 57 is a diagram showing numerous navigation buttons 5700 which are consistent across many system pages according to an embodiment of the present invention. In the example embodiment a search button 5702 will take a candidate to a search page. A dashboard button 5704 will take a candidate to a dashboard page. A watch list button 5706 will take a candidate to a watch list page. A messages button 5708 will take a candidate to a messages page. A profile button 5710 will take a candidate to a profile page. A homepage button 5712 will take a candidate to a homepage. A contact us button 5714 will take a candidate to a system contact us page. A blog button 5716 will take a candidate to a blog page. A FAQ button 5718 will take a candidate to a FAQ page. Notifications 5720 will appear near the messages button 5708 to indicate to a candidate a number of new messages the candidate has received. Notifications 5720 may also appear next to the dashboard button 5704 when there are new matches. Account settings button 5722 may present the candidate with a drop down menu with options such as password and email reset, payment information, receive emails, and others. A sign out button 5724 will sign a candidate out of the system and take the candidate to a login page. A highlighted section 5724 will indicate the current page to the candidate. An account settings button will present a candidate with a drop down menu to perform account management activities such as password and email reset, payment information, receive emails, and others.

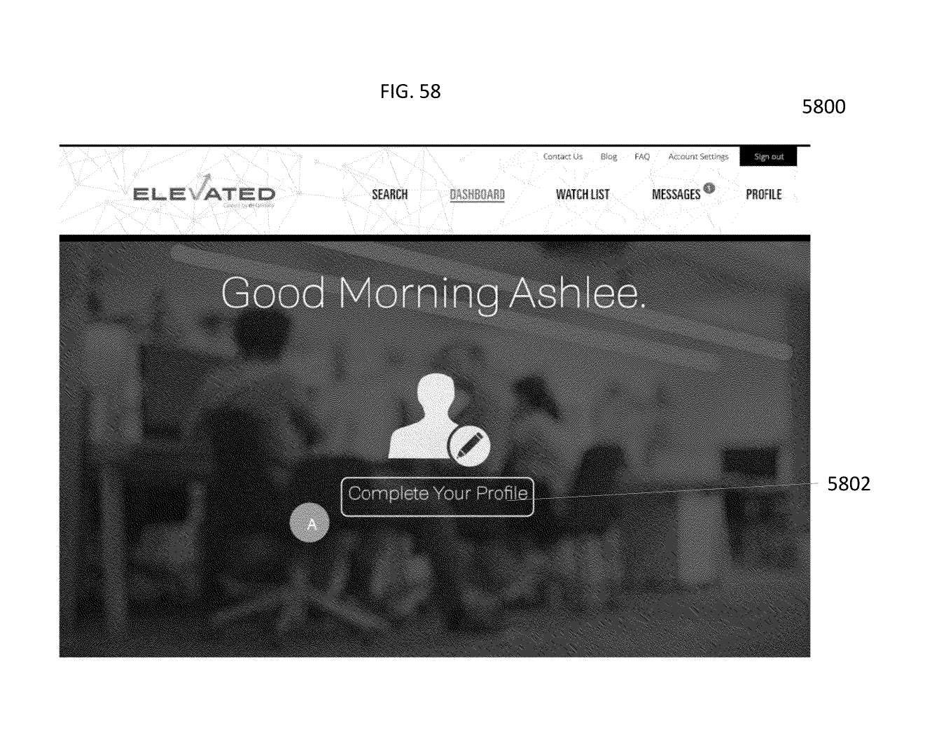

FIG. 58 is a diagram showing a dashboard message page 5800 according to an embodiment of the present invention. What a candidate that has not provided a resume navigates to a dashboard, the candidate will be presented with a notification button 5802 prompting the candidate to complete their profile. Once the candidate selects the notification button 5802 the candidate will be taken to a resume upload page.

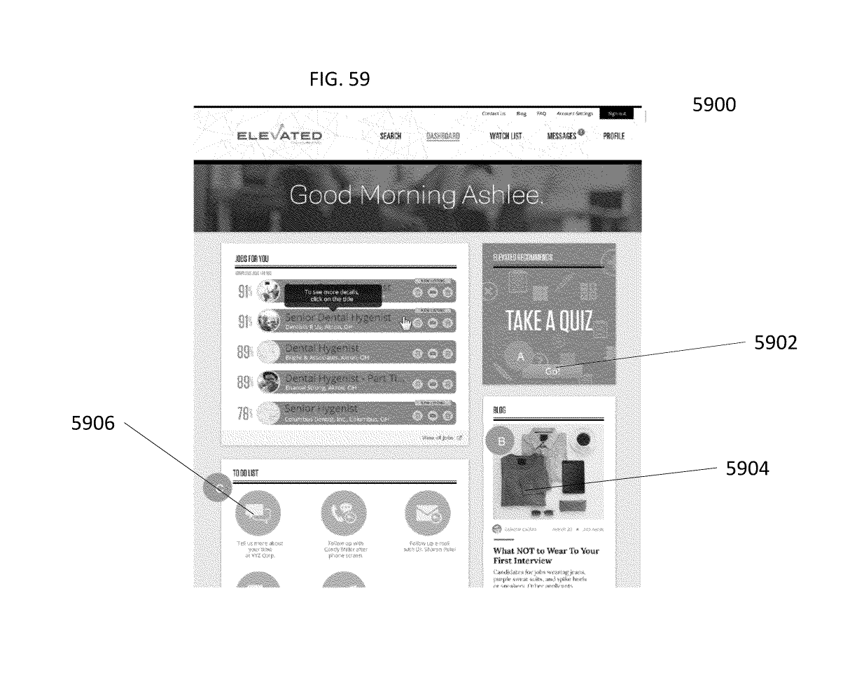

FIG. 59 is a diagram showing a candidate dashboard page 5900 according to an embodiment of the present invention. In the example embodiment, selecting a notification button 5902 will take a candidate to a corresponding page. For example, if a notification button 5902 is for completing a profile, the candidate will be taken to the first unanswered section of the profile builder. If a notification button 5902 is to subscribe, the candidate will be taken to a paywall. A blog button 5904 will take a candidate to a specific, associated article in a blog. A to do list 5906 may include buttons taking the candidate to corresponding pages. Once the candidate complete the task then it will be removed from to do list 5906.

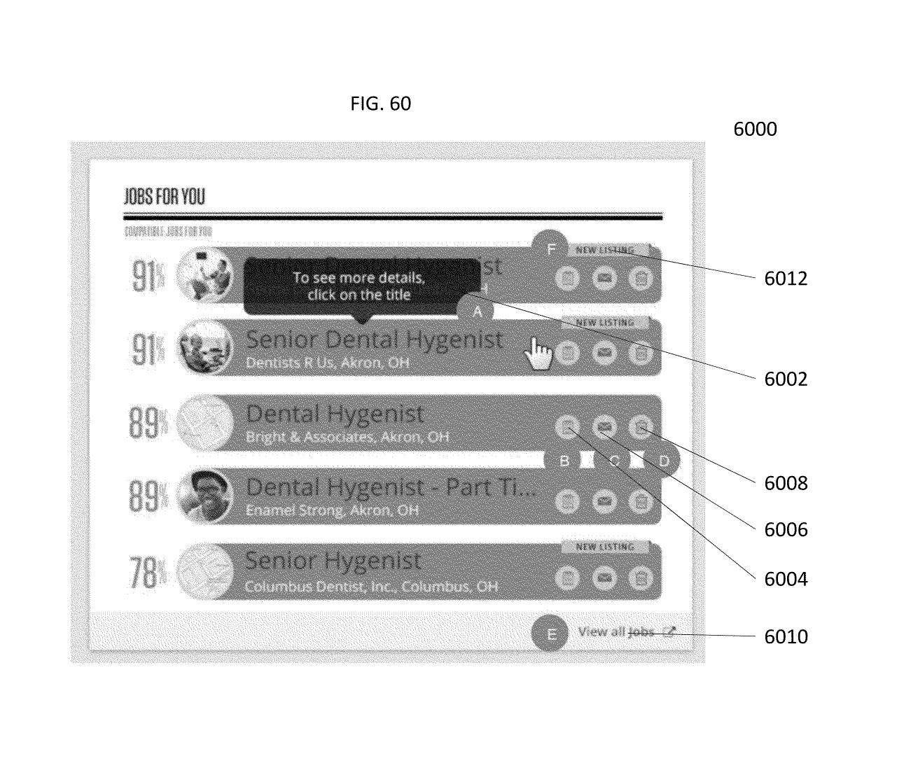

FIG. 60 is a diagram showing a top job search results page 6000 according to an embodiment of the present invention. When a candidate hovers over/around a job title, the candidate may see a prompt 6002 that they may select the job to view more details. If the candidate selects the job title it may take them to the company profile. A job description button 6004 may launch a separate page with the job listing's detailed description. Apply to job button 6006 may take the candidate to the job listing application page on a third party system. Delete job button 6008 will remove the job from the top jobs and from search results. View all jobs button 6010 will display a pop-up window and may allow the candidate to scroll through all jobs and close the window. New listing tag 6012 will stay until the candidate takes action.

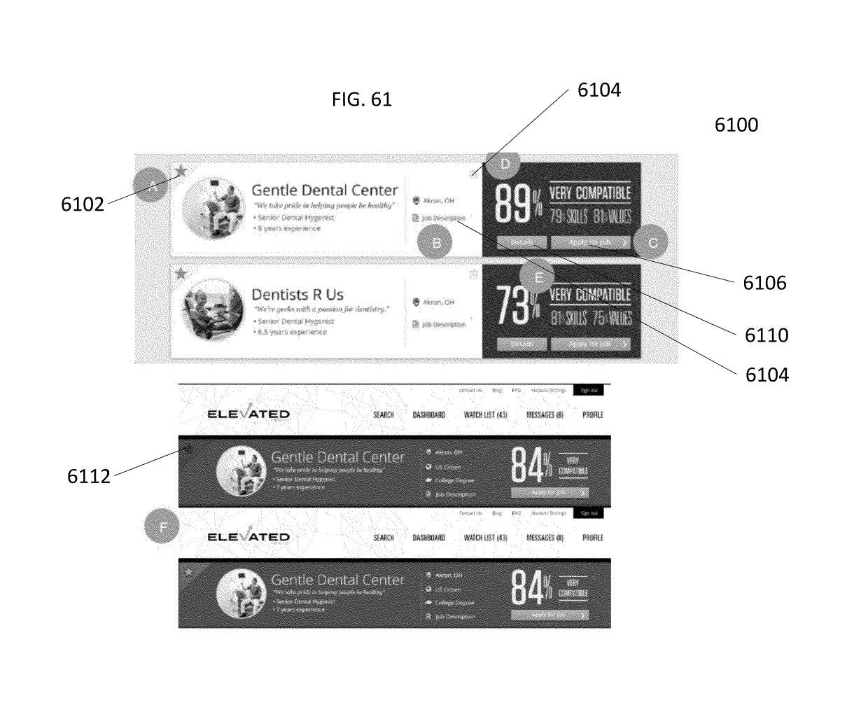

FIG. 61 is a diagram showing a candidate watch list page 6100 according to an embodiment of the present invention. Watch list removal 6102 may remove selected jobs from a watch list if the candidate selects a job on the watch list and chooses to remove it by un-tagging. Job description 6104 will launch a separate page with the job listing's detailed description. Apply to job 6106 will take the candidate to the job listing application page, often on third party systems. Delete job button 6108 will remove a selected job from the watch list, search results and/or top jobs, among others. Details button 6110 will take the candidate to the compatibility profile page. Star job 6112 will save the selected job to the watch list page.

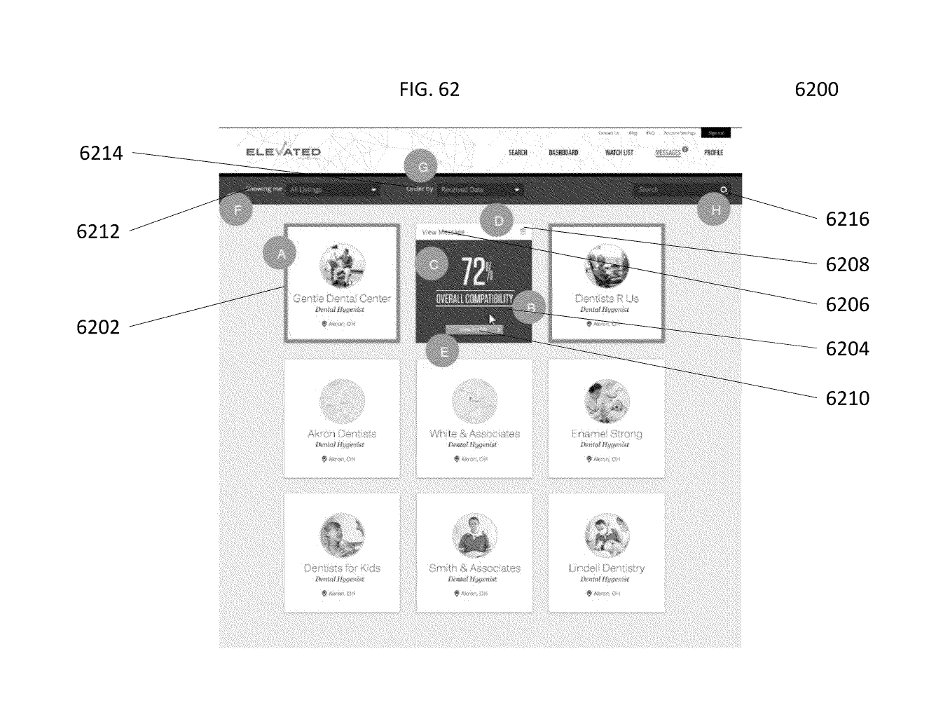

FIG. 62 is a diagram showing a candidate messages page 6200 according to an embodiment of the present invention. New message button 6202 indicates that a new message has arrived that a candidate has not yet reviewed and may be indicated by a special color around a border, shading, or other appropriate means. In the example embodiment new message 6202 is indicated by a blue border. Message hover 6204 may flip a message “card” to show an overall compatibility. View message button 6206 will take a candidate to the message. Delete message button 6208 will delete the selected message. View profile message 6210 will take the candidate to the compatibility profile. Show me button 6212 will give the candidate the option to view all job listings or job listings from specific companies. Order by button 6214 will allow a candidate to order by receive date, send date, or other appropriate means. Search button 6216 will allow a candidate to search for messages using keywords or other appropriate means.

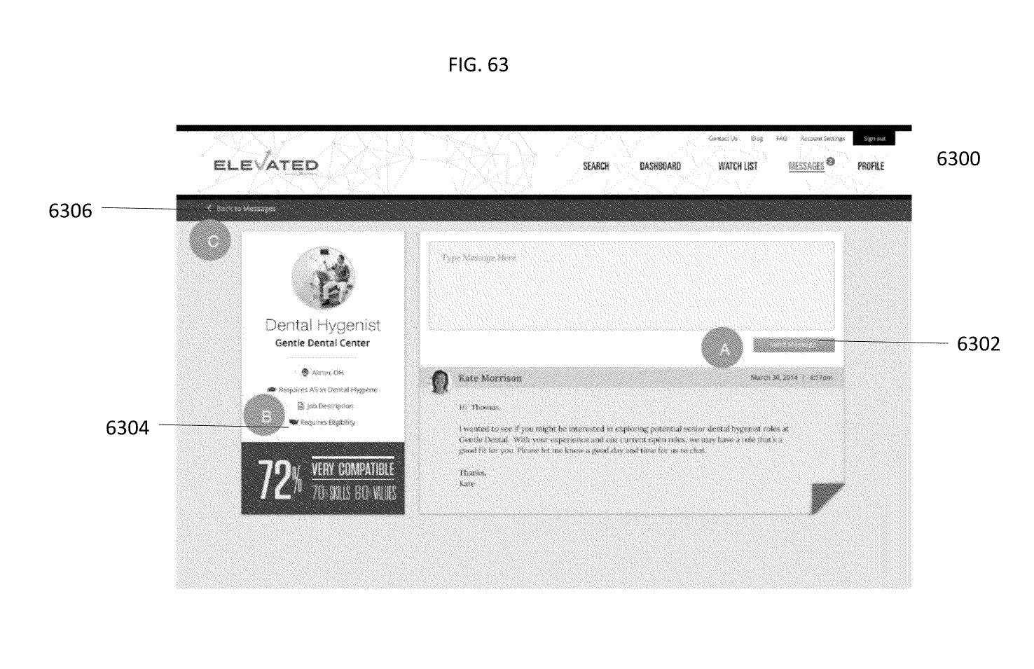

FIG. 63 is a diagram showing a candidate single message page 6300 according to an embodiment of the present invention. Send message button 6302 will send a message typed by the candidate in the text field. The message will then be displayed above the last message sent. View job description button 6304 will launch a separate page with the job listing's detailed description. Back to messages button 6306 will take the candidate back to the page containing all messages.

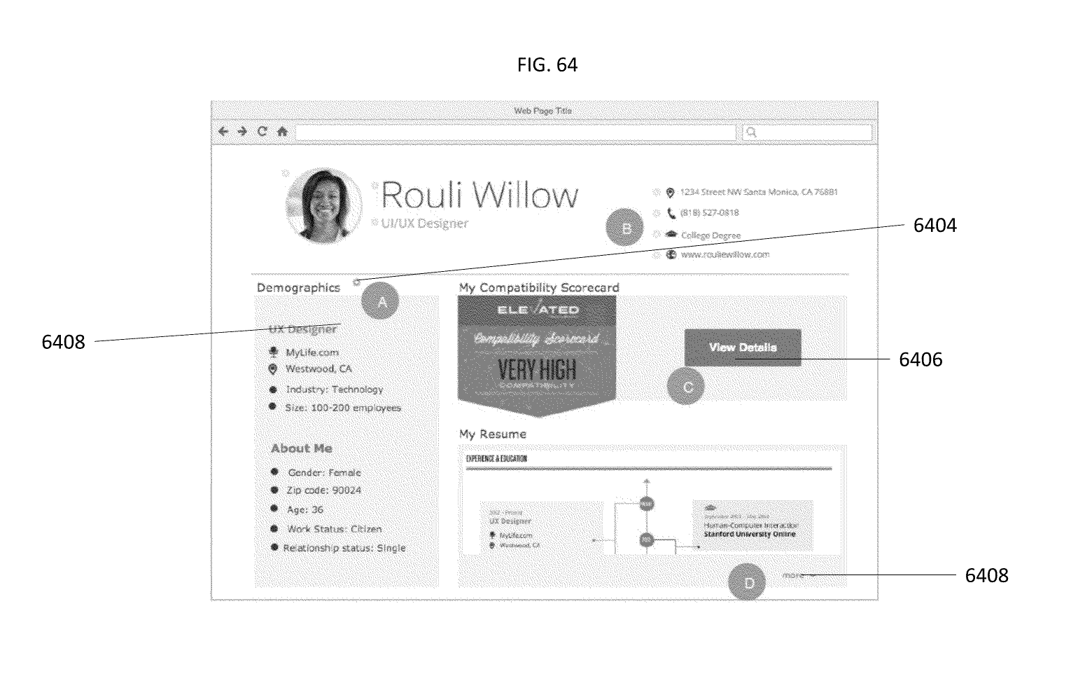

FIG. 64 is a diagram showing a candidate profile editing page 6400 according to an embodiment of the present invention. Edit demographics button 6402 will take the candidate to the demographics questionnaire with the answers pre-populated. The last page of the demographics questionnaire will have a save button and the candidate will see changes reflected after saving in the profile page. Gear button 6404 will behave like the resume edit. View details button 6406 will take the candidate to the first page of the compatibility scorecard. More button 6408 will take the candidate to the resume preview page.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A computer-based system for presenting employment analysis and recommendation, comprising:
an employment matching server system, operatively coupled to a public network, wherein the employment matching server system is configured to:
receive and store a job seeker's data in memory;
generate a job seeker's profile;
receive and store data about about employers;
generate profiles for specific employers;
generate profiles for generalized types of employers;
calculate a plurality of compatibility values by correlating the job seeker's profile with the specific employer's profile;
use the plurality of compatibility values to create matches between job listings and job seekers if an overall compatibility value meets or exceeds a predetermined threshold;
calculate a generalized compatibility value by correlating the job seeker's profile with the profiles of generalized types of employers, such correlation resulting in a potential match if the compatibility value meets or exceeds a predetermined threshold;
using calculated compatibility values generated from correlation of job seekers' profiles with the profiles of generalized types of employers to create matches between job listings and job seekers if the compatibility value meets or exceeds a predetermined threshold;
when a candidate search result or match is generated, presenting data associated with the specific employer's profile to the job seeker based on one or more of the compatibility values
when an employer search result or match is generated, presenting the data associated with the generalized employer's profile to the job seeker based on one or more of the compatibility values;
at least one user interface device, operatively coupled to the public network, wherein the user interface device is configured to enable a job seeker to evaluate the compatibility a search result or match.

2. The computer-based system for presenting employment analysis and recommendation of claim 1, wherein enabling the job seeker and the employer to evaluate the potential match includes presenting compatibility attributes.

3. The computer-based system for presenting employment analysis and recommendation of claim 2, wherein presenting compatibility attributes includes displaying compatibility visualizations.

4. The computer-based system for presenting employment analysis and recommendation of claim 2, wherein presenting compatibility attributes includes displaying a dynamic compatibility indicator.

5. The computer-based system for presenting employment analysis and recommendation of claim 2, wherein presenting compatibility attributes includes displaying a relative component importance map.

6. The computer-based system for presenting employment analysis and recommendation of claim 2, wherein presenting compatibility attributes includes displaying icons and summaries using color coordination.

7. The computer-based system for presenting employment analysis and recommendation of claim 1, wherein a job seeker may search for an employer based on one or more attributes.

8. The computer-based system for presenting employment analysis and recommendation of claim 1, wherein an employer may search for a job seeker based on one or more attributes.

9. A system for conducting an automatic search of candidates in an online employment server system based on normalized features of a job listing, and compatibility scores generated by comparing a specific employer and a plurality of candidates which returns results optimized for the probability of communication between the employer and candidate.

10. (canceled)

11. A system for conducting an automatic search of employers in an online employment server system based on normalized features of a job listing and compatibility scores generated by comparison of a plurality of specific employers and a candidate which returns results optimized for the probability of communication between the candidate and employer.

12. (canceled)
